(19) United States
(12) Patent Application Publication
(10) Pub. No.: US 2016/0116646 A1
(43) Pub. Date: Apr. 28, 2016

(54) DISPLAY DEVICE

(71) Applicant: SHARP KABUSHIKI KAISHA, Osaka (JP)

(72) Inventors: Ryoh ARAKI, Osaka-shi (JP); Shigenori TANAKA, Osaka-shi (JP); Masaki KAGEYAMA, Yonago-shi (JP)

(21) Appl. No.: 14/893,097

(22) PCT Filed: Feb. 27, 2014
(86) PCT No.: PCT/JP2014/054810

§ 371 Date: Nov. 23, 2015

(30) Foreign Application Priority Data
Jun. 4, 2013 (JP) 2013-117782

(51) Int. Cl. G02B 5/02; F21V 8/00; G02F 1/1335; G02B 5/00

(52) U.S. Cl. CPC G02B 5/0257; G02B 5/0242; G02B 5/0278; G02B 5/003; G02B 6/0011; G02F 1/133504

(57) ABSTRACT

A liquid crystal display device 10 includes a liquid crystal panel 11 and a second light diffusing sheet 43 that is an anisotropic optical member. The liquid crystal panel 11 includes a display surface DS for displaying images. The liquid crystal panel 11 has anisotropy in an exit angle distribution of rays of exiting light such that an exit angle range of the exiting light is relatively small with respect to the first direction along the display surface DS and relatively large with respect to the second direction along the display surface DS and perpendicular to the first direction. The second light diffusing sheet 43 is disposed over the liquid crystal panel 11 on any one of the display surface DS side and an opposite side thereof. The second light diffusing sheet 43 has anisotropy in an exit angle distribution of exiting light such that an exit angle range of the exiting light is relatively large with respect to the first direction and relatively small with respect to the second direction.

### TECHNICAL FIELD

The present invention relates to a display device.

### BACKGROUND ART

Display components in image display devices are now shifting from conventional cathode-ray tube displays to thin display panels such as liquid crystal panels and plasma display panels. With the thin display panels, the thicknesses of the image display devices can be reduced. Liquid crystal panels included in the liquid crystal display devices do not emit light and thus backlight devices are required as separate lighting devices. The backlight device includes at least a light source and an optical member for supplying even planar light to a liquid crystal panel by exerting optical effects on light from the light source. An example of a liquid crystal display device that includes such a backlight device is disclosed in Patent Document 1. In the liquid crystal display device disclosed in Patent Document 1, light is diffused by an anisotropy imparting means in the anisotropic manner to achieve high brightness while widening a viewing angle relative to a longitudinal direction to the liquid crystal display device and narrowing a viewing angle relative to a width direction of the liquid crystal display device.

### RELATED ART DOCUMENT

### Patent Document

Patent Document 1: International Publication No. 2012-42820

### PROBLEM TO BE SOLVED BY THE INVENTION

In the above Patent Document 1, the viewing angle relative to the width direction is narrowed by the anisotropic imparting means to reduce peeks from sides. In some application, a viewing angle with isotropy may be required for liquid crystal display devices. Specifically, if a device is switched between a portrait position (portrait mode) and a landscape position (landscape mode) depending on usage, a viewing angle with a high degree of isotropy may be required.

A liquid crystal panel includes display pixels arranged in a matrix each line including a number of the display pixels. Each display pixel includes unit pixels in three colors of R, G, and B. If a planar shape of the display pixels is rectangular, anisotropy may be observed in exit angle distribution of light transmitted through the liquid crystal panel. This may create anisotropy in viewing angle and result in decreases in display quality.

### DISCLOSURE OF THE PRESENT INVENTION

The present invention was made in view of the foregoing circumstances. An object is to improve display quality.

### MEANS FOR SOLVING THE PROBLEM

A display device according to the present invention includes a display surface for displaying images. The display device includes an anisotropic display component and an anisotropic optical member. The anisotropic display component has anisotropy in an exit angle distribution of exiting light such that an exit angle range of the exiting light is relatively small with respect to a first direction along the display surface and relatively large with respect to a second direction perpendicular to the first direction. The anisotropic optical member is disposed on any one of a display surface side or an opposite side relative to the anisotropic display component. The anisotropic optical member has anisotropy in an exit angle distribution of exiting light such that the exit angle range of the exiting light is relatively large with respect to the first direction and relatively small with respect to the second direction.

According to the configuration in which the anisotropic optical member is disposed on the opposite side from the display surface relative to the anisotropic display component, rays of light from the anisotropic optical member transmit through the anisotropic display component and images are displayed on the display surface. According to the configuration in which the anisotropic optical member is disposed on the display surface side relative to the anisotropic display component, rays of light from the anisotropic display component transit through the anisotropic optical member and images are displayed on the display surface. The anisotropic display component has the anisotropy in the exit angle distribution of exiting light such that the exit angle range of exiting light is relatively small with respect to the first direction along the display surface and relatively large with respect to the second direction along the display surface and perpendicular to the first direction. Therefore, a viewing angle regarding imaged displayed on the display surface may have anisotropy similar to that in the exit angle distribution of the anisotropic display component. However, the anisotropic optical component has the anisotropic optical member has the anisotropy in the exit angle distribution of exiting light such that the exit angle range of exiting light is relatively large with respect to the first direction and relatively small with respect to the second direction. With respect to the first direction, the exit angle range of exiting light from the anisotropic display component is relatively small. With respect to the second direction, the exit angle range of exiting light from the anisotropic display component is relatively large. Therefore, the viewing angle regarding the images displayed on the display surface of the anisotropic display component becomes isotropic. According to the configuration, the images are displayed on the display surface with high display quality.

Preferable embodiments of the present invention may include the following configurations.

(1) The anisotropic optical member may be for diffusing rays of light exiting therefrom. The anisotropic optical member may include at least an anisotropic light diffusing member having light diffusing anisotropy such that an amount of diffusing light is relatively large with respect to the first direction and relatively small with respect to the second direction. According to the configuration, the exit angle range of exiting light from the anisotropic light diffusing member having the light diffusing anisotropy is relatively large with respect to the first direction. With respect to the first direction, the exit angle range of exiting light from the anisotropic display component is relatively small and the amount of diffusing light from the anisotropic light diffusing member is relatively large. Furthermore, the exit angle range of exiting light from the anisotropic light diffusing member having the light diffusing anisotropy is relatively small with respect to the second direction. With respect to the second direction, the exit angle range of exiting light from the anisotropic display component is relatively large and the amount of diffusing light from the anisotropic light diffusing member is relatively small. According to the configuration, the viewing angle regarding images displayed on the display surface of the anisotropic display component becomes isotropic.

(2) The anisotropic light diffusing member may include anisotropic light diffusing particles each having a longitudinal shape and being oriented with a long-axis direction thereof along the second direction and a short-axis direction thereof along the first direction. According to the configuration, degrees of diffusing light by the anisotropic light diffusing particles are relatively low with respect to the long-axis direction thereof and relatively high with respect to the short-axis direction. Because the anisotropic light diffusing member includes the anisotropic light diffusing particles with the long-axis direction thereof along the second direction and the short-axis direction thereof along the first direction, the amount of diffusing light is relatively large with respect to the first direction and relatively small with respect to the second direction. With respect to the first direction, the exit angle range of exiting light from the anisotropic display component is relatively small. With respect to the second direction, the exit angle range of exiting light from the anisotropic display component is relatively large. According to the configuration, the viewing angle regarding images displayed on the display surface of the anisotropic display component becomes isotropic.

(3) The anisotropic light diffusing member may include a base and a light transmissive resin layer. The base has light transmissivity. The light transmissive resin layer is layered over the base and includes a number of the anisotropic light diffusing particle dispersed therein. The anisotropic light diffusing particles are oriented with the long-axis direction thereof along the second direction and the short-axis direction thereof along the first direction in the light transmissive resin layer. According to the configuration, rays of light transmitting through the anisotropic light diffusing member are diffused by the anisotropic light diffusing particles dispersed in the light transmissive resin layer with the long-axis direction thereof along the second direction and the short-axis direction thereof along the first direction such that the amount of diffusing light is large with respect to the first direction and small with respect to the second direction. Furthermore, in the production of the anisotropic light diffusing member, the light transmissive resin layer may be formed on the base by applying a material in a liquid state including the anisotropic light diffusing particles dispersed therein for forming the light transmissive layer and solidifying the material. The anisotropic light diffusing particles may be oriented such that the long-axis direction thereof is along a direction of the application of the material. Namely, the anisotropic light diffusing particles are easily oriented.

(4) Each of the anisotropic light diffusing particles may narrow from the middle toward ends with respect to the long axis direction. In comparison to a configuration in which each of the anisotropic light diffusing particles has a constant diameter for an entire length thereof along the long-axis direction, the anisotropic light diffusing particles are more smoothly oriented with the long-axis direction thereof along the direction in which the material of the light transmissive resin layer in the liquid state is applied in the production of the anisotropic light diffusing member. In the production of the anisotropic light diffusing member, the material of the light transmissive resin layer including the anisotropic light diffusing particles dispersed therein is applied to the base and solidified to form the light transmissive resin layer on the base. According to the configuration, the anisotropic light diffusing particles are more properly oriented in the light transmissive resin layer.

(5) Each of the anisotropic light diffusing particles may have an oval cross section cut along the long-axis direction. According to the configuration, ends of the long dimension of each anisotropic light diffusing particle are rounded. In the production of the anisotropic light diffusing member, the material of the light transmissive resin layer including the anisotropic light diffusing particles dispersed therein is prepared in the liquid state, applied to the base, and solidified to form the light transmissive resin layer on the base. During the application of the material in which the anisotropic light diffusing particles are oriented, the anisotropic light diffusing particles are less likely to be stuck. According to the configuration, the anisotropic light diffusing particles are more smoothly arranged such that the long-axis direction thereof along the direction in which the material is applied and thus the anisotropic light diffusing particles are further properly oriented in the light transmissive resin layer.

(6) Each of the anisotropic light diffusing particles may have a round cross section cut along the short-axis direction. In comparison to a configuration in which each anisotropic light diffusing particle has a rectangular cross section cut along the short-axis direction, the anisotropic light diffusing particles are less likely to be stuck during the application of the material in which the anisotropic light diffusing particles are oriented. In the production of the anisotropic light diffusing member, the material of the light transmissive resin layer including the anisotropic light diffusing particles dispersed therein is prepared in the liquid state, applied to the base, and solidified to form the light transmissive resin layer on the base. According to the configuration, the anisotropic light diffusing particles are more smoothly arranged such that the long-axis direction thereof along the direction in which the material is applied and thus the anisotropic light diffusing particles are further properly oriented in the light transmissive resin layer.

(7) The anisotropic light diffusing member may include a base and protrusions. The base may have light transmissivity and a sheet-like shape. The protrusions may protrude from a plate surface of the base. Each of the protrusions may have a triangular cross section cut along the first direction. Each protrusion may extend and meander along the second direction. The protrusions may be arranged along the first direction. Because each of the protrusions protruding from the plate surface of the base having the sheet-like shape may have the triangular cross section cut along the first direction, the rays of light angled according to the vertex angles may exit from the sloped surfaces. According to the configuration, the amount of light exiting from the protrusions along the first direction is larger than the amount of light exiting from the protrusions along the second direction. Furthermore, because each protrusion may extend and meander along the second direction, that is, the sloped surfaces may be undulating, the amount of exiting light may vary according to positions in the second direction on the sloped surfaces. According to the configuration, the rays of light exiting from the protrusions substantially along the first direction are properly diffused. Namely, the anisotropic light diffusing member may have diffusing anisotropy such that the amounts of diffused light are relatively large with respect to the first direction and relatively small with respect to the second direction. According to the configuration, the viewing angle regarding images displayed on the display surface of the anisotropic display component becomes isotropic.

(8) The protrusions arranged along the first direction maybe formed so as to randomly meander along the second direction. According to the configuration, the rays of light exiting from the sloped surfaces of the protrusions may be randomly diffused according to the meandering shapes of the protrusions. Therefore, moire fringes (interference fringes) are less likely to occur in the images displayed on the display surface of the anisotropic display component.

(9) The protrusions are formed such that at least one of a width and a height randomly varies according to positions in the second direction. Because the vertex angles and the orientations of the sloped surfaces randomly vary according to the positions in the second direction, the rays of light exiting from the sloped surfaces are randomly diffused. According to the configuration, moire fringes (interference fringes) are less likely to occur in images displayed on the display surface of the anisotropic display component.

(10) The display device may further include another optical member. The anisotropic light diffusing member may include in the anisotropic optical member disposed over the anisotropic display component on an opposite side from the display surface side. The other optical member may be disposed over the anisotropic display component and configured to transmit light. The anisotropic light diffusing member may be disposed closer to the anisotropic display component than the other optical member. According to the configuration, the rays of light transmitted through the other optical member and the anisotropic optical member in sequence are supplied to the anisotropic display component. Namely, the rays of light supplied to the anisotropic display component are the rays of light exiting from the anisotropic light diffusing member included in the isotropic optical member. Therefore, the viewing angle regarding images displayed on the display surface of the anisotropic display component more properly becomes isotropic. The display quality of the images further improves. Furthermore, the anisotropic light diffusing member is disposed over the surface of the anisotropic display component opposite from the display surface. The user of the display device directly sees the images displayed on the display surface. The display quality of the images further improves.

(11) The anisotropic optical member may include at least an anisotropic light collecting member for collecting rays of light exiting therefrom and having light collecting anisotropy such that light collecting effects are not exerted on the rays of exiting light with respect to the first direction and exerted on the rays of exiting light with respect to the second direction. According to the configuration, the rays of light from the anisotropic light collecting member having the light collecting isotropy has the exit angle distribution such that the exit angle range is relatively large with respect to the first direction and relatively small with respect to the second direction. With respect to the first direction, the exit angle range of exiting light from the anisotropic display component is relatively small. With respect to the second direction, the exit angle range of exiting light from the anisotropic display component is relatively large. According to the configuration, the viewing angle regarding images displayed on the display surface of the anisotropic display component becomes isotropic.

(12) The display device further may include a light source and a light guide plate. The light guide plate may be disposed on an opposite side from an anisotropic display component side with respect to the anisotropic optical member and configured to guide rays of light from the light source. The anisotropic optical member may be disposed over the anisotropic display component on an opposite side from the display surface. The light guide plate may include a peripheral surface and a plate surface. The peripheral surface may be configured as a light entrance surface through which rays of light from the light source enter. The plate surface may face the anisotropic optical member and may be configured as a light exit surface through which the rays of light exit. According to the configuration, the rays of light emitted by the light source enter the light guide plate through the light entrance surface, transmit through the light guide plate, and exit from the light exit surface. The rays of light exiting from the light exit surface are supplied to the anisotropic optical member and supplied from the anisotropic optical member to the anisotropic display component. With the light guide plate, uneven brightness is less likely to occur in the rays of light supplied to the anisotropic optical member and thus the optical performance of the anisotropic optical member is properly exerted.

(13) The display device may further include a light source. The anisotropic optical member may be disposed on an opposite side from the display surface side with respect to the anisotropic display component. The anisotropic optical member may have a sheet-like shape and include a plate surface along the display surface. The light source may include a light emitting surface for emitting rays of light. The light emitting surface may be opposite the plate surface of the anisotropic optical member. According to the configuration, the rays of light emitted through the light emitting surface of the light source are directed to the plate surface of the anisotropic optical member. The rays of light directed to the anisotropic optical member are supplied from the anisotropic optical member to the anisotropic display component. In comparison to a configuration in which the light guide plate is disposed between the light source and the anisotropic optical member, higher light use efficiency is achieved. This configuration is preferable for improving the brightness and reducing the power consumption.

(14) The anisotropic display component may include display pixels arranged in a matrix along the display surface. Each of the anisotropic display components may have a planar shape with a short-side direction corresponding with the first direction and a long-side direction corresponding with the second direction. According to the configuration, images are displayed on the display surface with the rays of light exiting from the display pixels arranged in the matrix along the display surface of the anisotropic display component. Each of the display pixels may have the planar shape with the short-side direction corresponding with the first direction and the long-side direction corresponding with the second direction. Therefore, the exit angle range of the rays of light exiting from the anisotropic display component is relatively small with respect to the first direction and relatively large with respect to the second direction. The anisotropic display component may have the exit angle distribution of exiting light such that the exit angle range is relatively large with respect to the first direction and relatively small with respect to the second direction. According to the configuration, the viewing angle regarding images displayed on the display surface of the anisotropic display component may become isotropic. Therefore, display quality of the images displayed on the display surface improves.

(15) The anisotropic display component may be a liquid crystal panel including liquid crystals sealed between substrates. Such a display panel may be used in various applications including displays in smartphones and tablet computers.

### ADVANTAGEOUS EFFECT OF THE INVENTION

According to the present invention, the display quality improves.

### BRIEF DESCRIPTION OF THE DRAWINGS

FIG. 1 is an exploded perspective view illustrating a general configuration of a liquid crystal display device according to a first embodiment of the present invention.

FIG. 2 is a cross-sectional view of a display area of a liquid crystal panel.

FIG. 3 is a magnified view illustrating a planar configuration of an array board included in the liquid crystal panel in the display area.

FIG. 4 is a magnified view illustrating a planar configuration of a CF board included in the liquid crystal panel in the display area.

FIG. 5 is a cross-sectional view illustrating a cross-sectional configuration of the liquid crystal display device along a short-side direction.

FIG. 6 is a cross-sectional view along a long-side direction illustrating a cross-sectional configuration of the liquid crystal display device.

FIG. 7 is a magnified cross-sectional view of an LED and therearound in FIG. 5.

FIG. 8 is a perspective view of a piece of a second light diffusing sheet (an anisotropic light diffusing sheet).

FIG. 9 is a plan view of the second light diffusing sheet schematically illustrating arrangement of anisotropic light diffusing particles.

FIG. 10 is a cross-sectional view of optical sheets and a light guide plate along the X-axis direction (a first direction).

FIG. 11 is a cross-sectional view of optical sheets and a light guide plate along the Y-axis direction (a second direction).

FIG. 12 is a graph illustrating brightness distribution of light exiting from a backlight unit according to a comparative sample in a comparative experiment.

FIG. 13 is a graph illustrating brightness distribution of light exiting from a liquid crystal panel in a liquid crystal display device according to the comparative sample in the comparative experiment.

FIG. 14 is a graph illustrating brightness distribution of light exiting from a backlight unit (a second light diffusing sheet according to a sample in the comparative experiment.

FIG. 15 is a graph illustrating brightness distribution of light exiting from a liquid crystal panel in a liquid crystal display device according to the sample in the comparative experiment.

FIG. 16 is a cross-sectional view of optical sheets and a light guide plate included in a backlight unit in a liquid crystal display device according to a second embodiment of the present invention along the X-axis direction (the first direction).

FIG. 17 is a cross-sectional view of the optical sheets and the light guide plate included in the backlight unit in the liquid crystal display device along the Y-axis direction (the second direction).

FIG. 18 is a cross-sectional view of optical sheets and a light guide plate included in a backlight unit in a liquid crystal display device according to a third embodiment of the present invention along the X-axis direction (the first direction).

FIG. 19 is a cross-sectional view of the optical sheets and the light guide plate included in a backlight unit in a liquid crystal display device along the Y-axis direction (the second direction).

FIG. 20 is a cross-sectional view of optical sheets and a light guide plate included in a backlight unit in a liquid crystal display device according to a fourth embodiment of the present invention along the X-axis direction (the first direction).

FIG. 21 is a cross-sectional view of the optical sheets and the light guide plate included in a backlight unit in a liquid crystal display device along the Y-axis direction (the second direction).

FIG. 22 is a perspective view of a piece of a second light diffusing sheet according to a fifth embodiment of the present invention.

FIG. 23 is a plan view of a second light diffusing sheet schematically illustrating arrangement of protrusions.

FIG. 24 is a cross-sectional view of optical sheets and a light guide plate included in a backlight unit in a liquid crystal display device along the X-axis direction (the first direction).

FIG. 25 is a perspective view of a piece of a second light diffusing sheet according to a sixth embodiment of the present invention.

FIG. 26 is a perspective view of a piece of a second light diffusing sheet according to a seventh embodiment of the present invention.

FIG. 27 is a magnified plan view of a display area of a CF board included in a liquid crystal panel illustrating a planar configuration (arrangement of display pixels) according to an eighth embodiment of the present invention.

FIG. 28 is a magnified plan view of a display area of a CF board included in a liquid crystal panel illustrating a planar configuration (arrangement of display pixels) according to other embodiment (1) of the present invention.

FIG. 29 is a magnified plan view of a display area of a CF board included in a liquid crystal panel illustrating a planar configuration (arrangement of display pixels) according to other embodiment (2) of the present invention.

FIG. 30 is a magnified plan view of a display area of a CF board included in a liquid crystal panel illustrating a planar configuration (arrangement of display pixels) according to other embodiment (3) of the present invention.

FIG. 31 is a magnified plan view of a display area of a CF board included in a liquid crystal panel illustrating a planar configuration (arrangement of display pixels) according to other embodiment (4) of the present invention.

FIG. 32 is a magnified plan view of a display area of a CF board included in a liquid crystal panel illustrating a planar configuration (arrangement of display pixels) according to other embodiment (5) of the present invention.

### MODE FOR CARRYING OUT THE INVENTION

### First Embodiment

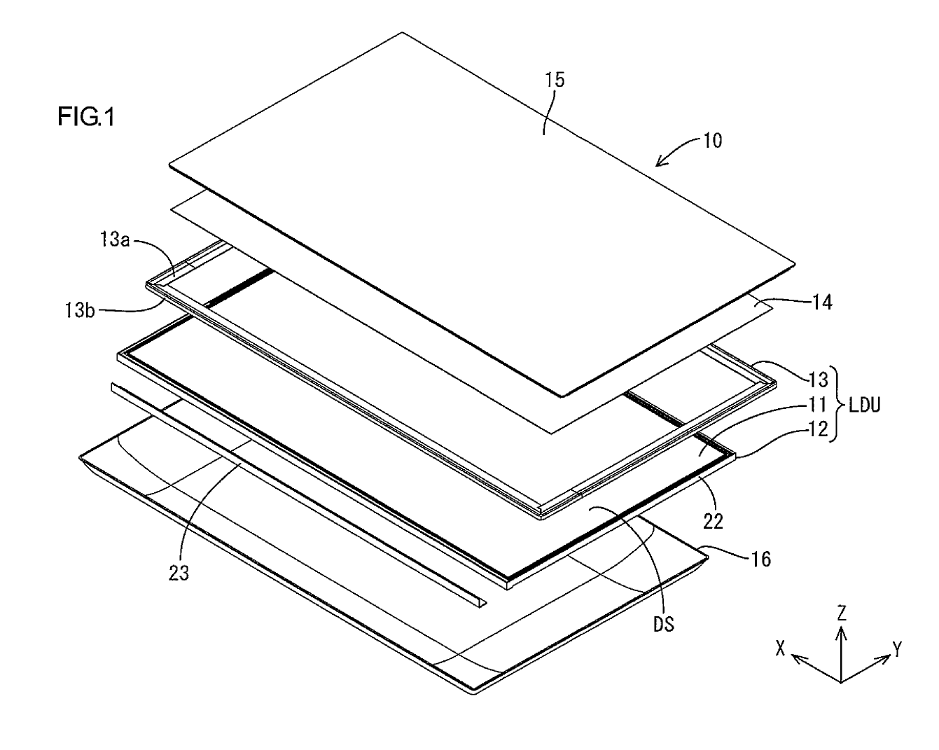

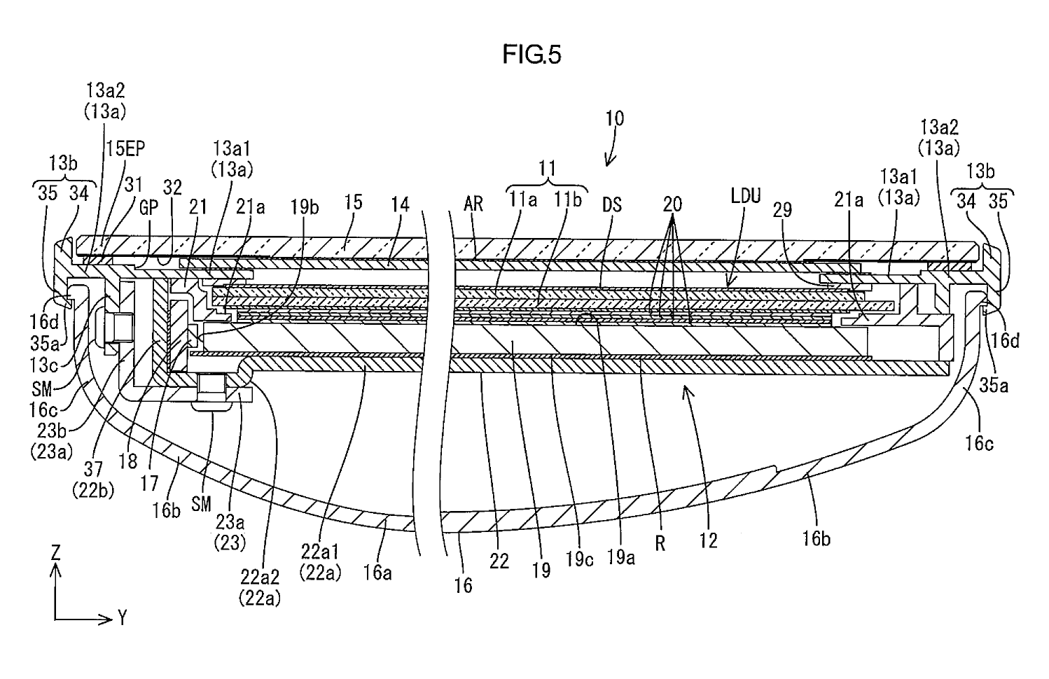

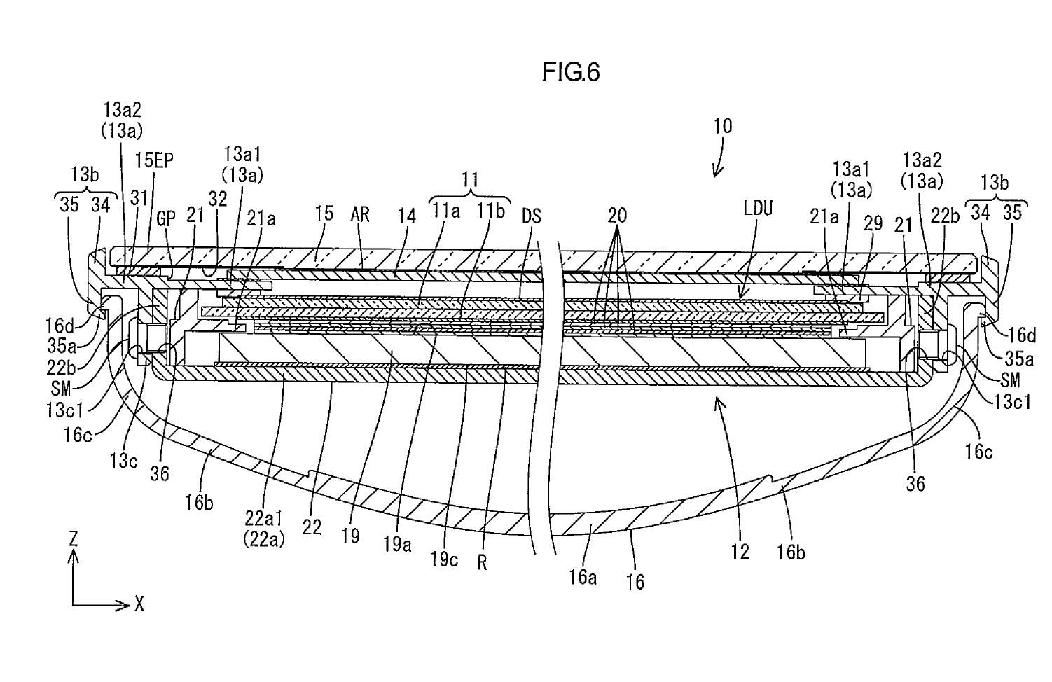

A first embodiment will be described with reference to FIGS. 1 to 15. In the following description, a liquid crystal display device 10 will be described. X-axes, Y-axes and Z-axes may be specified in the drawings. The axes in each drawing correspond to the respective axes in other drawings. The vertical direction is defined based on FIGS. 5 and 6 and the upper side and the lower side in those drawings correspond to the front and the rear of the device.

As illustrated in FIG. 1, the liquid crystal display device 10 has a horizontally-long rectangular overall shape and includes a liquid crystal display unit LDU, which is a core component. The liquid crystal display device 10 includes a touchscreen 14, a cover panel (a protection panel, a cover glass) 15, and a case 16 fixed to the liquid crystal display unit LDU. The liquid crystal display unit LDU includes a liquid crystal panel (an anisotropic component, an anisotropic liquid crystal display component) 11, a backlight unit (a lighting device) 12, and a frame (a chassis component) 13. The liquid crystal panel 11 includes a display surface DS on the front side for displaying images. The backlight unit 12 is disposed behind the liquid crystal panel 11 and configured to emit light toward the liquid crystal panel 11. The frame 13 presses down the liquid crystal panel 11 from the front side, that is, a side opposite from the backlight unit 12 (a display surface DS side). The touchscreen 14 and the cover panel 15 are held in the frame 13 that is a component of the liquid crystal display unit LDU from the front and received by the frame 13 from the rear. The touchscreen 14 is disposed more to the front than the liquid crystal panel 11 with a predefined distance apart from the liquid crystal panel 11. A plate surface of the touchscreen 14 on the rear (or on the inner side) is an opposed surface that is opposed to the display surface DS. The cover panel 15 is disposed over the touchscreen 14 on the front and a plate surface thereof on the rear (or the inner side) is an opposed surface that is opposed to a plate surface of the touchscreen 14 on the front. An antireflective film AR is disposed between the touchscreen 14 and the color panel 15 (see FIG. 5). The case 16 is fixed to the frame 13 so as to cover the liquid crystal display unit LDU from the rear. Among the components of the liquid crystal display device 10, a portion of the frame 13 (a rolled portion 13b, which will be described later), the cover panel 15, and the case 16 form an appearance of the liquid crystal display device 10. The liquid crystal display device 10 according to this embodiment is mostly used for an electronic device such as a smartphone and a tablet computer, a screen size of which is in a range from some inches to 20 inches, namely, categorized as a small-to-midsize display.

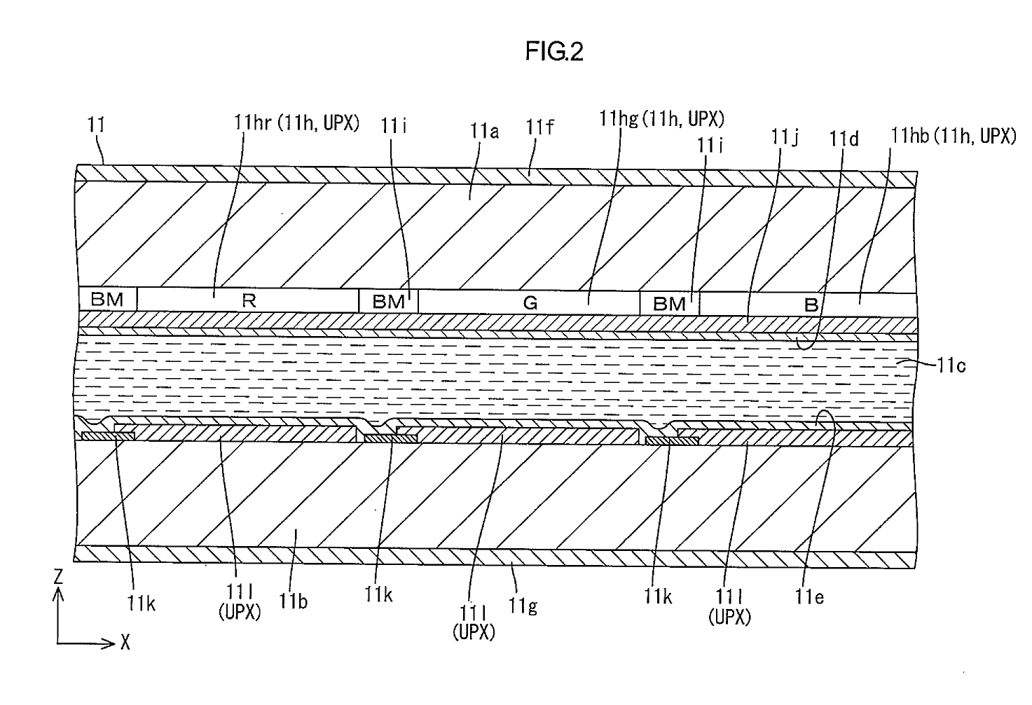

The liquid crystal panel 11 included in the liquid crystal display unit LDU will be described in detail. As illustrated in FIG. 2, the liquid crystal panel 11 has a horizontally-long rectangular shape and includes a pair of boards 11a and 11b and a liquid crystal layer 11c. Each of the glass boards 11a and 11b is a substantially transparent glass board having high light transmissivity. The liquid crystal layer 11c is between the boards 11a and 11b. The liquid crystal layer 11c includes liquid crystal molecules that vary their optical characteristics according to application of electrical field. he boards 11a and 11b are bonded together with a sealant, which is not illustrated, while a predefined gap corresponding to a thickness of the liquid crystal layer 11c is maintained therebetween. The liquid crystal panel 11 includes a display area (a middle area surrounded by a plate surface light blocking layer 32, which will be described later) and a non-display area (a peripheral area overlapping the plate surface light blocking layer 32, which will be described later). Images are displayed in the display area. The non-display area has a frame-like shape so as to surround the display area. Images are not displayed in the non-display area. One of the boards 11a and 11b of the liquid crystal panel 11 on the front is a CF board 11a and one on the rear (on the backside) is an array board 11b. Alignment films 11d and 11e are formed on inner surfaces of the boards 11a and 11b, respectively, for alignment of the liquid crystal molecules in the liquid crystal layer 11c. A long-side direction, a short-side direction, and a thickness direction of the liquid crystal panel 11 correspond with the X-axis direction, the Y-axis direction, and the Z-axis direction, respectively.

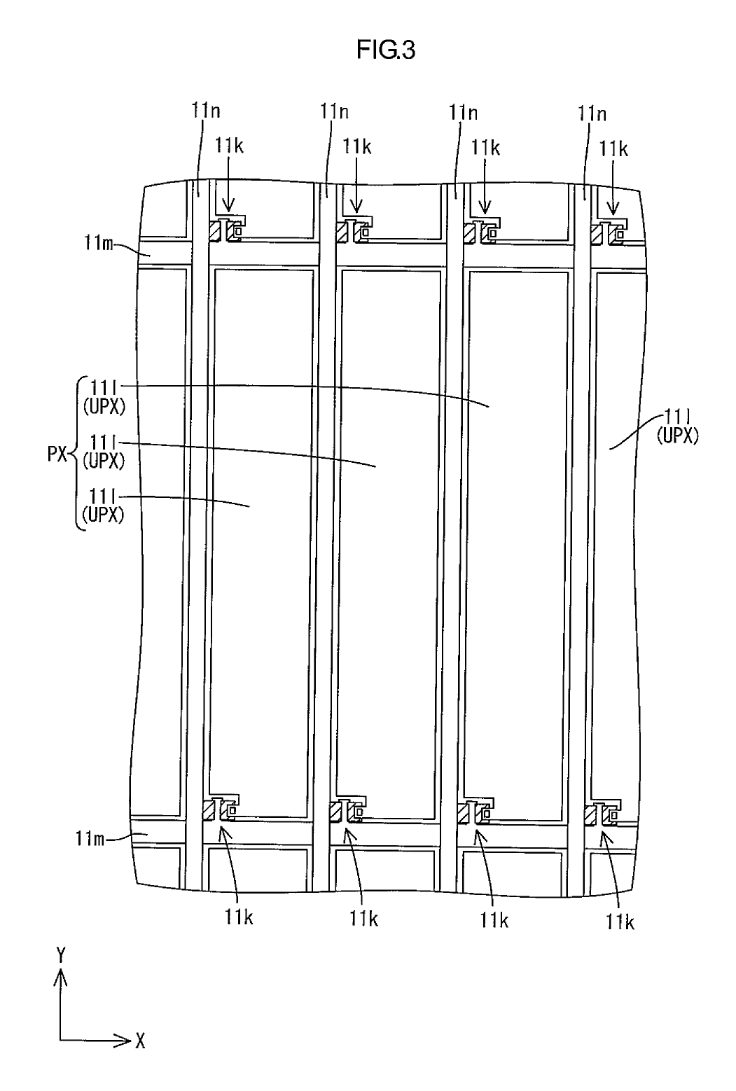

As illustrated in FIG. 3, on the inner surface of the array board 11b (on the liquid crystal layer 11c side, a side opposed to the CF board 11a), thin film transistors (TFTs) 11k that are switching components and pixel electrodes 11l are disposed in a matrix. Each rows along the X-axis direction includes a number of the TFTs 11k and a number of the pixel electrodes 11l and each column along the Y-axis direction includes a number of the TFTs 11k and a number of the pixel electrodes 11l. Gate lines 11m and source lines 11n are routed in a grid so as to surround the TFTs 11k and the pixel electrodes 11l. The gate lines 11m and the source lines 11n are connected to the gate electrodes and the source electrodes of the TFTs 11k, respectively. The pixel electrodes 11l are connected to the drain electrodes of the TFTs 11k. Scan signals related to images and data signals related to images are supplied from a display control circuit, which is not illustrated, to the gate lines 11m and the source lines 11n, respectively. Each of the gate lines 11m, the source lines 11n, and the gate electrodes, the source electrodes, and the drain electrodes of the TFTs 11k is a metal film having high conductivity and made of light blocking material. Each of the pixel electrodes 11l disposed in an area surrounded by the gate lines 11m and the source lines 11n has a vertically-long rectangular shape in a plan view with the short-side direction and the long-side direction thereof correspond with the X-axis direction and the Y-axis direction, respectively. Each of the pixel electrodes 11l has a short dimension one third of a long dimension thereof or smaller. The pixel electrodes 11l are made of transparent electrode material having high light transmissivity and conductivity such as indium tin oxide (ITO) and zinc oxide (ZnO). An opening area through which light from the display area of the array board lib transmits is an area other than the TFTs 11k, the gate lines 11m, and the source lines 11n, which are light blocking structures, that is, a vertically-long rectangular area that overlaps the pixel electrodes 11l, which are light transmissive structures, in a plan view.

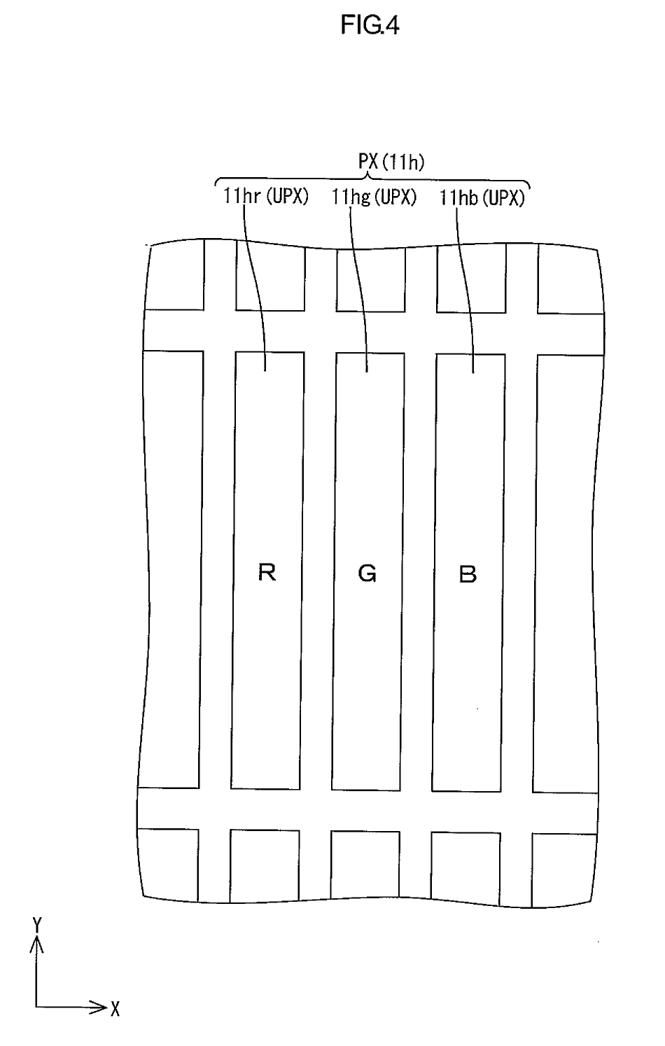

On the CF board 11a, as illustrated in FIG. 4, a number of color filters 11h are disposed at positions corresponding to the pixel electrodes 11l. The color filters 11h include R (red), G (green), and B (blue) color portions 11hr, 11hg, and 11hb. The color portions 11hr, 11hg, and 11hb in three colors are repeatedly arranged along the X-axis direction (the row direction) and form groups of the color portions. A number of the groups of the color portions are arranged along the Y-axis direction (the column direction). The color portions 11hr, 11hg, and 11hb of the color filters 11h are opposite the pixel electrodes 11l on the array board 11b side via the liquid crystal layer 11c and have vertically-long rectangular shapes in a plan view. The short-side direction and the long-side direction thereof correspond with the X-axis direction and the Y-axis direction, respectively. A pair of one of the color portions 11hr, 11hg, and 11hb of the color filters 11h and the pixel electrode 11l that is opposed to the one of the color portions 11hr, 11hg, and 11hb forms a unit pixel UPX. Each of the color portions 11hr, 11hg, and 11hb of the color filters 11h has a short dimension that is one third of the long dimension thereof or smaller. A ratio of the short dimension to the long dimension is about equal to the ratio of those of the pixel electrode 11l described above. A light blocking layer (a black matrix) 11i is formed among the color portions 11hr, 11hg, and 11hb of the color filters 11h for reducing color mixture. The light blocking layer 11i is made of light blocking material having high light blocking properties and formed in a grid. The light blocking layer 11i is arranged so as to overlap the gate lines 11m and the source lines 11n on the array board 11b. The opening area through which the light from the display area of the CF board 11a transmits is the area other than the light blocking layer 11i that is a light blocking structure, that is, a vertically-long rectangular area that overlaps the color portions of the color filters 11h, which are light transmitting structures, in a plan view. A counter electrode (a common electrode) 11j is disposed on surfaces of the color filters 11h and the light blocking layer 11i opposed to the pixel electrodes 11l on the array board 11b. A reference potential is applied to the counter electrode 11j by the display control circuit, which is not illustrated. When the pixel electrodes 11l are charged by the TFTs 11k that are driven according to the signals transmitted to the gate lines 11m and the source lines 11n, a potential difference occurs between the pixel electrodes 11l and the counter electrode 11j that is at the reference potential. The alignment of the liquid crystal molecules in the liquid crystal layer 11c between the electrodes 11l and 11j is controlled based on the potential difference. The amounts of light transmitting through the unit pixels UPX (the color portions 11hr, 11hg, and 11hb) are individually controlled for displaying images on the display surface DS of the liquid crystal panel 11. The CF board 11a has a size slightly smaller than the array board 11b in a plan view.

In the liquid crystal panel 11, the red (R), the green (G), and the blue (B) color portions 11hr, 11hg, and 11hb of the color filter 11h and three pixel electrodes 11l opposite the color portions form a display pixel PX that is a unit of display.

Specifically, as illustrated in FIGS. 3 and 4, the display pixel PX includes the red unit pixel of the R color portion 11hr, the green unit pixel of the G color portion 11hg, and the blue unit pixel of the B color portion 11hb. A number of the unit pixels UPX are arranged on the plate surface of the liquid crystal panel in repeat sequence along the X-axis direction (the row direction) to form groups of the unit pixels UPX. A number of the groups of the unit pixels UPX are arranged along the Y-axis direction (the column direction). Therefore, a number of the display pixels PX are arranged in a matrix along the plate surfaces of the boards 11a and 11b, that is, the display surface DS (or the X-Y plane). Each display pixel PX has a vertically-long rectangular shape in a plan view with the short-side direction and the long-side direction corresponding with the X-axis direction and the Y-axis direction, respectively. The display pixel PX has a short dimension one third of a long dimension thereof or smaller. A ratio of the short dimension to the long dimension is about equal to the ratio of those of the pixel electrode 11l or the color portion 11hr, 11hg, or 11hb of the color filter 11h described above. Because of such a configuration, a distribution of exit angle of transmitting light in the liquid crystal panel 11 has anisotropy. Specifically, the exit angle range of the transmitting light is relatively small with respect to the X-axis direction along the short-side direction of the display pixel PX and relatively large with respect to the Y-axis direction along the long-side direction of the display pixel PX. The “exit angle range” is an angle range between a direction of light exiting through the liquid crystal panel 11 relative to a direction of a line normal to the display surface DS on the positive side and that on the negative side, that is, the angle range in which the brightness of the exiting light is equal to or higher than a certain level (specifically, equal to or higher than a half of the highest brightness level). In the following description, a direction along the short-side direction of the display pixel PX (the X-axis direction) will be referred to as a “first direction” and a direction along the long-side direction of the display pixel PX (the Y-axis direction) will be referred to as a “second direction.” The display pixels PX and the unit pixels UPX form a structure that includes repeating patterns in which groups of the unit pixels PX are arranged at certain intervals along the X-axis direction and the Y-axis direction.

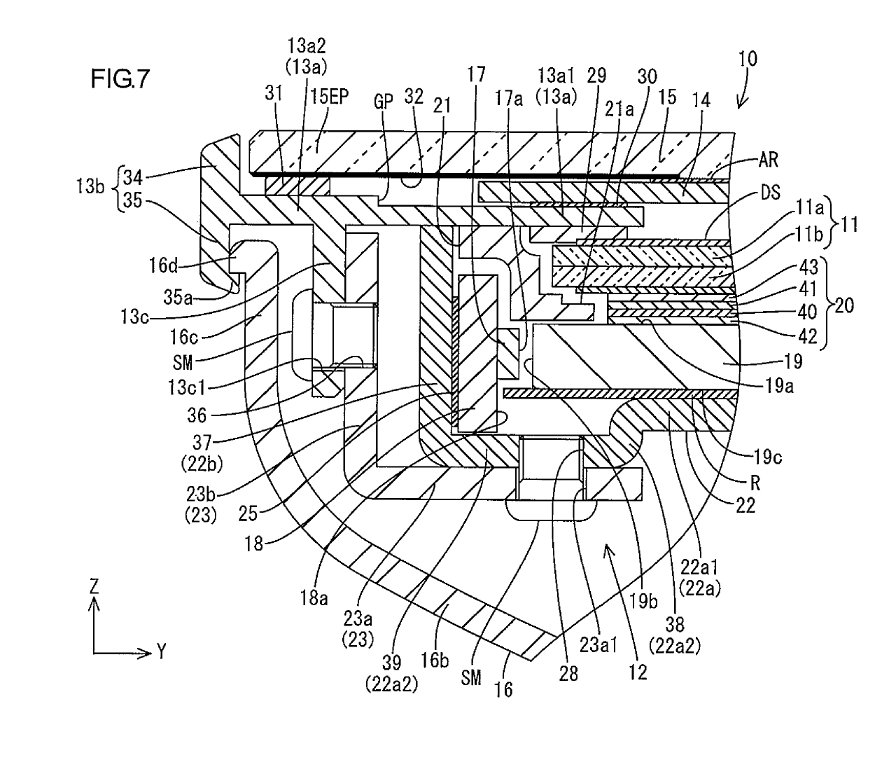

Next, the backlight unit 12 included in the liquid crystal display unit LDU will be described in detail. As illustrated in FIG. 1, the backlight unit 12 has a horizontally-long block-like overall shape similar to the liquid crystal panel 11. As illustrated in FIGS. 6 to 7, the backlight unit 12 includes light emitting diodes (LEDs) 17, an LED board (a light source board) 18, an optical sheet (an optical member) 20, a light blocking frame 21, a chassis 22, and a heat dissipation member 23. The LEDs 17 are light sources. The LEDs 17 are mounted on the LED board 18. The light guide plate 19 guides light from the LEDs 17. The optical sheet 20 is layered on the front side of the light guide plate 19. The light blocking frame 21 holds down the light guide plate 19 from the front. The chassis 22 holds the LED board 18, the light guide plate 19, the optical sheet 20, and the light blocking frame 21 therein. The heat dissipation member 23 is mounted so as to be in contact of the outer surface of the chassis 22. In the backlight unit 12, the LEDs 17 (the LED board 18) are disposed at one of the long sides of the periphery of the backlight unit 12. Namely, the backlight unit 12 is an edge-light type (a side-light type) which uses a method of supplying light from one side.

As illustrated in FIGS. 5 and 7, each LED 17 includes an LED chip that is disposed on a board and sealed with a resin. The board is fixed to the LED board 18. Each LED chip mounted on the board has a main wavelength of emitting light is one kind. Specifically, the LED chip that emits light in a single color of blue is used. In the resin that seals the LED chip, phosphors that emit a certain color of light when excited by the blue light emitted by the LED chip are dispersed. An overall color of light emitted by the phosphors is substantially white. The phosphors may be selected from yellow phosphors that emit yellow light, green phosphors that emit green light, and red phosphors that emit red light and used in a combination. Alternatively, the phosphors in a single color may be used. A surface of each LED 17 is opposite from a mounting surface thereof that is mounted to the LED board 18 is a light emitting surface 17a, that is, the LED 17 is a top surface light emitting type.

As illustrated in FIGS. 5 and 7, the LED board 18 has an elongated plate-like shape that extends in the X-axis direction (the long-side direction of the light guide plate 19 or that of the chassis 22). The LED board 18 is held in the chassis 22 with the plate surface thereof parallel to the X-Z plane, that is, perpendicular to the plate surface of the liquid crystal panel 11 or that of the light guide plate 19. Namely, the LED board 18 is held in a position such that the long-side direction and the short-side direction of the plate surface thereof correspond with the X-axis direction and the Z-axis direction, respectively. Furthermore, the thickness direction thereof perpendicular to the plate surface corresponds with the Y-axis direction. The LED board 18 is disposed such that a plate surface thereof facing the inner side (a mounting surface 18a) is opposite one of long peripheral surfaces of the light guide plate 19 (the light entrance surface 19b) with a predefined distance therefrom in the Y-axis direction. An arrangement direction of the LEDs 17, the LED board 18, and the light guide plate 19 corresponds substantially with the Y-axis direction. The LED board 18 has a length about equal to the long dimension of the light guide plate 19. The LED board 18 is mounted to the one of the long ends of the chassis 22, which will be described later.

As illustrated in FIG. 7, on the plate surface of the LED board 18 on the inner side, that is, the plate surface facing the light guide plate 19 (the surface opposed to the light guide plate 19), the LEDs 17 having the configuration described earlier are surface-mounted. The plate surface is the mounting surface 18a. The LEDs 17 are arranged in line (or linearly) on the mounting surface 18a of the LED board 18 at predefined intervals along the length direction thereof (the X-axis direction). Namely, the LEDs 17 are arranged at intervals along the long-side direction of the backlight unit 12 at one of the long ends of the backlight unit 12. Furthermore, on the mounting surface 18a of the LED board 18, a trace (not illustrated) is formed from a metal film (e.g., a copper film) for connecting the adjacent LEDs 17 in series. The trace extends along the X-axis direction across the LEDs 17. When terminals formed at ends of the trace are connected to an external LED drive circuit, driving power is supplied to the LEDs 17. A base of the LED board 18 is made of metal similar to the chassis 22 and the trace (not illustrated) is formed on a surface of the base via an insulating layer. An insulating material such as ceramic may be used for the base of the LED board 18.

As illustrated in FIGS. 5 and 6, the light guide plate 19 is made of substantially transparent synthetic resin (e.g., acrylic) having a refractive index sufficiently larger than that of the air and high light transmissivity. The light guide plate 19 has a horizontally-long rectangular flat plate-like shape similar to the liquid crystal panel 11. The plate surface of the light guide plate 19 is parallel to the plate surface (or the display surface DS) of the liquid crystal panel 11. The long-side direction and the short-side direction of the light guide plate 19 correspond with the X-axis direction and the Y-axis direction, respectively. The thickness direction of the light guide plate 19 perpendicular to the plate surface corresponds with the Z-axis direction. The light guide plate 19 is disposed immediately below the liquid crystal panel 11 and the optical sheet 20 inside the chassis 22 such that they overlay each other. Namely, the light guide plate 19 is disposed on a side of the optical sheet 20 opposite from the liquid crystal panel 11. One of the long peripheral surfaces of the light guide plate 19 is opposite the LEDs 17 on the LED board 18 at one of the long sides of the chassis 22. The arrangement direction of the LEDs 17 (or the LED board 18) and the light guide plate 19 corresponds with the Y-axis direction. The arrangement direction of the optical sheet (or the liquid crystal panel 11) and the light guide plate 19 (or a direction in which they overlap) corresponds with the Z-axis direction. Namely, the arrangement directions are perpendicular to each other. The light guide plate 19 has a function of receiving rays of light emitted from the LEDs 17 to the light guide plate 19 along the Y-axis direction (the arrangement direction of the LEDs 17 and the light guide plate 19) through the long peripheral surface, transmitting the rays of light therethrough, and guiding the rays of light toward the optical sheet 20 (toward the front or the light exiting side) so that the rays of light exit from the plate surface.

As illustrated in FIGS. 5 and 6, the surface of the light guide plate 19 having a flat plate-like shape facing the front (the surface opposed to the liquid crystal panel 11 or the optical sheet 20) is a light exit surface 19a through which the rays of light traveling therethrough exit toward the optical sheet 20 and the liquid crystal panel 11. One of short peripheries (on the left in FIG. 3) of the light guide plate 19 adjacent to the plate surface having an elongated shape along the X-axis direction (the arrangement direction of the LEDs 17 or the long-side direction of the LED board 18) is opposed to the LEDs 17 (or the LED board 18) with a predefined gap therebetween as illustrated in FIG.7. The long peripheral surface is configured as a light entrance surface through which the rays of light from the LEDs 17 enter. The light entrance surface 19b is parallel to the X-Z plane and substantially perpendicular to the light exit surface 19a. The arrangement direction of the LEDs 17 and the light entrance surface 19b (or the light guide plate 19) corresponds with the Y-axis direction and parallel to the light exit surface 19a. The peripheral surfaces of the light guide plate 19 except for the light entrance surface 19b, specifically, the long peripheral surface opposite from the light entrance surface 19b and the short peripheral surfaces are LED non-opposed peripheral surfaces (light source non-opposed peripheral surfaces) which are not opposed to the LEDs 17 as illustrated in FIGS. 5 and 6.

As illustrated in FIGS. 5 and 6, among the plate surfaces of the light guide plate 19, a reflection sheet R is disposed on the plate surface 19c that is opposite from the light exit surface 19a (an opposite plate surface) so as to cover an entire area of the opposite plate surface 19c. The reflection sheet R is configured to reflect the rays of light in the light guide plate 19 toward the front. Namely, the reflection sheet R is sandwiched between a bottom plate 22a of the chassis 22 and the light guide plate 19. As illustrated in FIG. 5, an end portion of the refection sheet R closer to the light entrance surface 19b of the light guide plate 19 is outer than the light entrance surface 19b, that is extends toward the LEDs 17. The extending end portion reflects the rays of light from the LEDs 17. According to the configuration, light entering efficiency at the light entrance surface 19b improves.

At least one of the light exit surface 19a and the opposite plate surface 19c of the light guide plate 19 or the surface of the reflection sheet R includes a scattering portion (not illustrated) for scattering rays of light inside the light guide plate 19. The scattering portion may be formed by patterning such that a predefined in-plane distribution is achieved. With the scattering portion, the rays of light exiting from the light exit surface 19a are controlled to be evenly distributed within the surface.

As illustrated in FIGS. 5 and 6, the optical sheet 20 has a horizontally-long rectangular shape in a plan view similar to the liquid crystal panel 11 and the chassis 22. The optical sheet 20 is disposed on the light exit surface 19a of the light guide plate 19 between the liquid crystal panel and the light guide plate 19. The optical sheet 20 is configured to transmit the rays of light exiting from the light guide plate 19 and to direct the rays of transmitted light toward the liquid crystal panel 11 while exerting predefined optical effects on the rays of the transmitted light. Specifically, the optical sheet 20 includes four sheets: two prism sheets (light collecting members, lens sheets) 40 and 41 and two light diffusing sheets (optical diffusing members) 42 and 43. The prism sheets 40 and 41 are configured to exert light collecting effects on the rays of light exiting from the light guide plate 19. The light diffusing sheet 42 and 43 are configured to exert light diffusing effects on the rays of light exiting from the light guide plate 19. The prism sheets 40 and 41 are sandwiched between the light diffusing sheet 42 and 43 so as to be overlaid one another. One of the prism sheets 40 and 41 on the rear is referred to as a first prism sheet 40 and the other on the front is referred to as a second prism sheet 41. One of the light diffusing sheets 42 and 43 on the rear is referred to as a first light diffusing sheet 42 and the other on the front is referred to as a second light diffusing sheet 43. The first light diffusing sheet 42 is disposed the closest to the light guide plate 19. The first prism sheet 40 is disposed in front of the first light diffusing sheet 42. The second prism sheet 41 is disposed in front of the first prism sheet 40. The second light diffusing sheet 43 is disposed the closest to the liquid crystal panel 11.

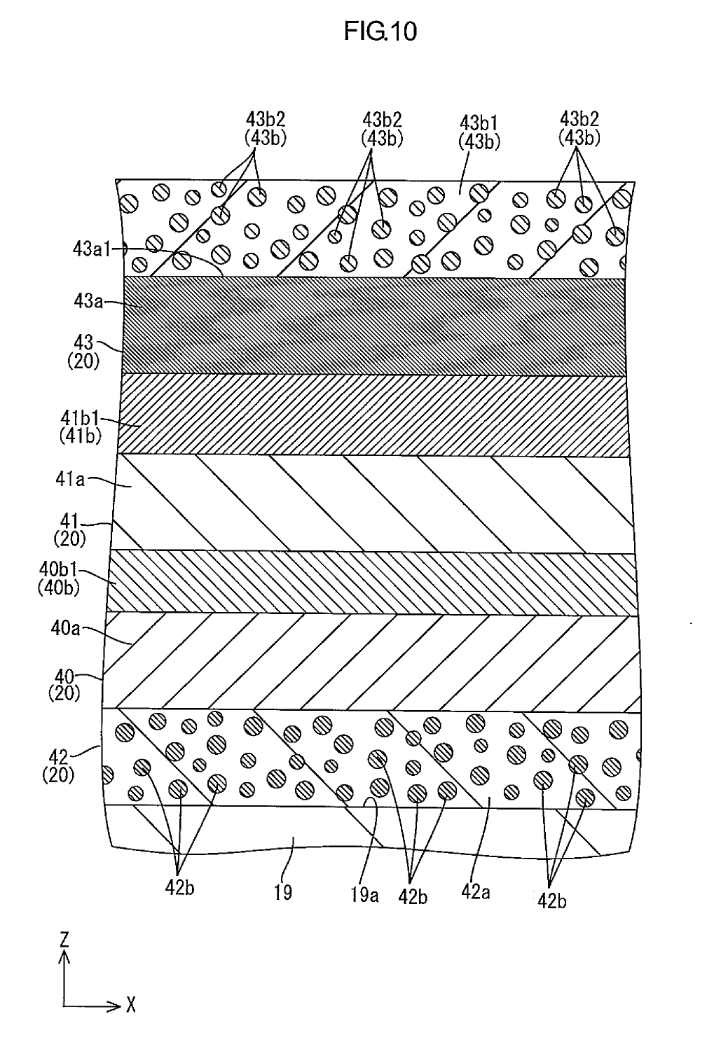

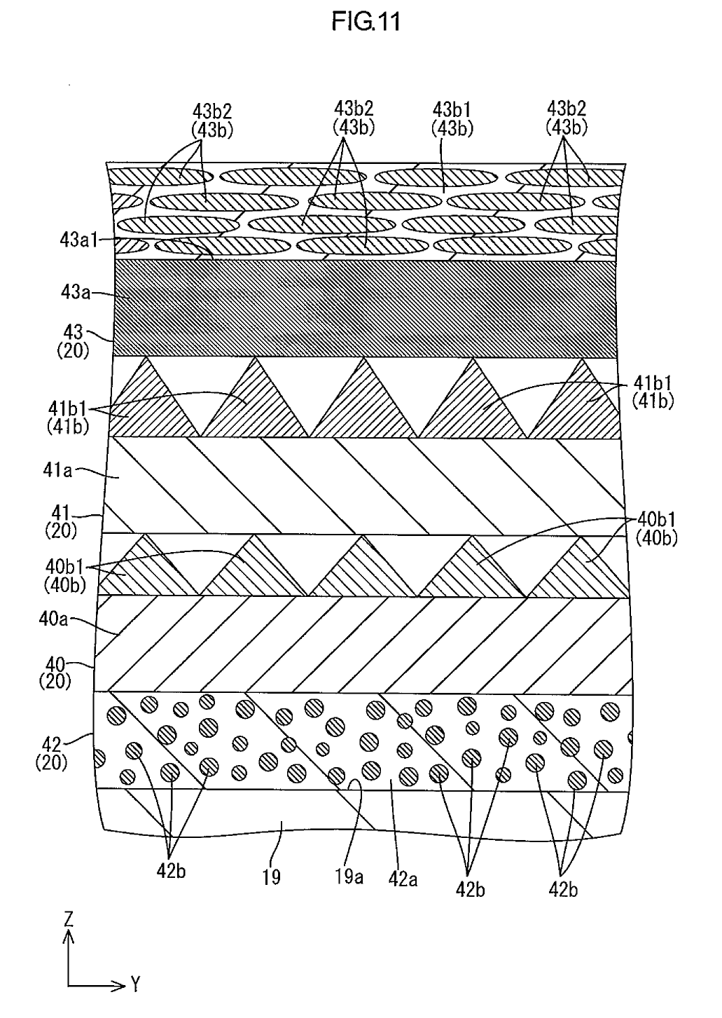

As illustrated in FIGS. 10 and 11, the prism sheets 40 and 41 included in the optical sheet 20 include the bases 40a and 41a, respectively. The prism sheets 40 and 41 further include the prism portions 40b and 41b, respectively. Each of the bases 40a and 41a has a sheet-like shape. The prism portions 40b and 41b are formed on the plate surfaces of the bases 40a and 41a on the front side, respectively, among the surfaces of the bases 40a and 41a on the front and the rear. The front side corresponds to a side opposite from the light guide plate 19 (i.e., the liquid crystal panel 11 side). The bases 40a and 41 are made of substantially transparent synthetic resin. The rays of light exiting from the light guide plate 19 enter the plate surfaces of the bases 40a and 41 on the rear (a side opposite from the prism portions 40b and 41b). The prism portions 40b and 41b are made of substantially transparent synthetic resin. The prism portion 40b includes a number of unit prisms 40b1 and the prism portion 41b includes a number of unit prisms 41b1. The unit prisms 40b1 and 41b1 project from the front plate surfaces of the bases 40a and 41a, respectively, along the Z-axis direction toward the front. Each of the unit prisms 40b1 and 41b1 has a triangular cross section along the second direction (the arrangement direction of the LEDs 17 and the light guide plate 19, the Y-axis direction) and linearly extends along the first direction (the direction perpendicular to the arrangement direction of the LEDs 17 and the light guide plate 19, the X-axis direction). A number of the unit prisms 40b1 and 41b1 are arranged on the plate surfaces of the bases 40a and 41a along the Y-axis direction. Each of the unit prisms 40b1 and 41b1 has an isosceles triangular cross section and includes a pair of sloped surfaces. Each unit prism 40b1 of the first prism sheet 40 has a height smaller than that of each unit prism 41b1 of the second prism sheet 41 and a width about equal to that of each unit prism 41b1 of the second prism sheet 41. A vertex angle between the sloped surfaces of the unit prism 40b1 of the first prism sheet 40 is larger than a vertex angle between the sloped surfaces of the unit prism 41b1 of the second prism sheet 41. The vertex angle between the sloped surfaces of the unit prism 41b1 of the second prism sheet 41 is about right. The unit prisms 40b1 and 41bq are arranged along the second direction at about equal intervals. According to the prism sheets 40 and 41 having such configurations, the rays of light from the first light diffusing sheet 42 (from the light guide plate 19) transmit through the bases 40a and 41a and enter the unit prisms 40b1 and 41b1 of the prism portions 40b and 41b. If the incident angles to the sloped surfaces are larger than the critical angle, the rays of light are fully reflected and returned to the first light diffusing sheet 42 (retroreflected). If the incident angles are smaller than the critical angle, the rays of light are refracted and exit. The rays of light exiting from the prism sheets 40 and 41 are controlled such that the traveling directions thereof with respect to the second direction are closer to the direction toward the front (the direction normal to the plate surface of the prism sheet 40 or 41). Namely, the light collecting effects are selectively exerted on the rays of light with respect to the second direction. The brightness of light toward the front directed from the optical sheet 20 to the liquid crystal panel 11 improves.

As illustrated in FIGS. 10 and 11, the first light diffusing sheet 42 of the light diffusing sheets 42 and 43 included in the optical sheet 20 is sandwiched between the light guide plate 19 and the first prism sheet 40. The first light diffusing sheet 42 includes a light transmissive resin portion 42a and isotropic light diffusing particles (spherical fillers) 42b dispersed in the light transmissive resin portion 42a. The light transmissive resin portion 42a contains a substantially transparent resin having high light transmissivity as a base material, for example, acrylic, polyurethane, polyester, silicone, epoxy, and ultraviolet curing resins. A refractive index may be in a range from 1.3 to 1.6. The isotropic light diffusing particles 42b are made of substantially transparent synthetic resin having high light transmissivity, for example, an inorganic material including silica, aluminum hydroxide, and zinc oxide, and an organic material including acrylic, polyurethane, and polystyrene. A refractive index may be in a range from 1.3 to 1.6. Each of the isotropic light diffusing particles 42b has a spherical shave having a substantially true circle cross section. The isotropic light diffusing particles 42b diffuse rays of light which hit the isotropic light diffusing particles 42b in the isotropic manner. In the first light diffusing sheet 42, the rays of light exiting from the light exit surface 19a of the light guide plate 19 entering the plate surface of the first light diffusing sheet 42 on the rear (the light entrance-side plate surface) hit the isotropic light diffusing particles 42a dispersed in the light transmissive resin portion 42a. With the first light diffusing sheet 42, the rays of light are diffused in the isotropic manner. According to the configuration, the rays of light diffused in the isotropic manner are directed from the front plate surface (the light exit-side plate surface) of the first light diffusing sheet 42 toward the first prism sheet 40. Namely, the first light diffusing sheet 42 has isotropy in exit angle distribution of the exiting light such that amounts of diffused light with respect to the first direction (the X-axis direction) and the second direction (the Y-axis direction) are about equal and exit angle ranges with respect to the first direction and the second direction are about equal. The first light diffusing sheet 42 is a so-called “isotropic light diffusing sheet (isotropic light diffusing member).” The “exit angle range” is an angle range between a direction of light exiting through the first light diffusing sheet 42 relative to a direction of a line normal to the plate surface of the first light diffusing sheet 42 on the positive side and that on the negative side, that is, the angle range in which the brightness of the exiting light is equal to or higher than a certain level (specifically, equal to or higher than a half of the highest brightness level). With the first light diffusing sheet 42, directivities of the rays of light exiting from the light guide plate 19 are compensated. Detailed configuration and function of the second light diffusing sheet 43 of the optical sheet 20 will be described later.

As illustrated in FIGS. 5 and 6, the light blocking frame 21 is formed in a frame-like (a picture frame-like) shape that extends along the periphery (or the peripheral surfaces) of the light guide plate 19. The light blocking frame 21 presses down the periphery of the light guide plate 19 for substantially the entire periphery. The light blocking frame 21 is made of synthetic resin. The light blocking frame 21 includes a surface in black, that is, has light blocking properties. The light blocking frame 21 is disposed such that an inner edge portion 21a thereof are arranged between the periphery of the light guide plate 19 and LEDs 17 and the periphery (or the peripheral surfaces) of the liquid crystal panel 11 and that of the optical sheet 20 for the entire periphery thereof. The light blocking frame 21 optically separate those from one another. According to the configuration, the rays of light from the LEDs 17 and not entering through the light entrance surface 19b or the rays of light leaking through the peripheral surfaces of the light guide plate 19 (the light entrance surface 19b and three LED non-opposed peripheral surfaces that are not opposed to the LEDs 17) are blocked by the light blocking frame 21 and thus less likely to directly enter peripheries (especially the peripheral surfaces) of the liquid crystal panel 11 and the optical sheet 20. Each of three edge portions of the light blocking frame 21 not overlapping the LEDs 17 and the LED board 18 in a plan view (short edge portions and a long edge portion farther from the LED board 18) includes a portion projecting from the bottom plate 22a of the chassis 22 and a portion that supports the frame 13 from the rear. A long edge portion overlapping the LEDs 17 and the LED board 18 in a plan view is formed so as to cover the end of the light guide plate 19 and the LED board 18 (or the LEDs 17) from the front and bridge the short edge portions. The light blocking frame 21 is fixed to the chassis 22, which will be described next, with fixing members such as screws.

The chassis 22 is formed from a metal sheet having high thermal conductivity such as an aluminum sheet and an electrolytic zinc coated steel sheet (SECC). As illustrated in FIGS. 5 and 6, the chassis 22 includes the bottom plate 22a and side plates 22b. The bottom plate 22a has a horizontally-long rectangular shape similar to the liquid crystal panel 11. The side plates 22b project from outer edges (long edges and short edges) of the bottom plate 22a toward the front, respectively. A long-side direction and a short-side direction of the chassis 22 (or the bottom plate 22a) correspond with the X-axis direction and the Y-axis direction, respectively. A large portion of the bottom plate 22a is a light guide plate holding portion 22a1 for supporting the light guide plate 19 from the rear (an opposite side from the light exit surface 19a). An end portion of the bottom plate 22a closer to the LED board 18 is a board holding portion that protrudes toward the rear so as to form a step. As illustrated in FIG. 5, the board holding portion 22a2 has an L-like cross section. The board holding portion 22a2 includes a rising portion 38 and a holding bottom portion 39. The rising portion 38 bends from an end of the light guide plate holding portion 22a1 and rises toward the rear. The holding bottom portion 39 bends from a distal end of the rising portion 38 and projects toward a side opposite from the light guide plate holding portion 22a1. A position at which the rising portion 38 rises from the end of the light guide plate holding portion 22a1 is farther from the LEDs 17 than the light entrance surface 19b of the light guide plate 19 (closer to the middle of the light guide plate holding portion 22a1. The long side plate 22b bends and rises from the distal end of the holding bottom portion 39 toward the front. The LED board 18 is mounted to the long side plate 22b continues to the board holding portion 22a2. The short side plate 22b is a board mounting portion 37. The board mounting portion 37 includes an opposed surface that is opposed to the light entrance surface 19b of the light guide plate 19. The LED board 18 is mounted to the opposed surface. A plate surface of the LED board 18 opposite from the mounting surface 18a on which the LEDs 17 are mounted is fixed to an inner plate surface of the board mounting portion 37 with a board fixing member 25 such as a double-sided tape. The mounted LED board 18 is arranged with a small gap to the inner plate surface of the holding bottom portion 39 of the board holding portion 22a2. On the rear plate surface of the bottom plate 22a of the chassis 22, a liquid crystal panel drive circuit board (not illustrated) for controlling driving of the liquid crystal panel 11, an LED drive circuit board (not illustrated) for supplying driving power to the LEDs 17, and a touchscreen drive circuit board (not illustrated) for controlling driving of the touchscreen 14 are mounted.

The heat dissipation member 23 is formed from a metal sheet having high thermal conductivity such as an aluminum sheet. As illustrated in FIGS. 1 and 5, the heat dissipation member 23 extends along the long edge of the chassis 22, specifically, the board holding portion 22a2 for holding the LED board 18. As illustrated in FIG. 7, the heat dissipation member 23 includes a first heat dissipation portion 23a and a second heat dissipation portion 23b. The first heat dissipation portion 23a has an L-like cross section. The first heat dissipation portion 23a is parallel to an outer surface of the board holding portion 22a2 and in contact with the outer surface. The second heat dissipation portion 23b is parallel to an outer surface of the side plate 22b that continues to the board holding portion 22a2 (or the board mounting portion 37). The first heat dissipation portion 23a has an elongated flat plate-like shape that extends along the X-axis direction. A plate surface of the first heat dissipation portion 23a facing the front and parallel to the X-Y plane is in contact with the outer surface of the holding bottom portion 39 of the board holding portion 22a2 for about the entire length thereof. The first heat dissipation portion 23a is fixed to the holding bottom portion 39 with screws SM. The first heat dissipation portion 23a includes screw insertion holes 23a1 in which the screws SM are inserted. The holding bottom portion 39 includes screw holes 28 for the screws SM to be screwed. According to the configuration, heat from the LEDs 17 are transmitted to the first heat dissipation portion 23a via the LED board 18, the board mounting portion 37, and the board holding portion 22a2. The screws SM are arranged at intervals along the extending direction of the first heat dissipation portion 23a and fixed thereto. The second heat dissipation portion 23b has an elongated flat plate-like shape that extends along the X-axis direction. A plate surface of the second heat dissipation portion 23b facing the inner side and parallel to the X-Z plane is arranged opposite the outer plate surface with a predefined gap between the plate surface and the outer plate surface of the board mounting portion 37.

Next, the frame 13 included in the liquid crystal display unit LDU will be described. The frame 13 is made of metal having high thermal conductivity such as aluminum. As illustrated in FIG. 1, the frame 13 has a horizontally-long rectangular frame-like (a picture frame-like) overall shape along the peripheries (or the outer edge portions) of the liquid crystal panel 11, the touchscreen 14, and the cover panel 15. The frame 13 may be prepared by stamping. As illustrated in FIGS. 5 and 6, the frame 13 holds down the periphery of the liquid crystal panel 11 and holds the liquid crystal panel 11, the optical sheet 20, and the light guide plate 19, which are layered, together with the chassis 22 of the backlight unit 12. The frame 13 receives the peripheries of the touchscreen 14 and the cover panel 15 from the rear. The frame 13 is disposed between the peripheries of the liquid crystal panel 11 and the touchscreen 14. According to the configuration, a predefined gap is provided between the liquid crystal panel 11 and the touchscreen 14. Even if the touchscreen 14 is pushed by the cover panel 15 when an external force is applied to the cover panel 15 and deformed toward the liquid crystal panel 11, the deformed touchscreen 14 is less likely to affect the liquid crystal panel 11.

As illustrated in FIGS. 5 and 6, the frame 13 includes a frame portion (a frame base portion, a picture frame-like portion) 13a, a rolled portion (a tubular portion) 13b, and mounting plate portions 13c. The frame portions 13a are along the peripheries of the liquid crystal panel 11, the touchscreen 14, and the cover panel 15. The rolled portion 13b continues from the outer edge of the frame portion and surrounds the touchscreen 14, the cover panel 15, and the case 16 from the outer side. The mounting plate portions 13c project from the frame portion 13a toward the rear. The mounting plate portions 13c are mounted to the chassis 22 and the heat dissipation member 23.

As illustrated in FIGS. 5 and 6, the frame portion 13a has a horizontally-long rectangular frame-like shape in a plan view including plate surfaces having flat plate-like shapes and parallel to the plate surfaces of the liquid crystal panel 11, the touchscreen 14, and the cover panel 15. An outer periphery 13a2 of the frame portion 13a has a thickness larger than that of an inner periphery 13a1 thereof. A gap GP is provided at a boundary between the inner periphery 13a1 and the outer periphery 13a2. The inner periphery 13a1 of the frame portion 13a is disposed between the periphery of the liquid crystal panel 11 and the periphery of the touchscreen 14. The outer periphery 13a2 receives the periphery of the cover panel 15 from the rear. Because the front plate surface of the frame portion 13a is covered with the cover panel 15 for about the entire area thereof, the front surface is less likely to be exposed to the outside. According to the configuration, even if a temperature of the frame 13 increases due to the heat from the LEDs 17, a user of the liquid crystal display device 10 is less likely to directly touch a portion of the frame 13 exposed to the outside. This configuration is advantageous in terms of safety. A shock absorber 29 is fixed to the rear plate surface of the inner periphery 13a1 of the frame portion 13a. The shock absorber 29 is for pressing down the periphery of the liquid crystal panel 11 from the front and absorbing an impact that may be applied to the periphery of the liquid crystal panel 11. A first fixing member 30 is fixed to the front plate surface of the inner periphery 13a1 for fixing the periphery of the touchscreen 14 and absorbing an impact that may be applied to the periphery of the touchscreen 14. The shock absorber 29 and the first fixing member 30 are arranged at a position within the inner periphery 13a1 overlapping each other in a plan view. A second fixing member 31 is fixed to the front plate surface of the outer periphery 13a2 of the frame portion 13a for fixing the periphery of the cover panel 15 and absorbing an impact that may be applied to the periphery of the cover panel 15. The shock absorber 29 and the fixing members 30 and 31 are disposed so as to extend along the sides of the frame portion 13a except for four corners. The fixing members 30 and 31 may be double-side tapes that include base materials having cushioning properties.

As illustrated in FIGS. 5 and 6, the rolled portion 13b includes a first rolled portion 34 and a second rolled portion 35. The first rolled portion 34 has a short horizontally-long rectangular tubular overall shape in a plan view and projects from an outer peripheral edge of the outer periphery 13a2 of the frame portion 13a toward the front. The second rolled portion 35 projects from the outer peripheral edge of the outer periphery 13a2 of the frame portion 13a toward the rear. Namely, the outer edge of the frame portion 13a continues to the inner surface of the rolled portion 13b having a short rectangular tubular shape at about the middle of the inner surface with respect the axial direction (the Z-axis direction) for the entire periphery of the rolled portion 13b. An inner periphery of the first rolled portion 34 is opposed to the peripheries of the touchscreen 14 and the cover panel 15. An outer periphery of the first rolled portion 34 is exposed to the outside of the liquid crystal display device 10, that is, forms appearances of sides of the liquid crystal display device 10. The second rolled portion 35 covers front edges (or mounting portions 16c) of the case 16 that is disposed behind the frame portion 13a from peripheral sides. An inner periphery of the second rolled portion 35 is opposed to the mounting portion 16c of the case 16, which will be described later. An outer periphery of the second rolled portion 35 is exposed to the outside of the liquid crystal display device 10, that is, forms appearances of sides of the liquid crystal display device 10. The second rolled portion includes a frame-side fixing portion 35a having a hook-like cross section at a distal end thereof. The case 16 is held to the frame-side fixing portion 35a to maintain the case 16 being fixed.

As illustrated in FIGS. 5 and 6, the mounting plate portions 13c project from the outer periphery 13a2 of the frame portion 13a toward the rear and has a plate-like shape that extends along the sides of the frame portion 13a. Plate surface of the mounting plate portions 13c are substantially perpendicular to the plate surface of the frame portion 13a. The mounting plate portions 13c are arranged at the respective sides of the frame portion 13a. The mounting plate portion 13c at the long side of the frame portion 13a on the LED board 18 side is mounted such that the inner plate surface thereof is in contact with the outer plate surface of the second heat dissipation portion 23b of the heat dissipation member 23. The mounting plate portions 13c are fixed to the second heat dissipation portion 23b with screws SM. The mounting plate portions 13c include screw insertion holes 13c1. The second heat dissipation portion 23b includes screw holes 36 for the screws SM to be fixed. Heat from the LEDs 17 transmitted from the first heat dissipation portion 23a to the second heat dissipation portion 23b is transmitted to the mounting plate portions 13c and then to the entire area of the frame 13. According to the configuration, the heat is efficiently dissipated. The mounting plate portion 13c is indirectly fixed to the chassis 22 via the heat dissipation member 23. The mounting plate portion 13c at the long side of the frame portion 13a farther from the LED board 18 and the mounting plate portions 13c at the short sides of the frame portion 13a are fixed with the screws SM such that the inner plate surface thereof is in contact with the outer plate surfaces of the side plates 22b of the chassis 22. The mounting plate portions 13c include screw insertion holes 13c1 in which the screws SM are inserted. The side plates 22b include screw holes 36 for the screws SM to be fixed. The screws SM are arranged along the extending direction of each mounting plate portion 13c at intervals and fixed to the mounting plate portions 13c.

Next, the touchscreen 14 fixed to the frame 13 the is described above will be described. As illustrated in FIGS. 1, 5 and 6, the touchscreen 14 is a position input device through which the user can input information regarding positions within the display surface DS of the liquid crystal panel 11. The touchscreen 14 has a horizontally-long rectangular shape. The touchscreen 14 includes a glass substrate that is substantially transparent and has high light transmissivity and a predefined touchscreen pattern (not illustrated) formed on the substrate. Specifically, the touchscreen 14 includes a glass substrate having a horizontally-long rectangular shape similar to the liquid crystal panel 11 in a plan view and a touchscreen transparent electrode (not illustrated) formed the front plate surface of the substrate. The touchscreen transparent electrodes are the touchscreen pattern using the projected capacitive touchscreen technology. A number of the touchscreen transparent electrodes are arranged in a grid within the plate surface of the substrate. Terminals (not illustrated) are formed in one of long edge portions of the touchscreen 14. The terminals are connected to traces continue from the touchscreen transparent electrodes that are portions of the touchscreen pattern. A flexible printed circuit board, which is not illustrated, is connected to the terminals. Electrical potentials are applied to the touchscreen transparent electrodes of the touchscreen pattern by a touchscreen drive circuit board. The inner plate surface of the touchscreen 14 at the periphery thereof is fixed to the inner periphery 13a1 of the frame portion 13a of the frame 13 with the first fixing member 30 that is described earlier while they are opposed each other.

Next, the cover panel 15 mounted to the frame 13 will be described. As illustrated in FIGS. 1, 5 and 6, the cover panel 15 covers the entire area of the touchscreen 14 from the front to protect the touchscreen 14 and the liquid crystal panel 11. The cover panel 15 covers the entire area of the frame portion 13a of the frame 13 from the front and forms a front appearance of the liquid crystal display device 10. The cover panel 15 has a horizontally-long rectangular shape in a plan view. The cover panel 15 includes a base in a plate-like shape and made of transparent glass having high light transmissivity, preferably, toughened glass. Chemically toughened glass may be preferable for the tempered glass used for the cover panel 15. The chemically toughened glass includes a chemically toughened layer formed through a chemical toughening process on a surface of the glass base having a plate-like shape. The chemical toughening process may be a process for toughening a glass base having a plate-like shape by replacing alkali metal ions included in glass material with alkali metal ions each having a larger diameter by alkali metal ion exchange. The chemically toughened layer formed as above is a compressive stress layer (ion exchange layer) in which compression stress remains. Because the cover panel 15 has mechanical strength and high shock resistance, the cover panel 15 more properly protects the touchscreen 14 and the liquid crystal panel 11 disposed behind the cover panel 15 from break or damage.

As illustrated in FIGS. 5 and 6, the cover panel 15 has a horizontally-long rectangular shape similar to the liquid crystal panel 11 and the touchscreen 14 in a plan view. A size of the cover panel 15 in a plan view is slightly larger than those of the liquid crystal panel 11 and the touchscreen 14. The cover panel 15 includes a projecting portion 15EP that project outward over the peripheries of the liquid crystal panel 11 and the touchscreen 14 for the entire periphery, that is, the projecting portion 15EP has an eaves-like shape. The projecting portion 15EP has a horizontally-long rectangular frame-like shape (a picture frame-like shape) which surrounds the liquid crystal panel 11 and the touchscreen 14. An inner plate surface of the projecting portion 15EP is fixed to the outer periphery 13a2 of the frame portion 13a of the frame 13 with the second fixing member 31 described earlier while they are opposed each other. A middle portion of the cover panel 15 opposite the touchscreen 14 is layered on the touchscreen 14 on the front via the antireflective film AR.

Aa illustrated in FIGS. 5 and 6, a plate surface light blocking layer (a light blocking layer, a plate surface light blocking portion) 32 is formed on an inner plate surface (or a rear plate surface, a plate surface opposed to the touchscreen 14) of the cover panel 15 that includes the projecting portion 15EP at the outer periphery. The plate surface light blocking layer 32 is made of light blocking material such as black paint. The plate surface light blocking layer 32 is formed by printing the light blocking material on the inner plate surface and thus integral with the plate surface. For forming the plate surface light blocking layer 32, printing including screen printing and inkjet printing may be used. The plate surface light blocking layer 32 is formed in the entire area of the projecting portion 15EP and an area that overlap the peripheries of the touchscreen and the liquid crystal panel 11 in a plan view. Namely, the plate surface light blocking layer 32 is formed so as to surround the display area of the liquid crystal panel 11. Therefore, rays of light outside the display area are blocked by the plate surface light blocking layer 32 and thus images are displayed in the display area with high display quality.

Next, the case 16 mounted to the frame 13 will be described. The case 16 is made of synthetic resin or metal. As illustrated in FIGS. 1 to 6, the case 16 has a bowl-like shape with an opening on the front and covers the frame portion 13a and the mounting plate portions 13c of the frame 13, the chassis 22, and the heat dissipation member 23 from the rear and forms a rear appearance of the liquid crystal display device 10. The case 16 includes a bottom portion 16a, a curved portion 16b, and a mounting portion 16c. The bottom portion 16a is substantially flat. The curved portion 16b curves from a boundary of the bottom portion 16a toward the front and has a curved cross section. The mounting portion 16c projects from a boundary of the curved portion 16b substantially straight toward the front. The mounting portion 16c includes a case-side fixing portion 16d having a hook-like cross section. The case-side fixing portion 16d is hooked to the frame-side fixing portion 35d of the frame 13. According to the configuration, the case 16 is maintained fixed to the frame 13.

As described earlier, the liquid crystal panel 11 according to this embodiment has the anisotropy in the distribution of rays of transmitting light such that the exit angle range of the transmitting light is relatively small with respect to the first direction (the X-axis direction) along the short-side direction of the display pixel PX and relatively large with respect to the second direction (the Y-axis direction) along the long-side direction of the display pixel PX. If the rays of light from the backlight to the liquid crystal panel 11 are isotropic, anisotropy similar to the distribution of exit angle of transmitting light in the liquid crystal panel 11 may occur in the viewing angle of the liquid crystal panel 11. The isotropy may be required in the viewing angle of the liquid crystal display device 10 in some situations. For example, a high level of isotropy may be required in the viewing angle when a user switch positions of a smartphone or a tablet computer between a portrait position (portrait mode) and a landscape position (landscape mode) during use. If the viewing angle is different between when the user sees images on the display surface DS of the liquid crystal display device 10 in portrait position and when the user sees images on the display surface DS of the liquid crystal display device 10 in landscape position, it may cause significant degradation in the display quality.

In this embodiment, the optical sheet 20 includes a second light diffusing sheet 43 that is an anisotropic light diffusing sheet having an inverse exit angle distribution to that of the liquid crystal panel 11. As illustrated in FIGS. 10 and 11, the second light diffusing sheet 43 is for directing the rays of light supplied by the LEDs 17 through the light guide plate 19 and other three optical sheets 20 (prism sheets 40 and 41 and a first light diffusing sheet 42) toward the liquid crystal panel 11. The exit angle distribution of the second light diffusing sheet 43 has anisotropy such that an exit angle range is relatively large with respect the first direction (the X-axis direction) and relatively small with respect to the second direction (the Y-axis direction). Namely, a light diffusing effect exerted by the second light diffusing sheet 43 on the rays of transmitting light is an “anisotropic light diffusing effect” through which an amount of the transmitting light is relatively large with respect to the first direction and relatively small with respect to the second direction. The “anisotropic light diffusing effect” corresponds to an angle range between a direction of light exiting through the second light diffusing sheet 43 relative to a direction of a line normal to a plate surface of the second light diffusing sheet 43 on the positive side and that on the negative side, that is, the angle range in which the brightness of the exiting light is equal to or higher than a certain level (specifically, equal to or higher than a half of the highest brightness level). A configuration of the second light diffusing sheet 43 will be described in detail below.

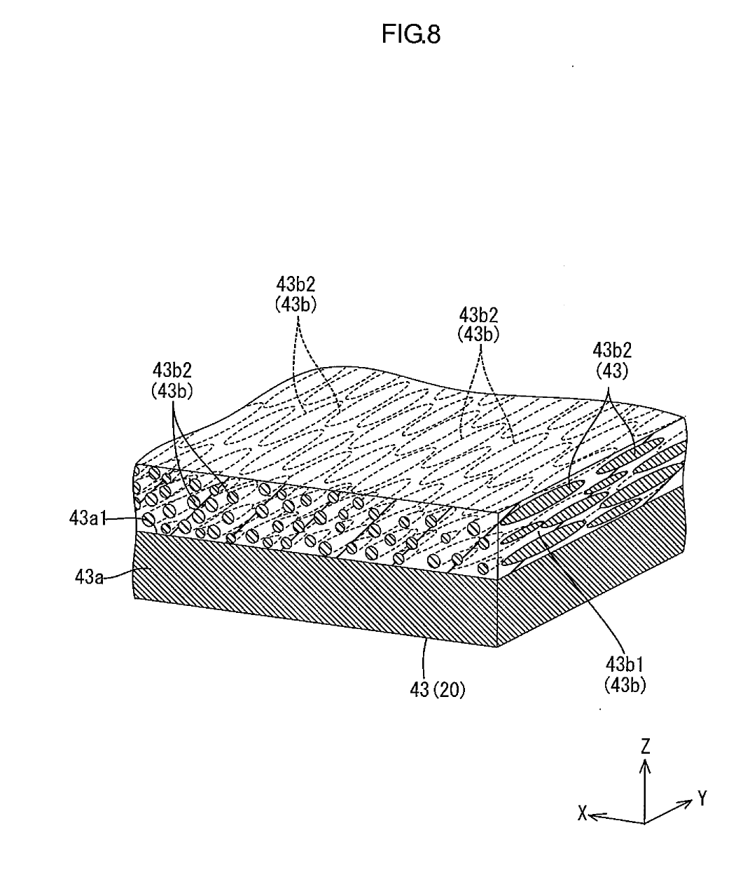

As illustrated in FIGS. 10 and 11, the second light diffusing sheet 43 is sandwiched between the liquid crystal panel 11 and the second prism sheet 41. The second light diffusing sheet 43 is disposed the closest to the liquid crystal panel 11 (the farthest from the light guide plate 19) in the optical sheet 20. Namely, the second light diffusing sheet 43 exerts the anisotropic light diffusing effect on the rays of light exiting from the light guide plate 19 through the light exit surface 19a and transmitting through the first light diffusing sheet 42, the first prism sheet 40, and the second prism sheet 41 in this sequence and supplies the rays of light on which the anisotropic light diffusing effect is exerted directly to the liquid crystal panel 11. As illustrated in FIG. 8, the second light diffusing sheet 43 includes a base 43a and an anisotropic light diffusing portion 43b. The base 43a has a sheet-like shape. The anisotropic light diffusing portion 43b is formed on a front plate surface of the base 43a, that is, a plate surface on the liquid crystal panel 11 side (a side opposite from the light guide plate 19) (a light exit-side plate surface 43a1 that will be described later). The base 43a is a substantially transparent sheet-like member having high light transmissivity. The base 43a may be made of thermoplastic resin such as PET. The base includes the light exit-side plate surface 43a1 that is the plate surface on the front side configured to direct rays of light toward the liquid crystal panel 11. In a process of producing the second light diffusing sheet 43, the thermoplastic resin to form the base 43a may be formed into a film having a predefined thickness and formed into the base 43a by biaxially stretching the film along the X-axis direction and the Y-axis direction under high temperature environment. The formed base 43a includes thermoplastic resin molecules that are aligned with respect to directions in which the film is stretched (the X-axis direction and the Y-axis direction) in the production process and thus has high strength and high thermal resistance. A thickness of the base 43a may be in a range from 25 μm to 100 μm.

As illustrated in FIGS. 8, 10, and 11, the anisotropic light diffusing portion 43b is integrally formed with the light exit-side plate surface 43a1 that is the front plate surface of the base 43a directly facing the liquid crystal panel 11 and configured to direct rays of light toward the liquid crystal panel 11. The anisotropic light diffusing portion 43b has a thickness smaller than the base 43a, specifically, in a range from 10 μm to 20 μm. The anisotropic light diffusing portion 43b includes a light transmissive resin layer 43b1 and an anisotropic light diffusing particles (longitudinal fillers) 43b2. The light transmissive resin layer 43b1 is a film having a predefined thickness and overlaid on the light exit-side plate surface 43a1 of the base 43a. A large number of the anisotropic light diffusing particles 43b2 are contained in the light transmissive resin layer 43b1. The light transmissive resin layer 43b1 may include a substantially transparent synthetic resin having high light transmissivity such as acrylic, polyurethane, silicon, epoxy, and ultraviolet curable resin as a main material. In the process of producing the second light diffusing sheet 43, a solvent may be added to the synthetic resin that is the base material of the light transmissive resin layer 43b1 to transform the synthetic resin to a liquid state. Furthermore, a large number of the anisotropic light diffusing particles 43b2 are dispersed in the solution and the solution is applied to the light exit-side plate surface 43a1 of the base 43a along a predefined direction and solidified. As a result, the light transmissive resin layer 43b1 that contains the anisotropic light diffusing particles 43b2 is integrally formed with the base 43a as layers. The light transmissive resin layer 43b1 may have a refractive index in a range from 1.3 to 1.6.

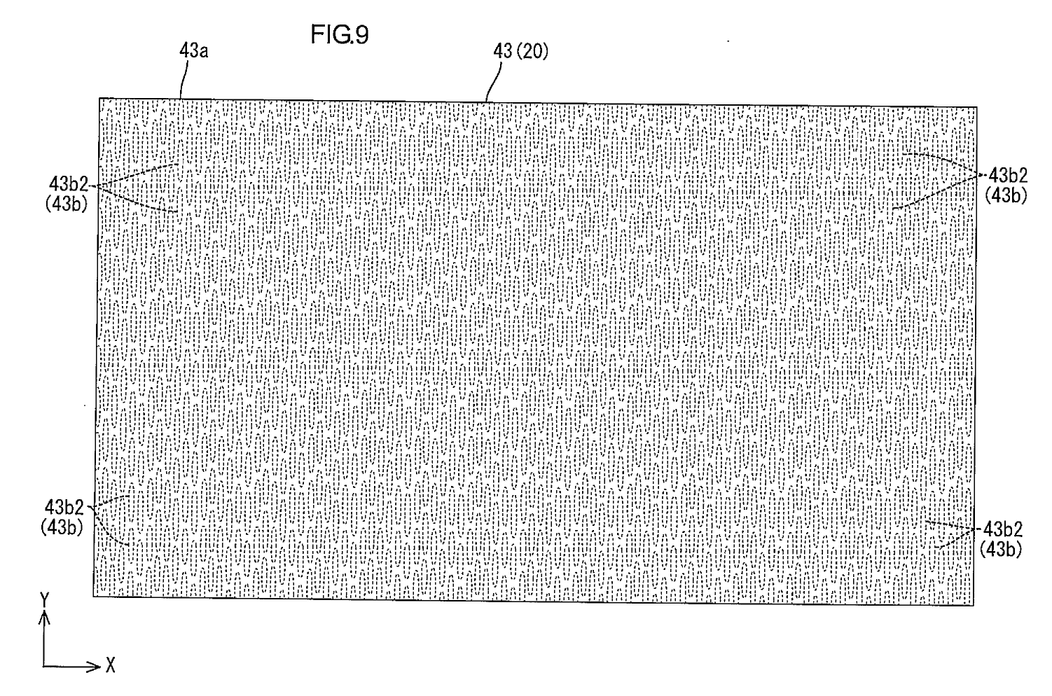

As illustrated in FIGS. 8 and 9, a large number of the anisotropic light diffusing particles 43b2 are dispersed in the light transmissive resin layer 43b1 described above and aligned in specific positions. The anisotropic light diffusing particles 43b2 are made of substantially transparent resin having high light transmissivity with a refractive index in a range from 1.3 to 1.6. The resin may be a non-organic material such as silica, aluminum hydroxide, and zinc oxide or an organic material such as acrylic, polyurethane, and polystyrene. The weight ratio of the anisotropic light diffusing particles 43b2 in the light transmissive resin may be in a range from 10 wt % to 40 wt %. Each of the anisotropic light diffusing particles 43b2 has a longitudinal shape with a long axis and a short axis. An overall shape of each anisotropic light diffusing particle 43b2 is an oval sphere-like shape. Specifically, a cross section of each anisotropic light diffusing particle 43b2 along the long-axis direction is an oval shape and a cross section thereof along the short-axis direction is a round shape close to a true circle. Furthermore, a diameter of each anisotropic light diffusing particle 43b2 decreases from the middle toward ends in the long-axis direction. Namely, the ends of each anisotropic light diffusing particle 43b2 in the long-axis direction are rounded. Each anisotropic light diffusing particle 43b2 is formed in a symmetric shape about an axis of symmetry that is along the short axis and at the middle of the long axis. A length of each anisotropic light diffusing particle 43b2 along the long axis thereof may be about 10 μm. A maximum width of each anisotropic light diffusing particle 43b2 along the short axis and a maximum diameter thereof may be about 2 μm. Actual sizes of those may be slightly different from one another depending on the anisotropic light diffusing particles 43b2.

As illustrated in FIGS. 8 to 11, the anisotropic light diffusing particles 43b2 dispersed in the light transmissive resin layer 43b1 are aligned such that the short-axis direction is along the second direction (the Y-axis direction) and the short-axis direction is along the first direction (the X-axis direction). Namely, the anisotropic light diffusing particles 43b2 are arranged in positions (or patterns) with a specific directivity such that the long-axis direction thereof corresponds with the second direction and the short-axis direction thereof corresponds with the first direction. The exit angle range of the transmitting light through the liquid crystal panel 11 is relatively large with respect to the second direction and relatively small with respect to the first direction. The anisotropic light diffusing particles 43b2 are held in the positions described above with the light transmissive resin layer 43b1 that is filled therearound. Some of the anisotropic light diffusing particles 43b2 in the light transmissive resin layer 43b1 may not be in the completely same positions described above. The anisotropic light diffusing particles 43b2 may include those in positions with the long axes slightly angled with respect to the second direction or those in positions with the short-axis direction slightly angled with respect to the first direction. Although the anisotropic light diffusing particles 43b2 are arranged in the positions described above, three-dimensional positions thereof in the light transmissive resin layer 43b1, that is, X-axis, Y-axis, and Z-axis positions thereof (including intervals) may be at random (or irregular). Namely, the anisotropic light diffusing particles 43b2 form a non-periodic structure that does not have periodicity unlike the display pixels PX in the liquid crystal panel 11.

In the production of the second light diffusing sheet 43, as described earlier, a mixed solution is prepared by dispersing a large number of the anisotropic light diffusing particles 43b2 in the light transmissive resin layer 43b1 that is in the liquid state. When the mixed solution is applied to the light exit-side plate surface 43a1 of the base 43a, the anisotropic light diffusing particles 43b2 each having the longitudinal shape are automatically oriented in the positions with the long-axis direction thereof along the direction in which the solution is applied due to shear stress that is exerted during the application of the solution (see FIGS. 8 to 11). By setting the direction in which the solution is applied to correspond with the second direction (the Y-axis direction), the anisotropic light diffusing particles 43b2 are easily oriented such that the long-axis direction thereof corresponds with the second direction and the short-axis direction thereof corresponds with the first direction. The exit angle range of the transmitting light through the liquid crystal panel 11 is relatively large with respect to the second direction and relatively small with respect to the first direction. Each anisotropic light diffusing particle 43b2 has narrow ends and the oval cross section along the long-axis direction and the round cross section close to a true circle along the short-axis direction. Therefore, the light diffusing particles 43b2 are smoothly aligned when the solution is applied. When the solution applied to the base 43a is solidified, the light transmissive resin layer 43b1 is formed on the light exit-side plate surface 43a1 of the base 43a in layers. The anisotropic light diffusing particles 43b2 contained in the light transmissive resin layer 43b1 are held in the positions such that the long-axis direction is along the second direction and the short-axis direction is along the first direction.

According to the second light diffusing sheet 43 having such a configuration, when the rays of light transmitting through the base 43a from the second prism sheet 41 side (the light guide plate 19 side) enter the anisotropic light diffusing portion 43b, the rays of light hit the anisotropic light diffusing particles 43b2 formed in the shape and oriented in the positions described above. The rays of light which hit the anisotropic light diffusing particles 43b2 are diffused and directed toward the front side. As illustrated in FIGS. 8, 10 and 11, the amount of diffused light is larger with respect to the short-axis direction of the anisotropic light diffusing particles 43b2 (the first direction) and smaller with respect to the long-axis direction of the anisotropic light diffusing particles 43b2 (the second direction). The first direction corresponds with the short-axis direction of each anisotropic light diffusing particle 43b2 and the second direction corresponds with the long-axis direction of each anisotropic light diffusing particle 43b2. The first direction is a strong light diffusing direction in which stronger light diffusing effects are exerted on the rays of light. The second direction is a weak light diffusing direction in which weaker light diffusing effects are exerted on the rays of light. Namely, the anisotropic light diffusing particles 43b according to this embodiment has light diffusing anisotropy. The strong light diffusing direction corresponds with the first direction (the short-side direction of the display pixel PX) and the weak light diffusing direction corresponds with the second direction (the long-side direction of the display pixel PX). The exit angle range of the transmitting light through the liquid crystal panel 11 is relatively small with respect to the first direction and relatively large with respect to the second direction. The light on which the anisotropic light diffusing effects are exerted by the anisotropic light diffusing portion 43b is supplied to the liquid crystal panel 11. The incidence angle range of the light supplied to the display pixels PX in the liquid crystal panel 11 is larger with respect to the first direction and smaller with respect to the second direction. The exit angle range of the rays of light directed toward the front side after passing through the display pixels PX of the liquid crystal panel 11 and the display surface DS with respect to the first direction and the exit angle range with respect to the second direction are about equal to each other. Namely, the rays of exit light are substantially isotropic. Because the viewing angle of the liquid crystal panel 11 is isotropic, the viewing angles are about equal when the user sees images on the display surface DS of the liquid crystal display device 10 in portrait position and images on the display surface DS of the liquid crystal display device 10 in landscape position. According to the configuration, the images are displayed on the display surface DS of the liquid crystal panel 11 with high display quality.

The anisotropic light diffusing particles 43b2 included in the anisotropic light diffusing portion 43b are oriented in the positions described above but randomly arranged in the light transmissive resin layer 43b1. Therefore, the rays of exiting light are randomly diffused and thus the directivities of the rays of exiting light are properly compensated. Furthermore, the anisotropic light diffusing particles 43b2 that are randomly arranged form the non-periodic structure. Therefore, the anisotropic light diffusing particles 43b2 are less likely to become obstacles to the arrangement of the display pixels PX in the liquid crystal panel 11 (see FIGS. 3 and 4) and thus moire fringes, which are interference fringes, are less likely to occur in the liquid crystal panel 11.

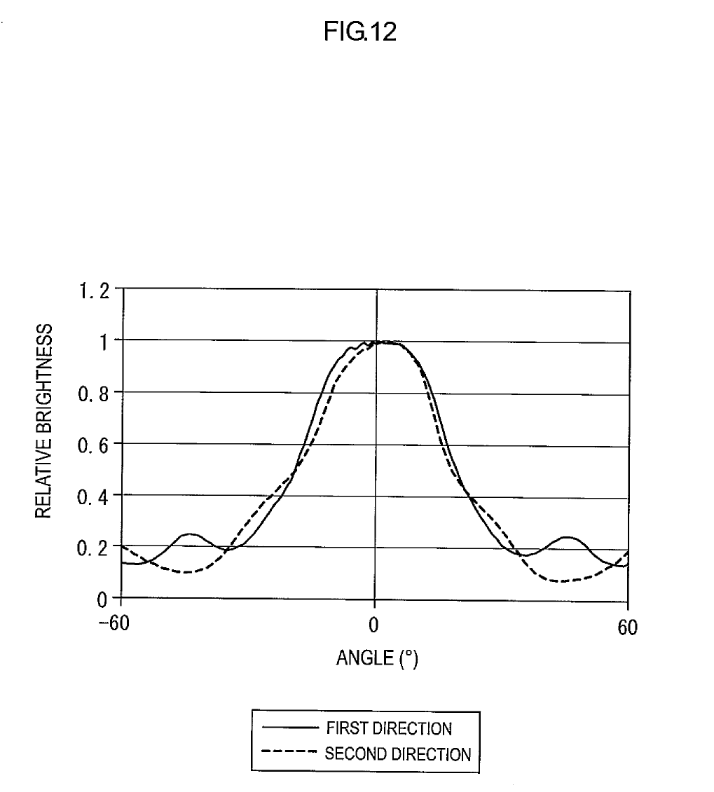

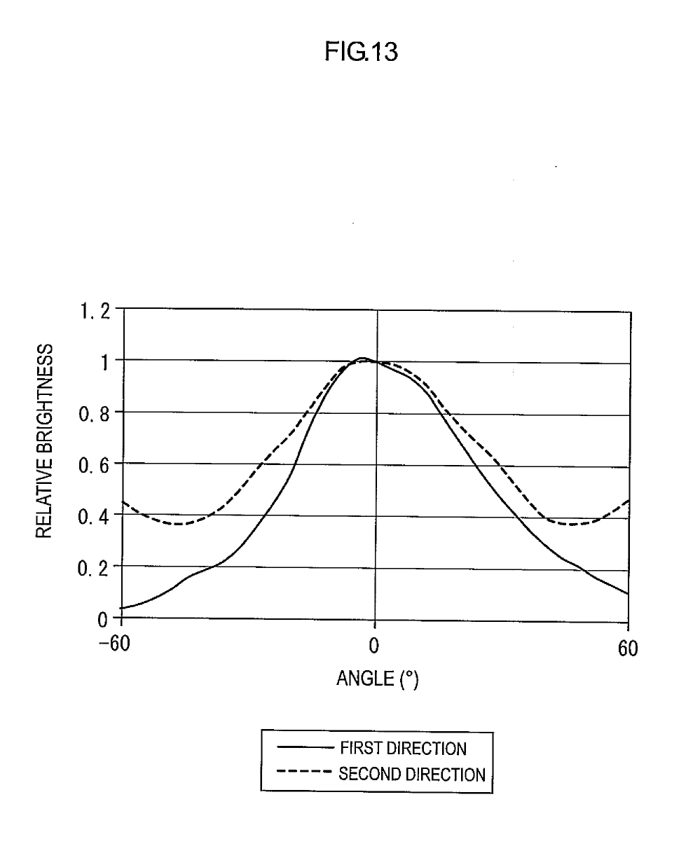

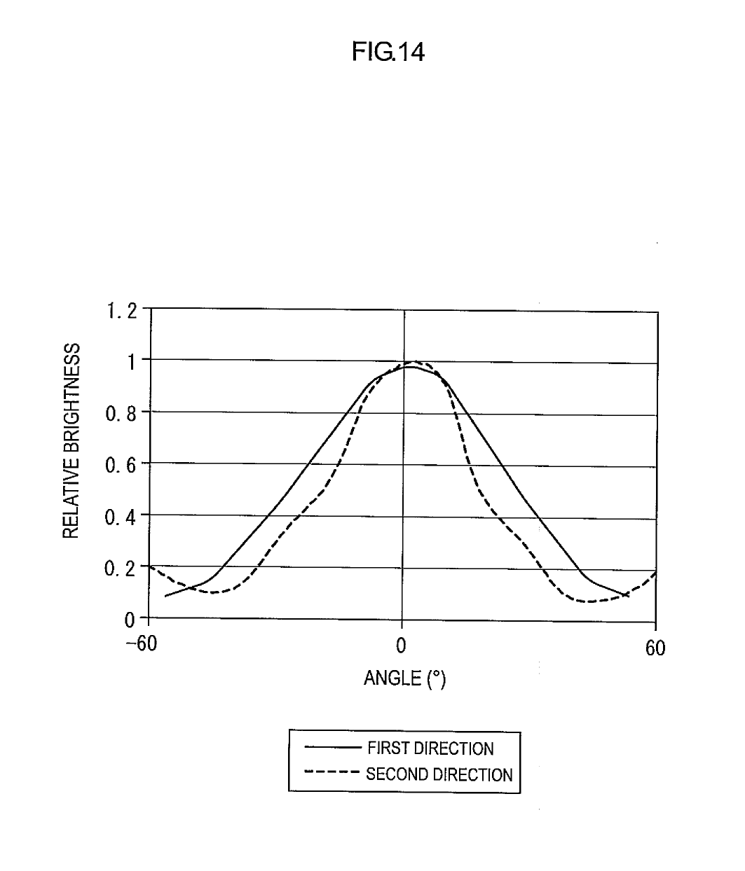

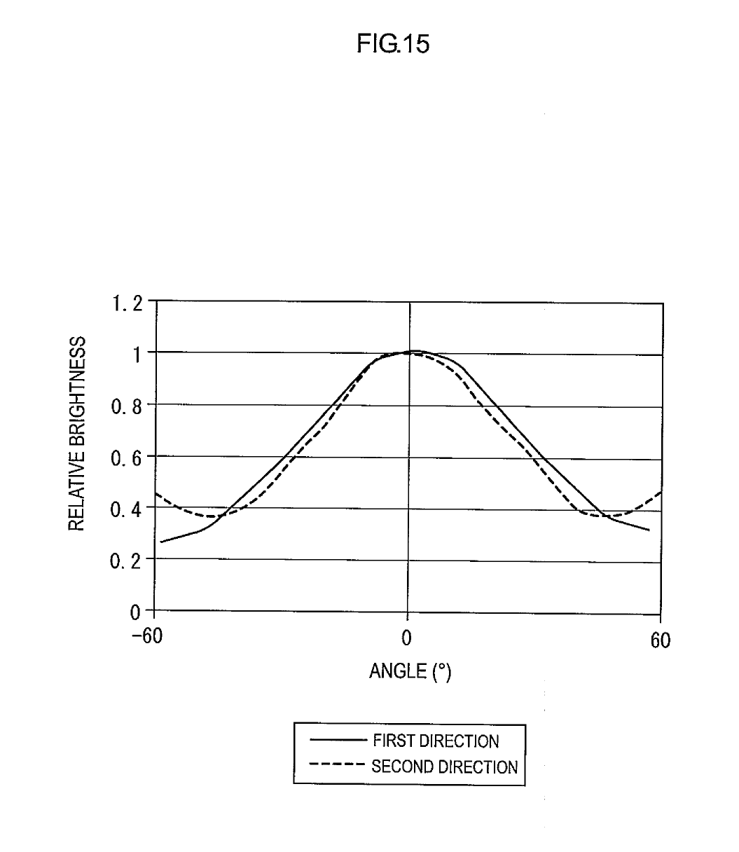

Comparative experiments using the optical sheet 20 that includes the second light diffusing sheet 43 included in this embodiment (see FIGS. 10 and 11) and an optical sheet that does not include the second light diffusing sheet 43 included in this embodiment (not illustrated) will be described. In the comparative experiments, the backlight unit 12 and the liquid crystal display device 10 that includes the optical sheet 20 including the second light diffusing sheet 43 is defined as a sample. A backlight unit and a liquid crystal display device that includes an optical sheet includes the first light diffusing sheet 42 described earlier instead of the second light diffusing sheet 43 is defined as a comparative sample. Brightness levels of light exiting from the backlight units were measured. Furthermore, the liquid crystal panels 11 are lit with the light from the respective backlights and brightness levels of the light exiting from the liquid crystal panels 11 were measured. The results are illustrated in FIGS. 12 to 15. The backlight unit of the comparative sample has the same configuration as the embodiment described above except for the optical sheet that includes two prism sheets 40 and 41 described earlier are sandwiched by two first light diffusing sheets (isotropic light diffusing sheets) 42 from the front and the rear. The liquid crystal panels 11 in the comparative sample and the sample have the same configuration, which has been described earlier in the description of the embodiment. The drawings that illustrate the measurements are as follows. FIG. 12 illustrates brightness distributions of light exiting from the backlight unit of the comparative sample. FIG. 13 illustrates brightness distribution of light exiting from the liquid crystal panel 11 of the liquid crystal display device of the comparative sample. FIG. 14 illustrates brightness distribution of light exiting from the backlight unit 12 of the sample. FIG. 15 illustrates brightness distribution of light exiting from the liquid crystal panel 11 of the liquid crystal display device 10 of the sample. In FIGS. 12 and 14, the vertical axes represent relative brightness levels of light exiting from the respective backlight units and the horizontal axes represent angles (in degrees) relative to the front direction. In FIGS. 13 and 15, the vertical axes represent relative brightness levels of light exiting from the respective liquid crystal panels 11 and the horizontal axes represent angles (in degrees) relative to the front direction. The relative brightness levels represented by the vertical axes in FIGS. 12 to 15 are expressed by values relative to a brightness level in the front direction which is defined as a reference (1.0). In FIGS. 12 to 15, curves in solid lines express the brightness distributions of light exiting along the first direction (the X-axis direction) and curves in broken lines express the brightness distributions of light exiting along the second direction (the Y-axis direction).

The results of the comparative experiments will be described. First, the result of the comparative sample will be described. According to the curves in FIG. 12, the exit angle ranges of the exiting light with respect to the first direction and the second direction are about equal, that is, the backlight unit of the comparative sample has an isotropic exit angle distribution. This proves that the backlight unit in the comparative sample that includes the optical sheet having the configuration in which two prism sheets 40 and 41 are sandwiched between the first light diffusing sheet 42 that are isotropic light diffusing sheet has an isotropic brightness distribution. According to the curves in FIG. 14, the exit angle range of the exiting light with respect to the first direction is relatively small and that of the exiting light with respect to the second direction is relatively large, that is, the liquid crystal display device of the comparative sample has an anisotropic exit angle distribution. Even through the exit angle distribution of exiting light of the backlight device of the comparative sample is isotropic, the liquid crystal display device has anisotropy in the viewing angle similar to the isotropy in the exit angle distribution of the liquid crystal panel 11. This is because the liquid crystal panel 11 has the configuration in which the display pixels are arranged such that the short-side direction corresponds with the first direction and the long-side direction corresponds with the second direction.

Next, the results of the sample will be described. According to FIG. 13, the backlight unit 12 of the sample has the exit angle ranges of the exiting light which are relatively large with respect to the first direction and relatively small with respect to the second direction. Namely, the exit angle distribution is inversed anisotropy to the exit angle distribution of the liquid crystal panel 11. This proves that the backlight unit 12 of the sample including the optical sheet 20 that has the configuration in which the second light diffusing sheet 43 that is an isotropic light diffusing sheet is disposed the closest to the liquid crystal panel 11 has anisotropy in the brightness distribution. According to the curves in FIG. 15, the exit angle range of the exiting light with respect to the first direction and that of the exiting light with respect to the second direction are about equal, that is, the liquid crystal display device of the comparative sample has an isotropic exit angle distribution. Even through the exit angle distribution of exiting light of the liquid crystal panel 11 is anisotropic because it has the configuration in which the short-side direction and the long-side direction of the display pixels PX correspond with the first direction and the second direction, respectively, the liquid crystal display device 10 has isotropy in the viewing angle. This is because the second light diffusing sheet 43 in the backlight unit 12 has inversed anisotropy to the exit angle distribution of the liquid crystal panel 11 and thus the difference in the exit angle range between the first direction and the second direction is compensated. This proves that the viewing angle of the liquid crystal display device 10 is isotropic.

As described above, the liquid crystal display device (a display device) 10 according to this embodiment includes the liquid crystal panel (an anisotropic display component) 11 and the second light diffusing sheet 43. The liquid crystal panel 11 includes the display surface DS for displaying images. The liquid crystal panel 11 has anisotropy in the exit angle distribution of the exiting light such that the exit angle range of the exiting light which are relatively small with respect to the first direction along the display surface DS and relatively large with respect to the second direction. The second light diffusing sheet 43 is disposed over the display surface DS of the liquid crystal panel 11 or the opposite surface to the display surface DS. The second light diffusing sheet 43 has anisotropy in the exit angle distribution of the exiting light such that the exit angle ranges of the exiting light are relatively large with respect to the first direction and relatively small with respect to the second direction.

According to the configuration, if the second light diffusing sheet 43 that is an anisotropic optical member is disposed over the opposite surface from the display surface DS, images are displayed on the display surface DS with the rays of light exiting from the second light diffusing sheet 43 that is an isotropic optical member and passing through the liquid crystal panel 11. If the second light diffusing sheet 43 that is an anisotropic optical member is disposed over the display surface DS of the liquid crystal panel 11, images are displayed on the display surface DS with the rays of light exiting from the liquid crystal panel 11 and passing through the second light diffusing sheet 43 that is an isotropic optical member. The liquid crystal panel 11 has the anisotropy in the exit angle distribution of the exiting light such that the exit angle range of the exiting light is relatively small with respect to the first direction along the display surface DS and relatively large in the second direction that is along the display surface DS and perpendicular to the first direction. Therefore, the viewing angle regarding the images displayed on the display surface DS may have the anisotropy similar to the exit angle distribution of the liquid crystal panel 11. The second light diffusing sheet 43 that is an anisotropic optical member has the anisotropy in the exit angle distribution of the exiting light such that the exit angle range of the exiting light is relatively large with respect to the first direction and relatively small with respect to the second direction. The exit angle ranges of the liquid crystal panel 11 are relatively small with respect to the first direction and relatively large with respect to the second direction. According to the configuration, the viewing angle regarding the images displayed on the display surface DS of the liquid crystal panel 11 is isotropic. Therefore, images are displayed on the display surface DS with high display quality.

The anisotropic optical member includes at least the second light diffusing sheet (an anisotropic light diffusing member) 43 for directing light while diffusing. The second light diffusing sheet 43 has the light diffusing isotropy such that the amounts of diffused light are relatively large with respect to the first direction and relatively small with respect to the second direction. According to the configuration, the light exiting from the second light diffusing sheet 43 having the light diffusing anisotropy has the exit angle distribution such that the exit angle range in the liquid crystal panel 11 becomes relatively large with respect to the first direction because the amount of the diffused light is relatively large with respect to the first direction and relatively small with respect to the second direction because the amount of the diffused light is relatively small with respect to the second direction. The exit angle ranges of the liquid crystal panel 11 are relatively small with respect to the first direction and relatively large with respect to the second direction. According to the configuration, the viewing angle regarding the images displayed on the display surface DS becomes isotropic.

The second light diffusing sheet 43 includes the anisotropic light diffusing particles 43b2 each having the longitudinal shape. The anisotropic light diffusing particles 43b2 are arranged with the long-axis direction along the second direction and the short-axis direction along the first direction. According to the configuration, degrees of diffusing of light with the anisotropic light diffusing particles 43b2 are relatively low with respect to the long-axis direction and relatively high with respect to the short-axis direction. With the second light diffusing sheet 43 including the anisotropic light diffusing particles 43b2 arranged such that the long-axis direction is along the second direction and the short-axis direction is along the first direction, the amounts of diffused light become relatively large with respect to the first direction and relatively small with respect to the second direction. The exit angle ranges of the liquid crystal panel 11 are relatively small with respect to the first direction and relatively large with respect to the second direction. According to the configuration, the viewing angle regarding images displayed on the display surface DS of the liquid crystal panel 11 becomes isotropic.

The second light diffusing sheet 43 includes the base 43a having the light transmissivity and the light transmissive resin layer 43b1 on the base 43a. The light transmissive resin layer 43b1 contains a large number of anisotropic light diffusing particles 43b2 dispersed therein. In the light transmissive resin layer 43b1, the anisotropic light diffusing particles 43b2 are oriented such that the long-axis direction is along the second direction and the short-axis direction is along the first direction. According to the configuration, the rays of light transmitting through the second light diffusing sheet 43 are diffused with the anisotropic light diffusing particles 43b2 such that the amounts of diffused light are large with respect to the first direction and small with respect to the second direction. The light diffusing particles 43b2 are dispersed in the light transmissive resin layer 43b1 and oriented such that the long-axis direction is along the second direction and the short-axis direction is along the first direction. Furthermore, in the production of the second light diffusing sheet 43, the material of the light transmissive resin layer 43b1 in the liquid state containing the anisotropic light diffusing particles 43b2 dispersed therein is applied and solidified. As a result, the light transmissive resin layer 43b1 is formed on the base 43a. The anisotropic light diffusing particles 43b2 are arranged such that the long-axis direction thereof is along the direction of the application of the material. Therefore, the anisotropic light diffusing light diffusing particles 43b2 are easily oriented.

Each of the anisotropic light diffusing particles 43b2 has the shape that the diameter of the anisotropic light diffusing particle 43b2 decreases from the middle toward ends in the long-axis direction. According to the configuration, in comparison to a configuration in which each of the anisotropic light diffusing particles 43b2 has a constant diameter for an entire dimension thereof in the long-axis direction, the anisotropic light diffusing particles 43b2 are more smoothly oriented such that the long-axis direction thereof is along the direction in which the material is applied during the application of the material in formation of the light transmissive resin layer 43b1 on the base 43a by applying the material of the light transmissive resin layer 43b1 in the liquid state and containing the anisotropic light diffusing particles 43b2 dispersed therein to the base 43a and by solidifying the material. According to the configuration, the anisotropic light diffusing particles 43b2 are more properly oriented in the light transmissive resin layer 43b1.

Each of the anisotropic light diffusing particles 43b2 has the oval cross section along the long-axis direction. The ends of the long dimension of each anisotropic light diffusing particle 43b2 are rounded. During the formation of the light transmissive resin layer 43b1 on the base 43a by applying the material of the light transmissive resin layer 43b1 in the liquid state and containing the anisotropic light diffusing particles 43b2 dispersed therein to the base 43a and by solidifying the material in the production of the second light diffusing sheet 43, the anisotropic light diffusing particles 43b2 are less likely to be stuck during the application of the material and when the anisotropic light diffusing particles 43b2 are oriented. Therefore, the anisotropic light diffusing particles 43b2 are further smoothly oriented such that the long-axis direction thereof is along the direction in which the material is applied and thus the anisotropic light diffusing particles 43b2 are further properly oriented in the light transmissive resin layer 43b1.

Each of the anisotropic light diffusing particles 43b2 has a round cross section along the short-axis direction. In comparison to a configuration in which each anisotropic light diffusing particle 43b2 has a rectangular cross section along the short-axis direction, during the formation of the light transmissive resin layer 43b1 on the base 43a by applying the material of the light transmissive resin layer 43b1 in the liquid state and containing the anisotropic light diffusing particles 43b2 dispersed therein and by solidifying the material in the production of the second light diffusing sheet 43, the anisotropic light diffusing particles 43b2 are less likely to be stuck during the application of the material and when the anisotropic light diffusing particles 43b2 are oriented. Therefore, the anisotropic light diffusing particles 43b2 are further smoothly oriented such that the long-axis direction thereof is along the direction in which the material is applied and thus the anisotropic light diffusing particles 43b2 are further properly oriented in the light transmissive resin layer 43b1.

The second light diffusing sheet 43 included in the anisotropic optical member is disposed on the opposite surface of the liquid crystal panel 11 opposite from the display surface DS. Furthermore, other optical members, that is, the first prism sheet 40 and the second prism sheet 41, and the first light diffusing sheet 42 for transmitting light are disposed over the second light diffusing sheet 43. The second light diffusing sheet 43 is disposed closer to the liquid crystal panel 11 in comparison to the other optical members, that is, the first prism sheet 40 and the second prism sheet 41, and the first light diffusing sheet 42. According to the configuration, the rays of light are supplied to the liquid crystal panel 11 via the other optical member, that is, the first prism sheet 40 and the second prism sheet 41, the first light diffusing sheet 42, and the second light diffusing sheet 43 included in the anisotropic optical member passing therethrough in sequence. Namely, the rays of light supplied to the liquid crystal panel 11 are the rays of light exiting from the second light diffusing sheet 43 included in the anisotropic optical member. According to the configuration, the viewing angle regarding the images displayed on the display surface DS of the liquid crystal panel 11 further properly become isotropic and thus the images are displayed with higher display quality. The second light diffusing sheet 43 is disposed over the opposite surface of the liquid crystal panel 11 from the display surface DS. Therefore, the user of the liquid crystal display device 10 directly sees the images displayed on the display surface DS, that is, the display quality of the images further improves.

The second light diffusing sheet 43 in the anisotropic optical member is disposed over the opposite surface of the liquid crystal panel 11 from the display surface DS. The liquid crystal display device 10 further includes the LEDs (a light source) 17 and the light guide plate 19 disposed on the side of the second light diffusing sheet 43 opposite from the liquid crystal panel 11. The light guide plate 19 is for directing rays of light from the LEDs 17. The light guide plate 19 includes the peripheral surface configured as the light entrance surface 19b and the plate surface facing the second light diffusing sheet 43 in the anisotropic optical member and configured as the light exit surface 19a. The rays of light enter through the light entrance surface 19b. The rays of light exit from the light exit surface 19a. According to the configuration, the rays of light emitted from the LEDs 17 enter the light guide plate 19 through the light entrance surface 19b, transmit through the light guide plate 19, and exit from the light exit surface 19a. The rays of light that exit from the light exit surface 19a are directed to the second light diffusing sheet 43 in the anisotropic optical member and then from the second light diffusing sheet 43 in the anisotropic optical member to the liquid crystal panel 11. With the light guide plate 19, the rays of light directed to the second light diffusing sheet 43 in the anisotropic optical member are less likely to have unevenness. Therefore, the optical performances of the second light diffusing sheet 43 in the anisotropic optical member are properly exerted.

The liquid crystal panel 11 includes the display pixels PX arranged in groups in a matrix along the display surface DS. Each of the display pixels PX has a planar shape with the short-side direction corresponding with the first direction and the long-side direction corresponding with the second direction. According to the configuration, images are displayed on the display surface DS of the liquid crystal panel 11 with the rays of light exiting from the display pixels PX that are arranged in groups in a matrix along the display surface DS. Each display pixel PX has the planar surface with the short-side direction corresponding with the first direction and the long-side direction corresponding with the second direction. Therefore, the exit angle ranges of the rays of light exiting from the liquid crystal panel 11 are relatively small with respect to the first direction and relatively large with respect to the second direction. The liquid crystal panel 11 has the exit angle distribution such that the exit angle ranges are relatively large with respect to the first direction and relatively small with respect to the second direction. Therefore, the viewing angle regarding the images displayed on the display surface DS of the liquid crystal panel 11 becomes isotropic. According to the configuration, the images are displayed on the display surface DS with high display quality.

The anisotropic display component is the liquid crystal panel 11 that includes the liquid crystal layer (liquid crystals) 11c sealed between the boards 11a and 11b. Such a display device, that is, the liquid crystal display device 10 may be used in various applications including displays of smartphones and tablet computers.

### Second Embodiment

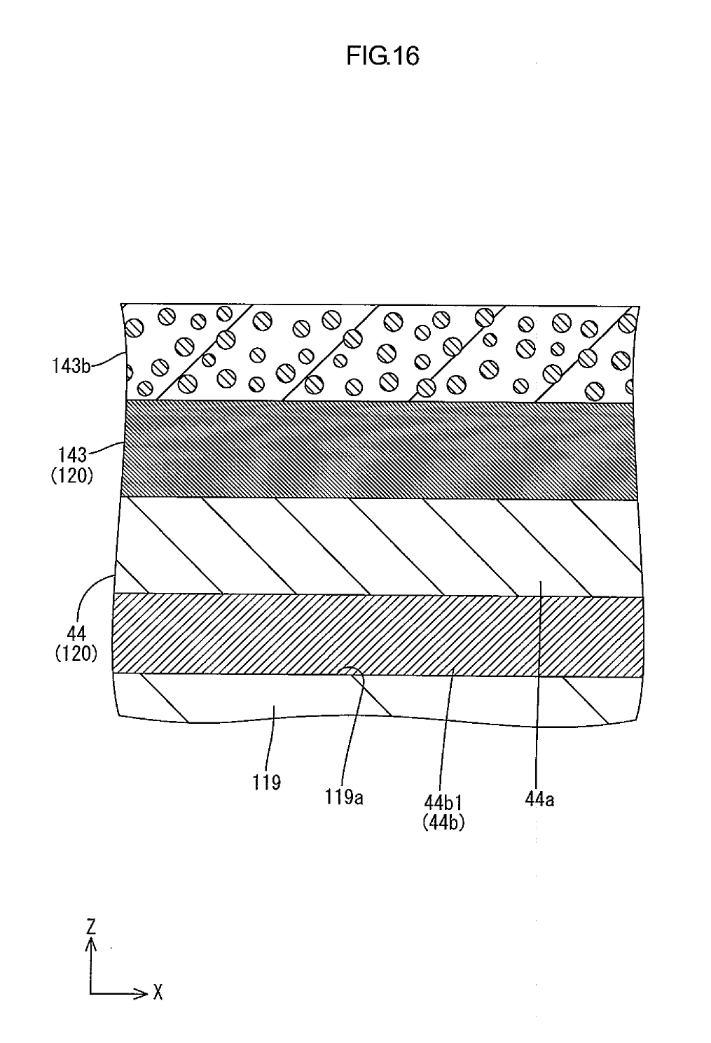

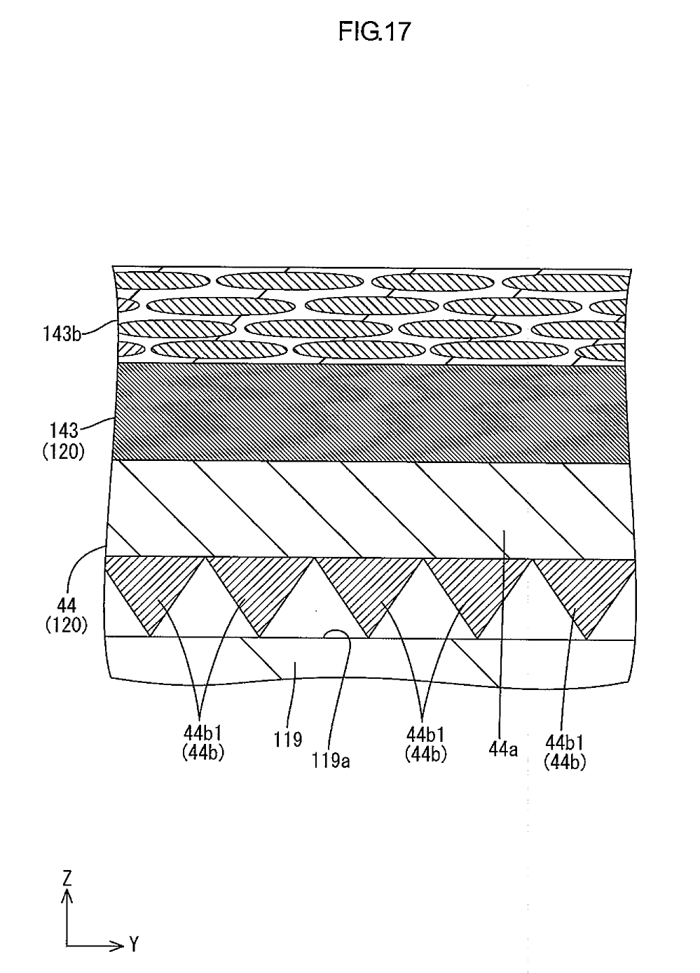

A second embodiment of the present invention will be described with reference to FIGS. 16 and 17. The second embodiment includes an optical sheet 120 having a configuration different from that of the first embodiment. Structures, functions, and effects similar to those of the first embodiment will not be described.

As illustrated in FIGS. 16 and 17, the optical sheet 120 according to this embodiment includes two sheets: one is a second light diffusing sheet (an anisotropic light diffusing sheet) 143 and the other is a prism sheet (an anisotropic light collecting member) 44. The second light diffusing sheet 143 has a configuration similar to that of the first embodiment. The prism sheet 44 is disposed between the second light diffusing sheet 143 and a light guide plate 119. In the following description, the second light diffusing sheet 143 will not be described in detail.

The prism sheet 44 includes a base 44a and a prism portion (an anisotropic light collecting portion) 44b. The base 44a has a sheet-like shape. The prism portion 44b is formed on a plate surface of the base 44a which is a plate surface of the base 44a on the rear side, that is, on the light guide plate 119 side among front and rear plate surfaces of the base 44a. In the prism sheet 44 in this embodiment, the position of the prismportion 44b relative to the base 44a in the front-rear direction is opposite from the first prism sheet 40 or the second prism sheet 41 in the first embodiment described above (see FIGS. 10 and 11). The base 44a is made of substantially transparent synthetic resin and configured such that rays of light exiting from the light guide plate 119 enter the plate surface (a light entrance-side surface) of the base 44a on the rear side (a prism portion 44b side). The prism portion 44b is made of substantially transparent synthetic resin. The prism portion 44b includes a large number of unit prisms 44b1 that project from the rear plate surface of the base 44a in the Z-axis direction toward the rear. Each of the unit prisms 44b1 has a triangular cross section along the second direction (the Y-axis direction). The unit prisms 44b1 are linearly arranged along the first direction (the X-axis direction). A number of the unit prisms 44b1 are arranged on the plate surface of the base 44a along the second direction. Each of the unit prisms 44b1 has a substantially isosceles triangular cross section and includes a pair of sloped surfaces and a vertex angle formed by the sloped surfaces is about aright angle. Vertex angles, widths of the bases and heights of unit prisms 44b1 arranged along the second direction are about the same, respectively. Intervals between the adjacent unit prisms 44b1 are about equal, that is, the unit prisms 44b1 are arranged at equal intervals. When the rays of light from the light guide plate 119 enter the prism portion 44b of the prism sheet 44 having such a configuration, the rays of light inside the unit prisms 44b1 of the prism portion 44b are totally reflected off the sloped surfaces of the unit prisms 44b1 and returned to the light guide plate 119 (retroreflected) if incident angles to the sloped surfaces of the unit prisms 44b1 are larger than the critical angle. If the incident angles are not larger than the critical angle, the rays of light are refracted by the sloped surfaces toward the front (in a direction normal to the plate surface of the base 44a) and exit.

Many rays of light traveling inside the light guide plate 119 or exiting from the light exit surface 119a travel from the LEDs toward the light guide plate 119 (toward the right along the Y-axis direction in FIG. 17). By efficiently directing such rays of light in the direction toward the front with the prism portion 44b, brightness of light directed from the optical sheet 120 toward the liquid crystal panel in the direction toward the front improves. The light collecting effects described above affect the rays of light entering the unit prisms 44b1 along the second direction (the arrangement direction of the LEDs and the light guide plate 119). The light collecting effects are less likely to be exerted on the rays of light entering the unit prisms 44b1 in the first direction perpendicular to the second direction. Namely, the second direction, which is the arrangement direction of the unit prisms 44b1, is a light collecting direction of the prism portion 44b in this embodiment. The light collecting effects are exerted on the rays of light in the light collecting direction. The first direction is a non-light collecting direction in which the light collecting effects are less likely to be exerted on the rays of light. As described above, the prism portion 44b has a periodic structure and characteristics to selectively collect the rays of light in the specific direction, that is, has the light collecting anisotropy. The exit angle distribution of the prism sheet 44 has the anisotropy such that the exit angle range of the exiting light is relatively large with respect the first direction that is the non-light collecting direction and relatively small with respect to the second direction that is the light collecting direction. The second light diffusing sheet 143 that has the exit angle distribution similar to the prism sheet 44 is disposed between the prism sheet 44 described above and the liquid crystal panel that is not illustrated. The anisotropic light diffusing portion 143b of the second light diffusing sheet 143 exerts the anisotropic light diffusing effects on the rays of light on which the anisotropic light collecting effects are exerted by the prism portion 44b of the prism sheet 44. As a result, the rays of light are directed to the liquid crystal panel with the exit angle range relatively large with respect to the first direction and relatively small with respect to the second direction. The incident angle range of the rays of light entering the display pixels in the liquid crystal panel (see FIGS. 3 and 4) is relatively large with respect to the first direction and relatively small with respect to the second direction. Therefore, the exit angle range of the rays of light transmitting through the display pixels in the liquid crystal panel and exiting from the display surface toward the front are more likely to become similar to each other with respect to the first direction and the second direction and thus the rays of light become more isotropic. According to the configuration, the viewing angle regarding the liquid crystal panel becomes isotropic. The viewing angles when the user sees images on the display surface of the liquid crystal display device in portrait position and when the user sees images on the display surface of the liquid crystal display device in landscape position are about equal. The high display quality is achieved for the images displayed on the display surface of the liquid crystal display.

As described earlier, the anisotropic optical member in this embodiment includes at least the prism sheet (an anisotropic light collecting member) 44. The prism sheet 44 is configured to collect the rays of light to exit. The light collecting effects are not exerted on the rays of exiting light with respect to the first direction and are exerted on the rays of exiting light with respect to the second direction. According to the configuration, the rays of light exiting from the prism sheet 44 having the light collecting anisotropy have the exit angle distributions such that the exit angle ranges of the rays of light are relatively large with respect to the first direction because the light collecting effects are not exerted and relatively small with respect to the second direction because the light collecting effects are exerted. The exit angle ranges in the liquid crystal panel are relatively small with respect to the first direction and relatively large with respect to the second direction. According to the configuration, the viewing angle regarding the images displayed on the display surface of the liquid crystal panel becomes isotropic.

### Third Embodiment

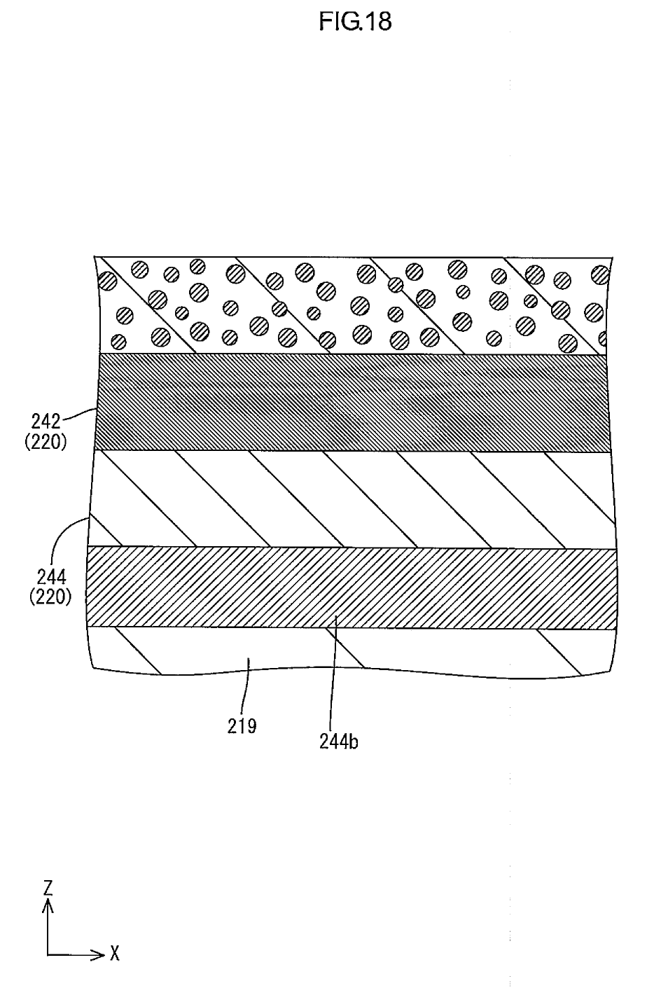

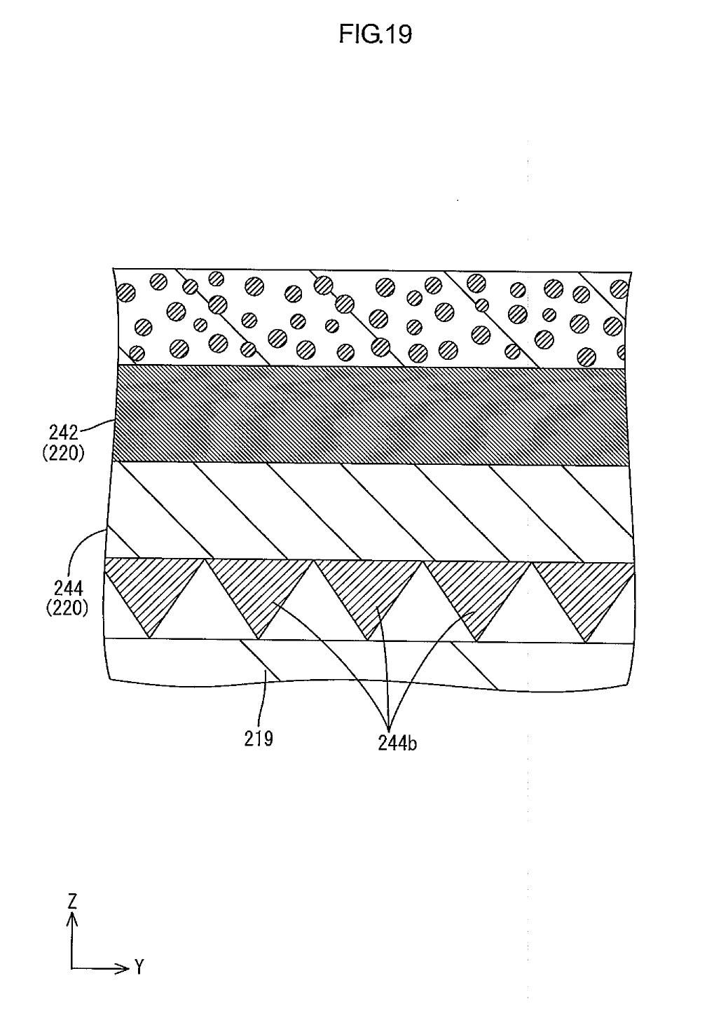

A third embodiment of this embodiment will be described with reference to FIGS. 18 and 19. The third embodiment includes a first light diffusing sheet 242 instead of the second light diffusing sheet in the second embodiment. The configurations, the functions, and the effects similar to those of the first and the second embodiments will not be described.

As illustrated in FIGS. 18 and 19, this embodiment includes an optical sheet 220 and a prism sheet 244. The optical sheet 220 includes a first light diffusing sheet (an isotropic light diffusing sheet) 242 having a configuration similar to the second embodiment. The prism sheet 244 has a configuration similar to that of the second embodiment. The prism sheet 244 is disposed between the first light diffusing sheet 242 and a light guide plate 219. The optical sheet 220 in this embodiment includes the first light diffusing sheet 242 and the prism sheet 244. The exit angle distribution of the first light diffusing sheet 242 is isotropic. The exit angle distribution of the prism sheet 244 is anisotropic. The optical sheet 220 has a configuration different from the second embodiment that includes the second light diffusing sheet 143 and the prism sheet 44 used in a combination (see FIGS. 16 and 17) and both having the anisotropic exit angle distributions. In the following description, the first light diffusing sheet 242 and the prism sheet 244 will not be described in detail.

According to the optical sheet 220 having such a configuration, the rays of light on which the anisotropic light collecting effects are exerted by the prism portion 244b of the prism sheet 244 are diffused by the first light diffusing sheet 242 in the isotropic manner. The exit angle distribution of the rays of light exiting from the first light diffusing sheet 242 has the anisotropy similar to the exit angle distribution regarding the prism sheet 244. Therefore, the incident angle range of the rays of light supplied to the display pixels in the liquid crystal panel (see FIGS. 3 and 4) when the light exiting from the first light diffusing sheet 242 is supplied are relatively large with respect to the first direction and relatively small with respect to the second direction. The exit angle ranges of the rays of light transmitting through the display pixels in the liquid crystal panel and exiting from the display surface toward the front are about equal with respect to the first direction and the second direction. Namely, the rays of light become substantially isotropic. Because the viewing angle regarding the liquid crystal panel becomes isotropic, the viewing angles when the user sees images on the display surface of the liquid crystal display device in portrait position and when the user sees images on the display surface of the liquid crystal display device in landscape position become equal. According to the configuration, the images are displayed on the display surface of the liquid crystal panel with high quality. In comparison to the second embodiment, the exit angle distribution of light supplied to the liquid crystal panel has lower anisotropy. This configuration is preferable for the liquid crystal panel that has relatively low exit angle distribution.

### Fourth Embodiment

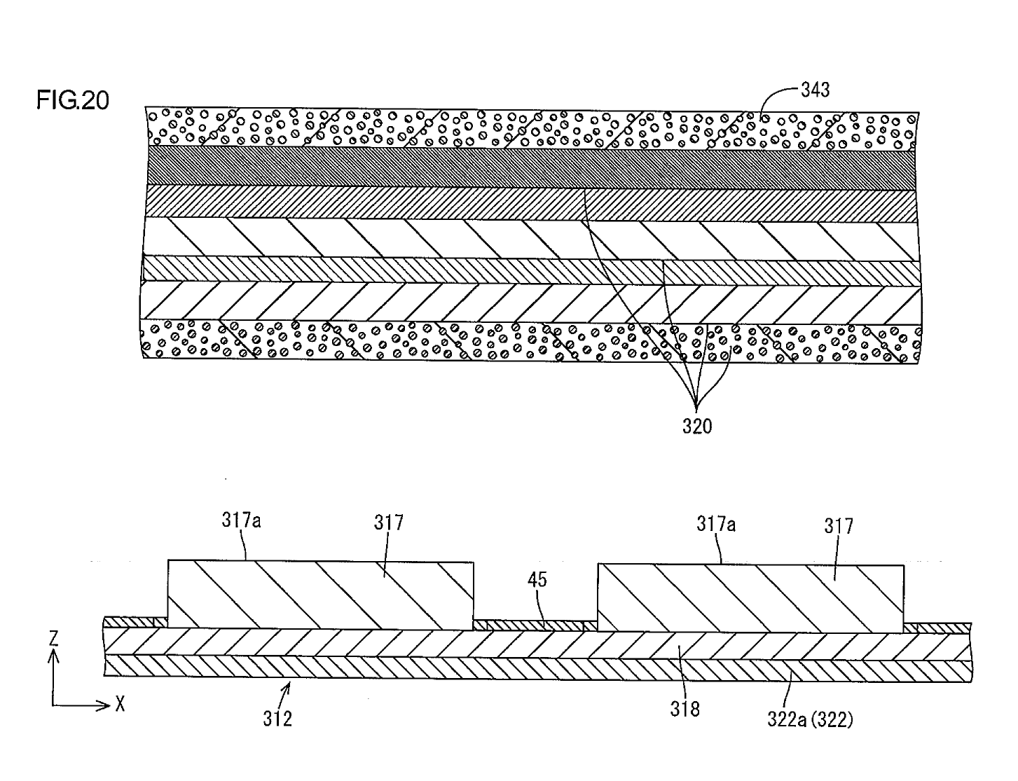

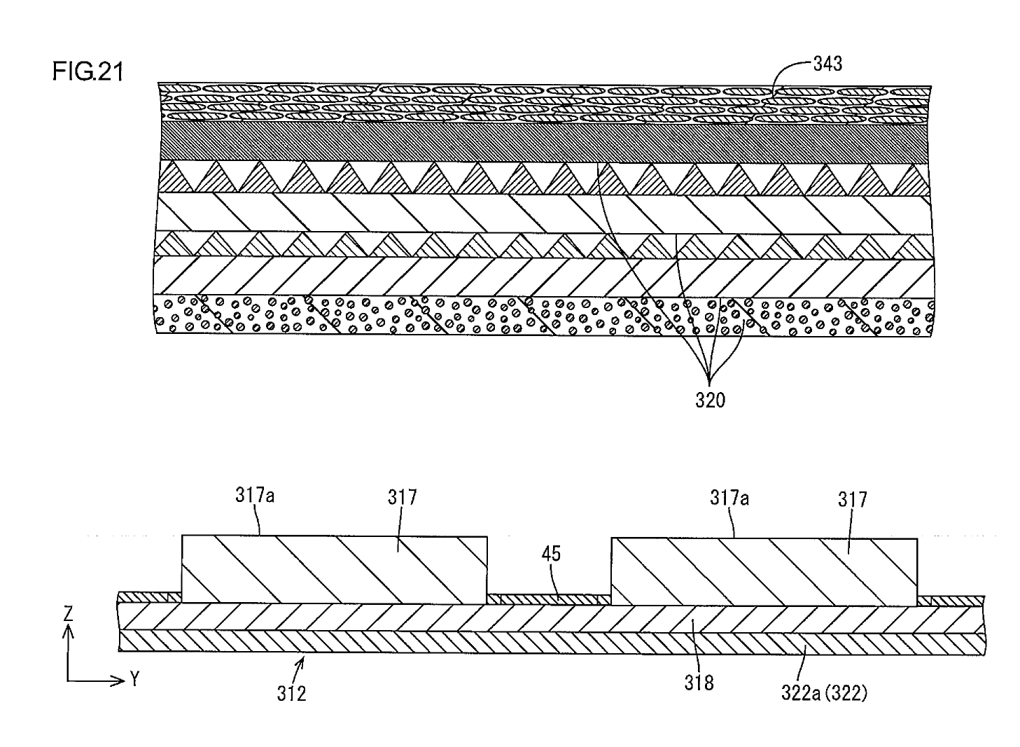

A fourth embodiment of the present invention will be described with reference to FIGS. 20 and 21. The fourth embodiment includes a backlight unit 312 that is a direct backlight. Structures, functions, and effects similar to those of the first embodiment will not be described.

As illustrated in FIGS. 20 and 21, the backlight unit 312 in this embodiment includes LEDs 317 that are light sources and disposed immediately behind an optical sheet 320. The LEDs 317 include light emitting surfaces 317a opposed to a plate surface of the optical sheet 320. Specifically, the backlight unit 312 includes a chassis 322, an LED board 318, the LEDS 317, a reflection sheet 45, and the optical sheet 320. The chassis 322 includes at least a bottom plate 322a that includes a plate surface parallel to the plate surface of the optical sheet 320. The LED board 318 is disposed on the plate surface of the bottom plate 322a of the chassis 322 on the front side. The LEDs 317 are mounted on the plate surface of the LED board 318 on the front side. The reflection sheet 45 is disposed on the plate surface of the LED board 318 on the front side. The optical sheet 320 has a configuration similar to the first embodiment. The LED board 318 has a plate-like shape that extends along the plate surface of the bottom plate 322a (the first direction and the second direction). The LEDs 317 are arranged in a matrix on the plate surface of the LED board 318 such that groups of the LEDs 317 are arranged at predefined intervals along the first direction and the second direction. Each of the LEDs 317 is a top-surface light emitting type. A surface opposite from a mounting surface mounted to the LED board 318 (on the front side) is the light emitting surface 317a.

Rays of light emitted by the LEDs 317 on the LED board 318 through the light emitting surfaces 317a are directed to the plate surface of the optical sheet 320 (including a second light diffusing sheet 343) opposite the light emitting surfaces 317a and supplied to the liquid crystal panel via the optical sheet 320. In comparison to the first embodiment that includes the light guide plate 19 (see FIGS. 10 and 11), higher light use efficiency is achieved. This configuration is preferable for improving brightness and reducing power consumption.

As described above, in this embodiment, the second light diffusing sheet 343 that is the anisotropic optical member is disposed over the surface of the liquid crystal panel opposite from the display surface and has the sheet-like shape having the plate surface along the display surface. Furthermore, the LEDs 317 that includes the light emitting surfaces 317a through which the rays of light are emitted are disposed such that the light emitting surfaces 317a opposite the plate surface of the second light diffusing sheet 343 that is the anisotropic optical member. According to the configuration, the rays of light emitted by the LEDs 317 through the light emitting surfaces 317a are directed to the plate surface of the second light diffusing sheet 343 that is the anisotropic optical member and opposite the light emitting surfaces 317a. The rays of light directed to the second light diffusing sheet 343 that is the anisotropic optical member are supplied from the second light diffusing sheet 343 to the liquid crystal panel. In comparison to a configuration in which a light guide plate is disposed between the LEDs 317 and the second light diffusing sheet 343 that is the anisotropic optical member, higher light use efficiency is achieved. This configuration is preferable for improving brightness and reducing power consumption.

### Fifth Embodiment

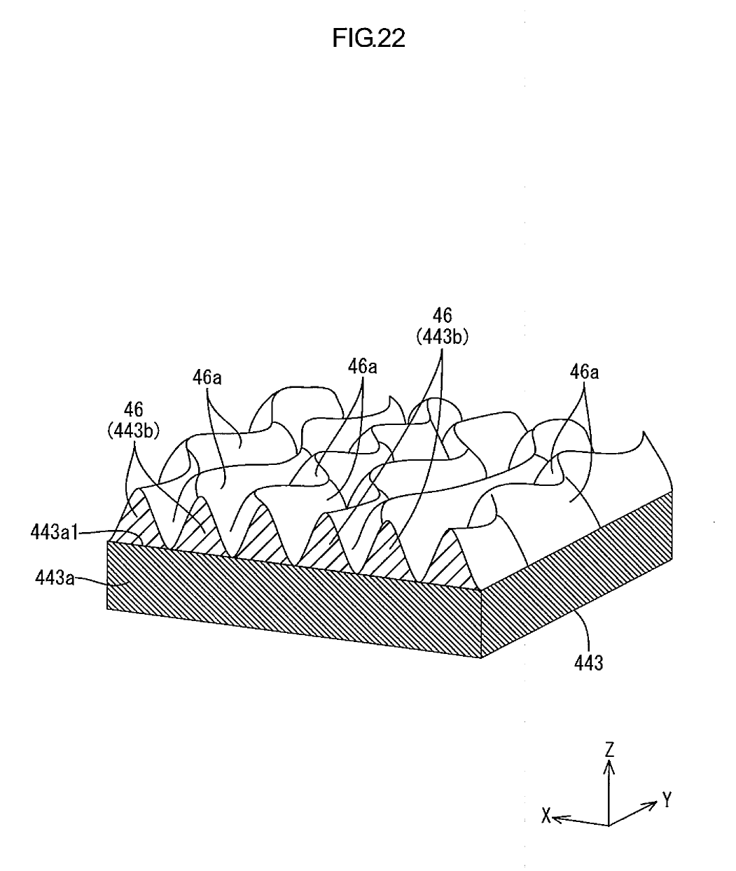

A fifth embodiment of the present invention will be described with reference to FIGS. 22 to 24. The fifth embodiment includes a second light diffusing sheet 443 having a configuration different from the first embodiment described earlier. Structures, functions, and effects similar to the first embodiment will not be described.

As illustrated in FIG. 22, the second light diffusing sheet 443 in this embodiment includes abase 443a and an anisotropic light diffusing portion 443b. The base 443a has a sheet-like shape and light transmissivity. The anisotropic light diffusing portion 443b includes protrusions 46 that protrude from a plate surface of the base 443a. The base 443a has a configuration similar to the first embodiment and thus will not be described in detail.

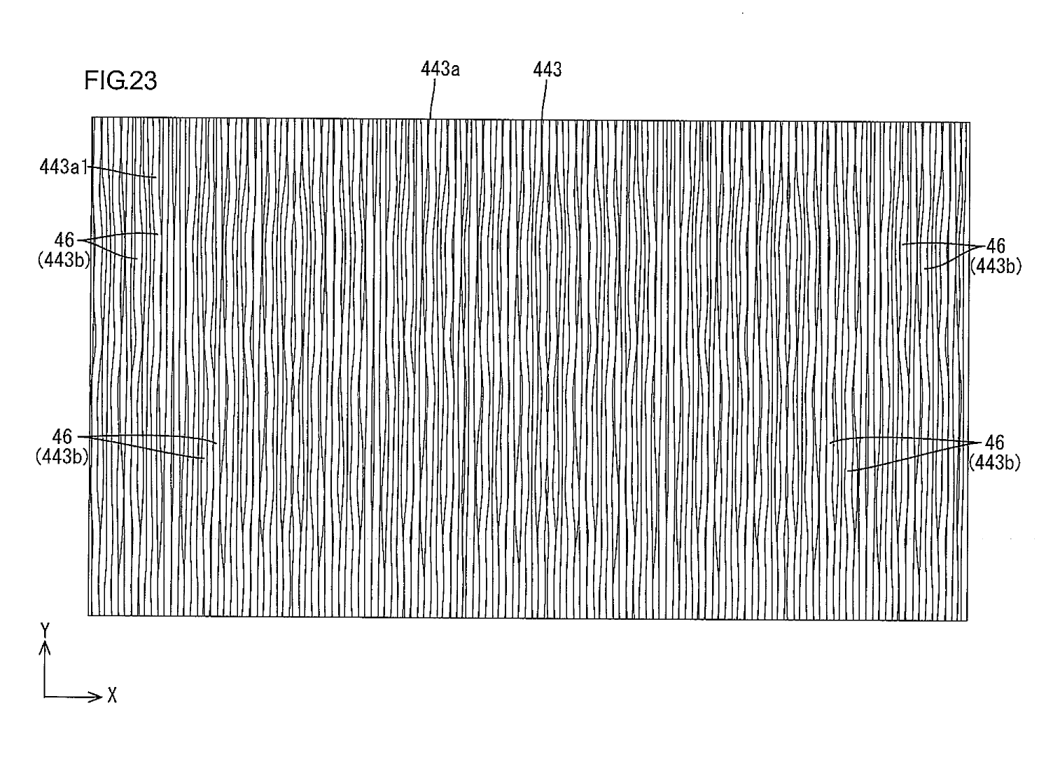

As illustrated in FIGS. 22 and 23, the anisotropic light diffusing portion 443b is integrally formed on light exit-side plate surface 443a1 of the base 443a on the front side, that is, on the liquid crystal panel side. The anisotropic light diffusing portion 443b is made of substantially transparent ultraviolet curing resin that is one kind of light curing resins. The ultraviolet curing resin may contain substantially transparent resin such as acrylic as main material and have characteristics that it is cured (or increased in viscous) with ultraviolet rays (UV light). A refractive index of the ultraviolet curing resin is larger than that of the air. In a production of the second light diffusing sheet 443, a forming die is filled with an ultraviolet curing resin before being cured and the base 443a is placed over an opening of the forming die. The ultraviolet curing resin before being cured is in contact with the light exit-side plate surface 443a1. Ultraviolet rays are applied to the ultraviolet curing resin via the base 443a and the ultraviolet curing resin is cured. As a result, the anisotropic light diffusing portion 443b is formed.

As illustrated in FIGS. 22 and 23, the anisotropic light diffusing portion 443b includes a number of the protrusions 46 that protrude from the light exit-side plate surface 443a1 of the base 443a in the Z-axis direction, that is, in a direction perpendicular to the plate surface of the base 443a toward the front (the liquid crystal panel side). As illustrated in FIGS. 22 to 24, each of the protrusions 46 has a triangular cross section along the Y-axis direction (the second direction). Each protrusion 46 meanders and extends in the X-axis direction (the first direction). A number of the protrusions 46 are arranged on the light exit-side plate surface 443a1 along the Y-axis direction. Each protrusion 46 has an isosceles triangular cross section and includes a pair of sloped surfaces 46a about a vertex. The protrusion 46 has a vertex angle that is an acute angle. The sloped surfaces 46a are angled with respect to the Y-axis direction and the Z-axis direction. The angle formed by the sloped surfaces 46a (the vertex angle) varies according to X-axis positions. Namely, the sloped surfaces 46a of the protrusion 46 are irregular curved surfaces that face the front at angles to the Y-axis direction and meander. More specifically, the protrusion 46 is formed in a serpentine shape, that is, a width of its base, a height (a position of the vertex with respect to the Z-axis direction), and a position of the vertex with respect to the Y-axis direction other than the angles of the sloped surfaces 46a randomly vary according to the X-axis positions. The protrusions 46 arranged along the Y-axis direction do not include portions that are parallel to the adjacent protrusions 46, that is, the protrusions randomly meander. FIG. 23 schematically illustrates arrangement of the protrusions 46 on the second light diffusing sheet 443.

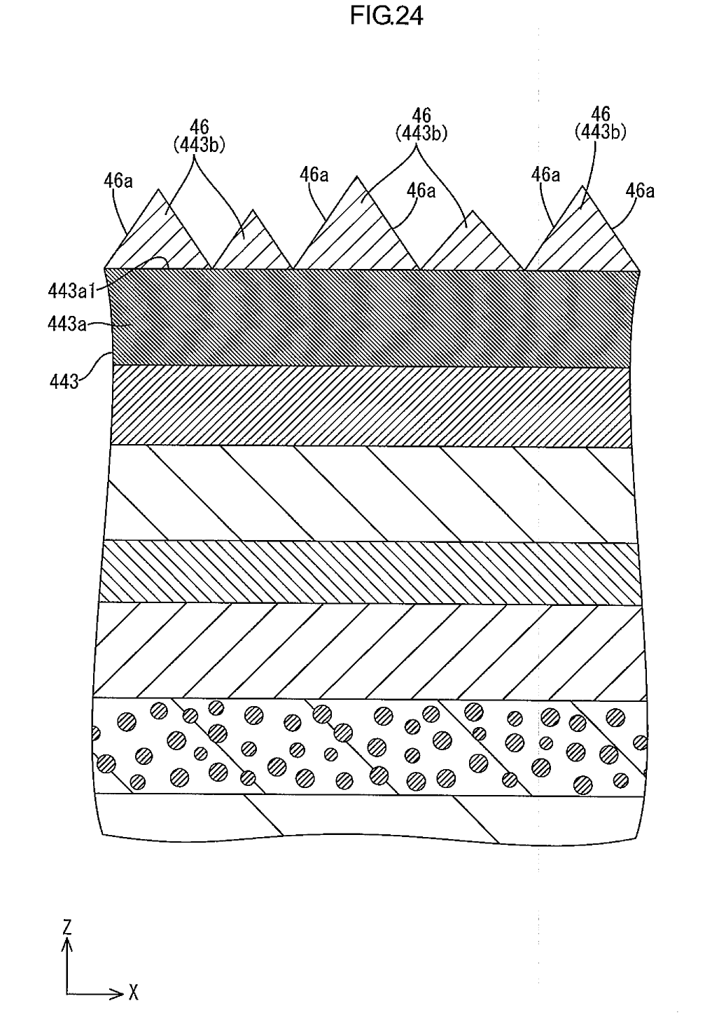

As illustrated in FIG. 24, after entering the protrusions 46 having such configurations, the rays of light from the base 443a are transmitted through the protrusions 46 and refracted off an interface between each sloped surface 46a and an external air layer. The rays of light are angled according to the curved shapes (the serpentine shapes) of the sloped surfaces and exit. A number of the rays of light exit from the sloped surface 46a substantially along the Y-axis direction (the second direction) but the directions in which the rays of light exit are slightly different according to the X-axis positions (positions in the first direction). Therefore, the rays of light exiting from the protrusions along the Y-axis direction are properly diffused. The smaller number of the rays of light exit from the sloped surface 46a along the X-axis direction in comparison to the number of rays of light exiting from the sloped surface 46a along the Y-axis direction. For the anisotropic light diffusing portion 443b in this embodiment, the Y-axis direction that corresponds to the arrangement direction of the protrusions 46 is a strong light diffusing direction in which stronger light diffusing effects are exerted on the rays of light. Furthermore, the X-axis direction that corresponds to the extending direction of each protrusion 46 is a weak light diffusing direction in which weaker light diffusing effects are exerted on the rays of light. The anisotropic light diffusing portion 443b has such light diffusing anisotropy. The exit angle distribution of the exiting light of the second light diffusing sheet 443 in this embodiment has the anisotropy similar to that of the second light diffusing sheet 43 in the first embodiment described earlier (see FIGS. 8 to 11). The strong light diffusing direction of the anisotropic light diffusing portion 443b corresponds with the first direction (the short-side direction of the display pixels) and the weak light diffusing direction thereof corresponds with the second direction (the long-side direction of the display pixels). The exit angle ranges are relatively small with respect to the first direction and relatively large with respect to the second direction. Because the incident angle range of the rays of light supplied to the display pixels in the liquid crystal panel are relatively large with respect to the first direction and relatively small with respect to the second direction, the rays of light on which the anisotropic light diffusing effects are exerted by the anisotropic light diffusing portion 443b are transmitted through the display pixels in the liquid crystal panel and exiting from the display surface toward the front after being supplied to the liquid crystal panel have the exit angle ranges substantially equal with respect to the first direction and the second direction. Namely, the rays of the exiting light are substantially isotropic. According to the configuration, the viewing angle regarding the liquid crystal panel is isotropic. The viewing angles when the user sees images on the display surface of the liquid crystal display device in portrait position and when the user sees images on the display surface of the liquid crystal display device in landscape position are about equal. According to the configuration, images are displayed on the display surface of the liquid crystal panel with high display quality.

The slope angles and orientations of the sloped surfaces 46a of the protrusions 46 in the anisotropic light diffusing portion 443b randomly vary according to the X-axis positions. Therefore, the rays of light exiting from the sloped surfaces 46a are randomly diffused and directivity of the exiting light is more properly compensated. Furthermore, the protrusions 46 in the anisotropic light diffusing portion 443b randomly meander. Therefore, the rays of light exiting from the protrusions 46 are randomly diffused according to the serpentine shapes of the protrusions 46. According to the configuration, the directivity of the exiting light is further properly compensated. As described above, according to the X-axis positions of the protrusions 46 in the anisotropic light diffusing portion 443b, the slope angles of the sloped surfaces 46a, the widths of the bases, and the heights randomly vary. Furthermore, the serpentine shapes of the adjacent protrusions 46 are random. Therefore, interference is less likely to occur between the arrangement of the display pixels in the liquid crystal panel and the arrangement of the protrusions 46 and thus moire fringes that are interference patterns are less likely to occur on the liquid crystal panel.

As described above, in this embodiment, the second light diffusing sheet 443 includes the base 443a and the protrusions 46. The base 443a has the light transmissivity and the sheet-like shape. Each of the protrusions 46 protrudes from the plate surface of the base 443a and has the triangular cross section along the first direction. The protrusions 46 meander and extend in the second direction. The protrusions 46 are arranged along the first direction. Because each protrusion 46 that protrudes from the plate surface of the base 443a having the sheet-like shape has the triangular cross section along the first direction, the rays of light angled according to the vertexes exit from the sloped surfaces substantially along the first direction. According to the configuration, the amount of light exiting from the protrusions 46 along the first direction is larger than the amount of light exiting from the protrusions 46 along the second direction. Because the protrusions 46 meander and extend in the second direction, that is, the sloped surfaces are meandering, the directions in which the rays of light exit vary according to the positions on the sloped surfaces in the second direction. According to the configuration, the rays of light exiting from the protrusions 46 along the first direction are properly diffused. The second light diffusing sheet 44 has the diffusing anisotropy such that the amounts of diffused light are relatively large with respect to the first direction and relatively small with respect to the second direction. According to the configuration, the viewing angle regarding images displayed on the display surface of the liquid crystal panel becomes isotropic.

The protrusions 46 arranged along the first direction meander along the second direction. According to the configuration, the rays of light exiting from the sloped surfaces of the protrusions 46 are randomly diffused according to the serpentine shapes of the protrusions 46. The moire fringes (interference patterns) are less likely to occur in images displayed on the display surface of the liquid crystal panel.

The protrusions 46 are formed such that at least one of the width and the height randomly varies according to the positions in the second direction. According to the configuration, the angles of the vertexes and the orientations of the sloped surfaces of the protrusions 46 randomly vary. Therefore, the rays light exiting from the sloped surfaces are randomly diffused. According to the configuration, moire fringes (interference patterns) are less likely to occur in images displayed on the display surface of the liquid crystal panel.

### Sixth Embodiment

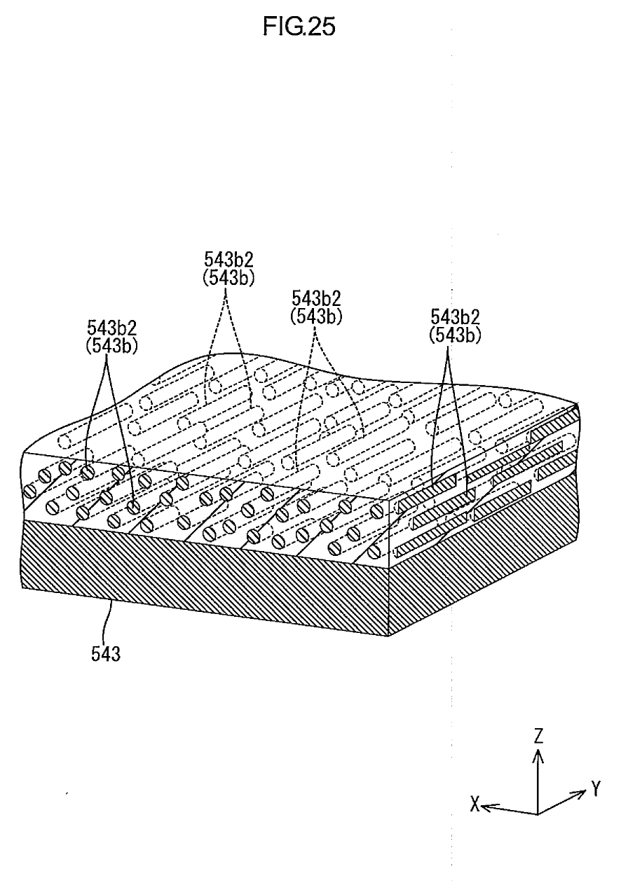

A sixth embodiment of the present invention will be described with reference to FIG. 25. The sixth embodiment includes a second light diffusing sheet 543. The light diffusing sheet 543 includes anisotropic light diffusing particles 543b2 each having a shape different from the first embodiment. Structures, functions, and effects similar to those of the first embodiment will not be described.

As illustrated in FIG. 25, the second light diffusing sheet 543 in this embodiment includes the anisotropic light diffusing particles 543b2 each having a round column-like shape. Each of the anisotropic light diffusing particles 543b2 has a rectangular cross section along a long-axis direction (the Y-axis direction, the second direction) and a true circular cross section along a short-axis direction (the X-axis direction, the first direction). A diameter (a dimension along the short-axis direction) of each anisotropic light diffusing particle 543b2 is substantially constant for an entire length in the long-axis direction. Although each of the anisotropic light diffusing particles 543b2 has such a shape, the anisotropic light diffusing particles 543b2 can be oriented with the long-axis direction thereof along the second direction and the short axes thereof along the first direction so that the strong light diffusing direction of the anisotropic light diffusing portion 543b corresponds with the first direction (the short-side direction of the display pixels) and the weak light diffusing direction thereof corresponds with the second direction (the long-side direction of the display pixels). The exit angle ranges of the transmitting light in the liquid crystal panel are relatively small with respect to the first direction and relatively large with respect to the second direction. According to the configuration, the rays of light transmitting through the display pixels in the liquid crystal panel and exiting from the display surface toward the front become isotropic and the display quality improves.

### Seventh Embodiment

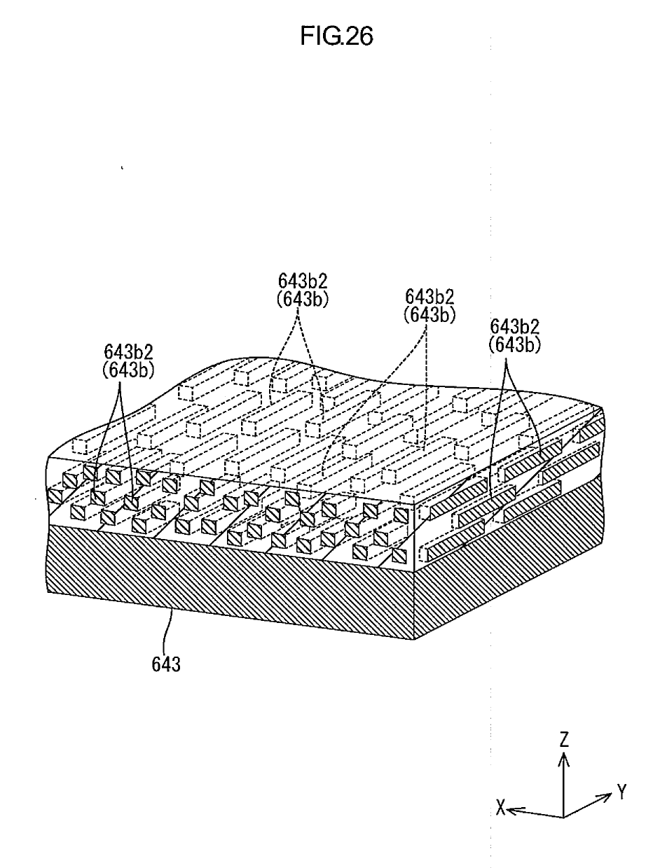

A seventh embodiment of the present invention will be described with reference to FIG. 26. The seventh embodiment includes a second light diffusing sheet 643. The second light diffusing sheet 643 includes anisotropic light diffusing particles 643b2 each having a shape different from the first embodiment. Structures, functions, and effects similar to the first embodiment will not be described.

As illustrated in FIG. 26, the second light diffusing sheet 643 in this embodiment includes anisotropic light diffusing particles 643b2 each having a rectangular column-like shape. Each anisotropic light diffusing particle 643b2 has a rectangular cross section along a long-axis direction (the Y-axis direction, the second direction) and a square cross section along a short-axis direction (the X-axis direction, the first direction). Dimensions of sides (dimensions along the short-axis direction) are substantially constant for an entire length in the long-axis direction. Although each anisotropic light diffusing particle 643b2 has such a shape, the anisotropic light diffusing particles 643b2 can be oriented such that the long-axis direction thereof along the second direction and the short axes thereof along the first direction so that the strong light diffusing direction of the anisotropic light diffusing portion 643b corresponds with the first direction (the short-side direction of the display pixels) and the weak light diffusing direction thereof corresponds with the second direction (the long-side direction of the display pixels). The transmitting light in the liquid crystal panel are relatively small with respect to the first direction and relatively large with respect to the second direction. According to the configuration, the rays of light transmitting through the display pixels in the liquid crystal panel and exiting from the display surface toward the front become isotropic and the display quality improves.

### Eighth Embodiment

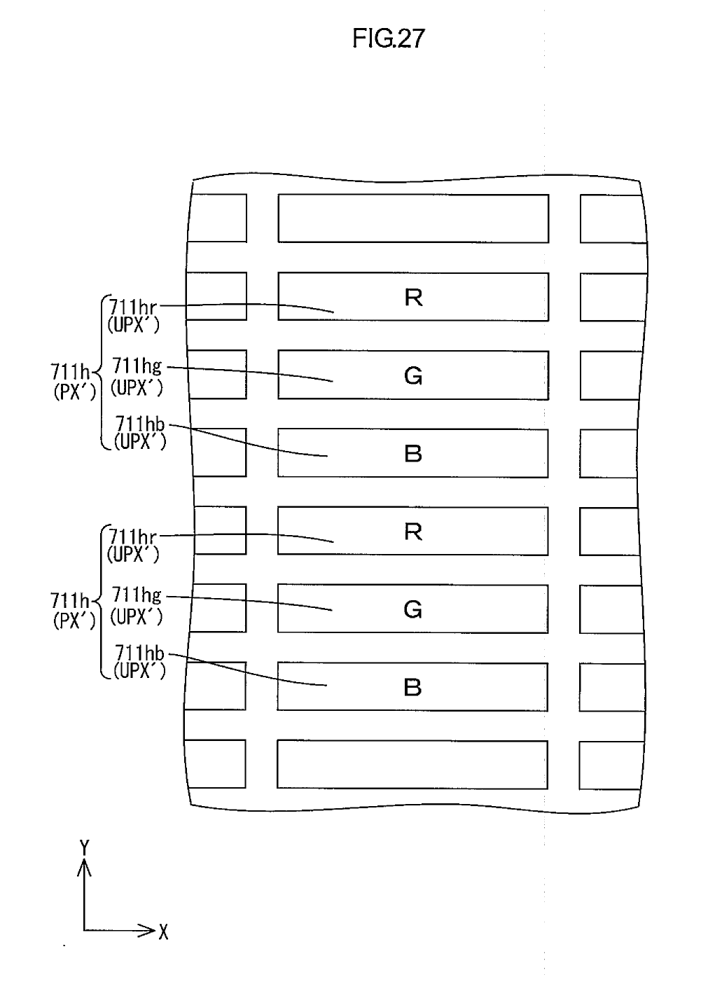

An eighth embodiment of the present invention will be described with reference to FIG. 27. The eighth embodiment includes display pixels PX′ in a liquid crystal panel. Each of the display pixels PX′ has a plan-view shape different from the first embodiment. The display pixels PX′ are arranged differently from the first embodiment. Structures, functions, and effects similar to the first embodiment will not be described.

As illustrated in FIG. 27, the liquid crystal panel includes unit pixels UPX′ in three colors each having a horizontally-long rectangular shape in a plan view and oriented with long axis thereof corresponding with the X-axis direction and short axis thereof corresponding with the Y-axis direction. The liquid crystal panel includes display pixels PX′ each including the unit pixels UPX′ in three colors. Each of the display pixels PX′ has a horizontally-long rectangular shape in a plan view and oriented with long axis thereof corresponding with the X-axis direction and short axis thereof corresponding with the Y-axis direction. The unit pixels UPX′ in three colors are repeatedly arranged along the Y-axis direction and form unit pixel groups. A number of the unit pixel groups are arranged along the X-axis direction and thus a number of the display pixels PX′ are arranged in a matrix along the X-axis direction and the Y-axis direction. According to the configuration, the liquid crystal panel has anisotropy in an exit angle distribution of transmitting light such that an exit angle range of the transmitting light is relatively large with respect to the X-axis direction along the long-side direction of the display pixels PX′ and relatively small with respect to the Y-axis direction along the short-side direction of the display pixels PX′. The Y-axis direction corresponds to “the first direction” and the X-axis direction corresponds to “the second direction.” In FIG. 27, only arrangement of color portions 711hr, 711hg, and 711hb included in color filters 711h on a CF board is illustrated. Plan-view shapes and arrangement of pixels electrodes on an array board are similar to the color filters 711h.

To combine the liquid crystal panel in this embodiment described above with any one of the first to the seventh embodiments, the following configuration may be employed. To combine the liquid crystal panel with any one of the first, the second, the fourth, the sixth, and the seventh embodiments, the anisotropic light diffusing particles in the second light diffusing sheet may be oriented such that the long axes thereof correspond with the Y-axis direction and the short axes thereof correspond with the X-axis direction. To combine the liquid crystal panel with any one of the second and the third embodiments, the unit prisms in the prism sheet may be oriented such that the extending direction thereof corresponds with the arrangement direction thereof corresponds with the X-axis direction. To combine the liquid crystal panel with the fifth embodiment, the protrusions of the second light diffusing sheet may be oriented such that the extending direction thereof corresponds with the Y-axis direction and the arrangement direction thereof corresponds with the X-axis direction.

### Other Embodiments

The technology is not limited to the embodiments described in the above description and the drawings. For example, the following embodiments may be included in technical scopes of the present invention.

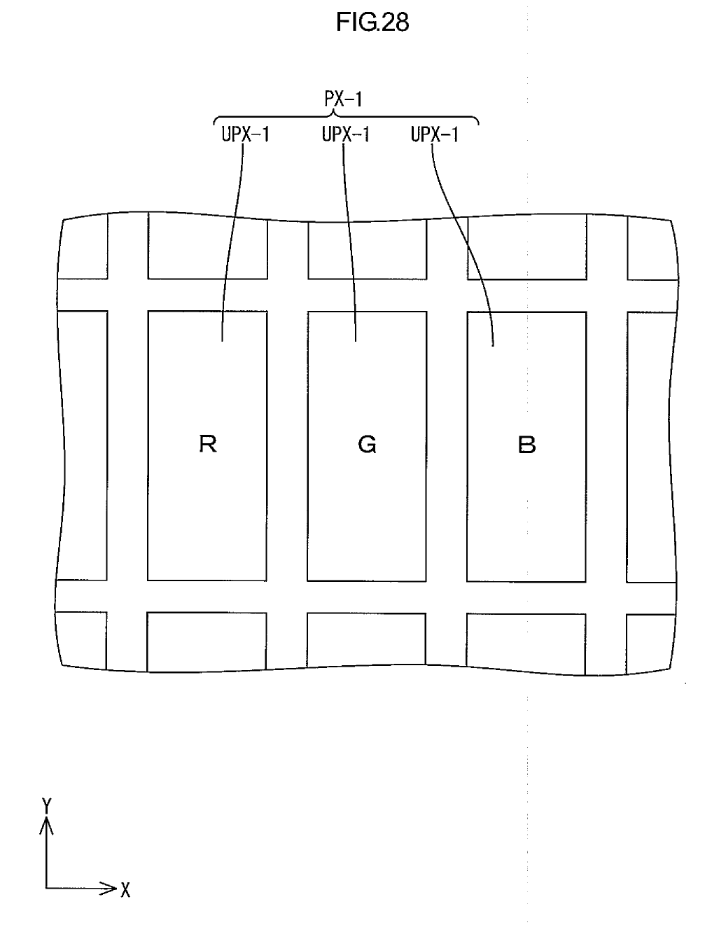

(1) A modification of the first and the eight embodiments illustrated in FIG. 28 includes unit pixels UPX-1 in three colors each having a vertically-long rectangular shape in a plan view. A long-side direction of each unit pixel UPX-1 corresponds with the Y-axis direction and a short-side direction thereof corresponds with the X-axis direction. The modification includes display pixels PX-1 including the unit pixels UPX-1 in three colors. The display pixels PX-1 each having a horizontally-long rectangular shape in a plan view. A long-side direction of each display pixel PX-1 corresponds with the X-axis direction and a short-side direction thereof corresponds with the Y-axis direction. The present invention can be applied to the liquid crystal panel having such a configuration. In this case, exit angle distributions of transmitting light are similar to the first embodiment described earlier.

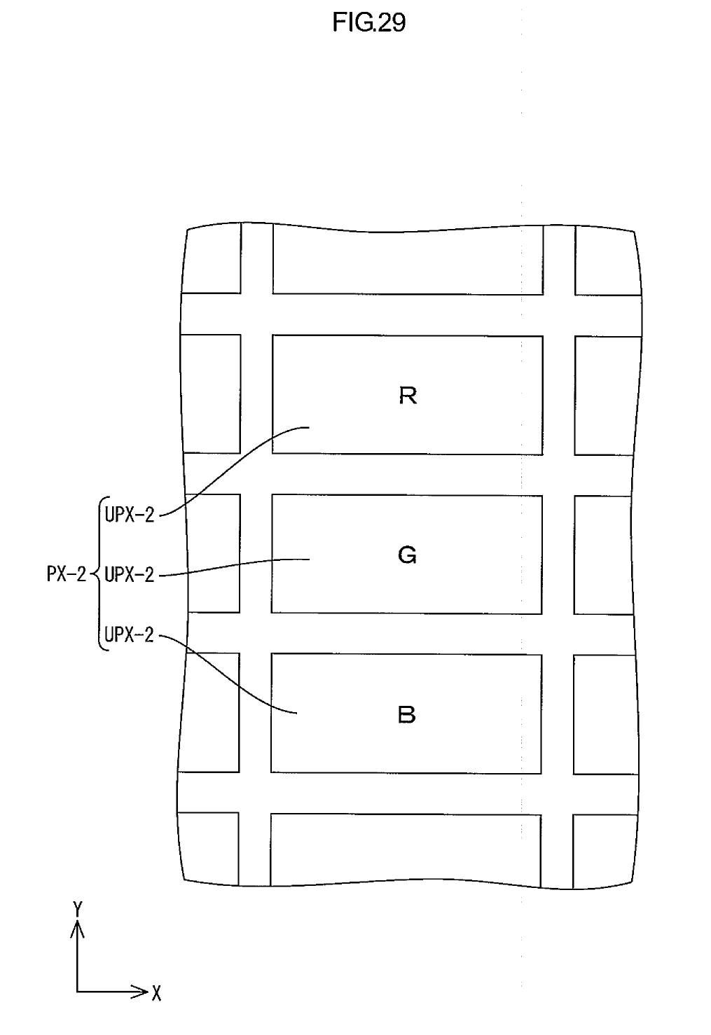

(2) A modification of the first and the eighth embodiments illustrated in FIG. 29 includes unit pixels UPX-2 in three colors each having a horizontally-long rectangular shape in a plan view. A long-side direction of each unit pixel UPX-2 corresponds with the X-axis direction and a short-side direction thereof corresponds with the Y-axis direction. The modification includes display pixels PX-2 including the unit pixels UPX-2 in three colors. Each of the display pixels PX-2 has a vertically-long rectangular shape in a plan view. A long-side direction of each display pixel PX-2 corresponds with the Y-axis direction and a short-side direction thereof corresponds with the X-axis direction. The present invention can be applied to the liquid crystal panel having such a configuration. In this case, exit angle distributions of transmitting light are similar to the eighth embodiment described earlier.

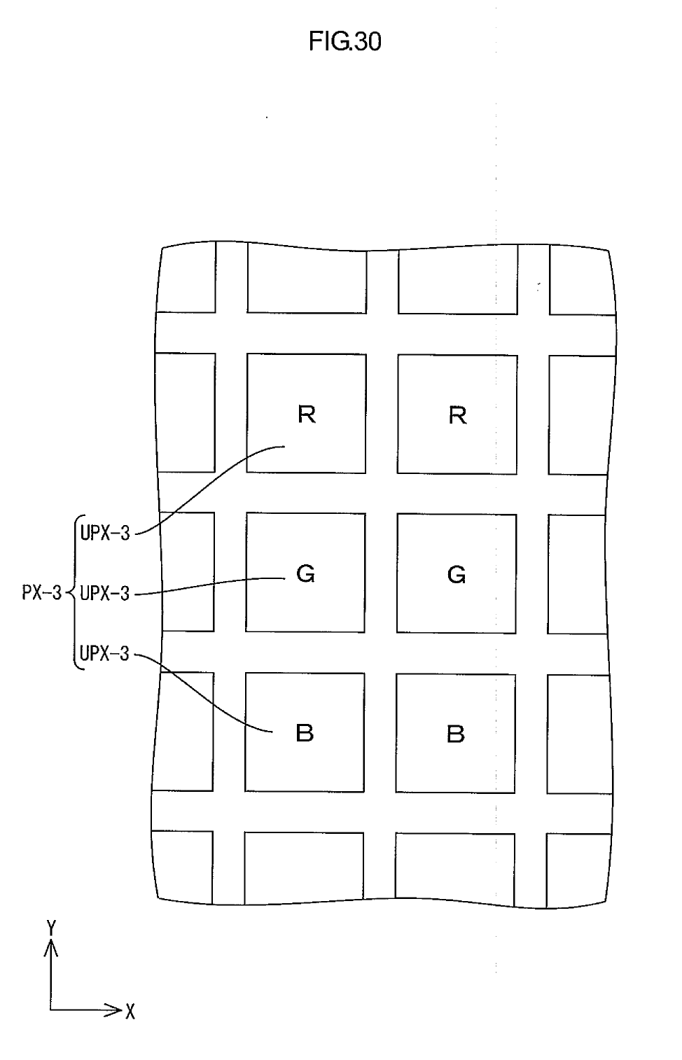

(3) A modification of the first and the eighth embodiments illustrated in FIG. 30 includes unit pixels UPX-3 in three colors each having a square shape in a plan view. The modification includes display pixels PX-3 including the unit pixels UPX-3 in three colors. Each of the display pixels PX-3 has a vertically-long rectangular shape in a plan view. A long-side direction of each display pixel PX-3 corresponds with the Y-axis direction and a short-side direction thereof corresponds with the X-axis direction. The present invention can be applied to the liquid crystal panel having such a configuration. In this case, exit angle distributions of transmitting light are similar to the first embodiment described earlier.

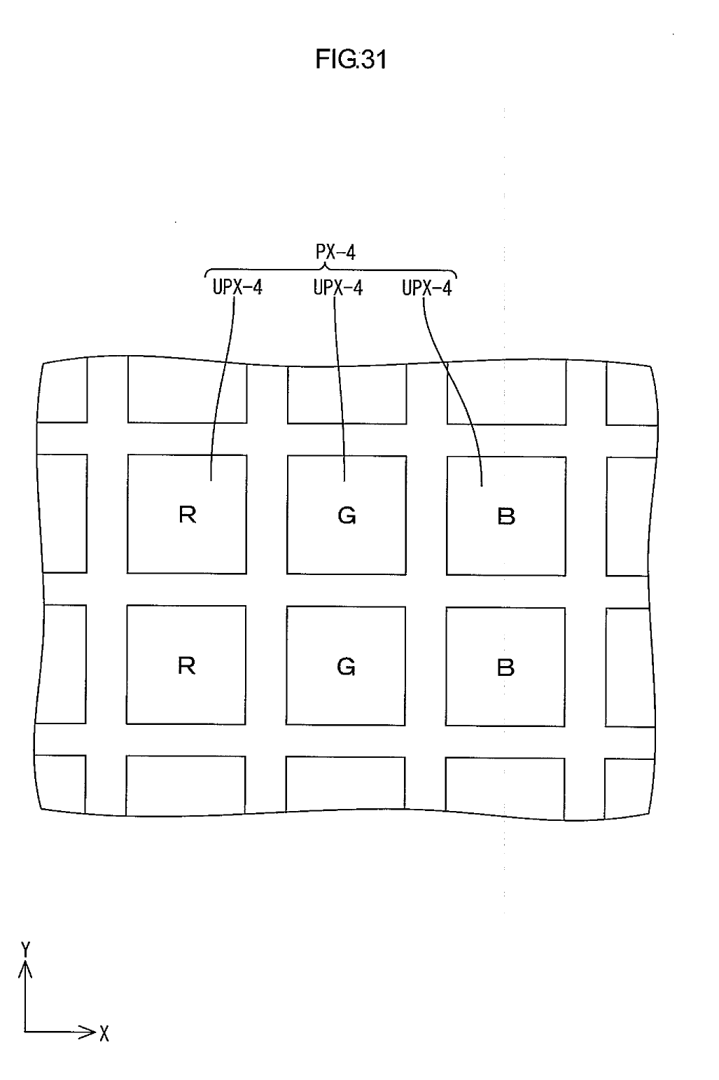

(4) A modification of the first and the eighth embodiments illustrated in FIG. 31 includes unit pixels UPX-4 in three colors each having a square shape in a plan view. The modification includes display pixels PX-4 including the unit pixels UPX-4 in three colors. Each of the display pixels PX-4 has a horizontally-long rectangular shape in a plan view. A long-side direction of each display pixel PX-4 corresponds with the X-axis direction and a short-side direction thereof corresponds with the Y-axis direction. The present invention can be applied to the liquid crystal panel having such a configuration. In this case, exit angle distributions of transmitting light are similar to the eighth embodiment described earlier.

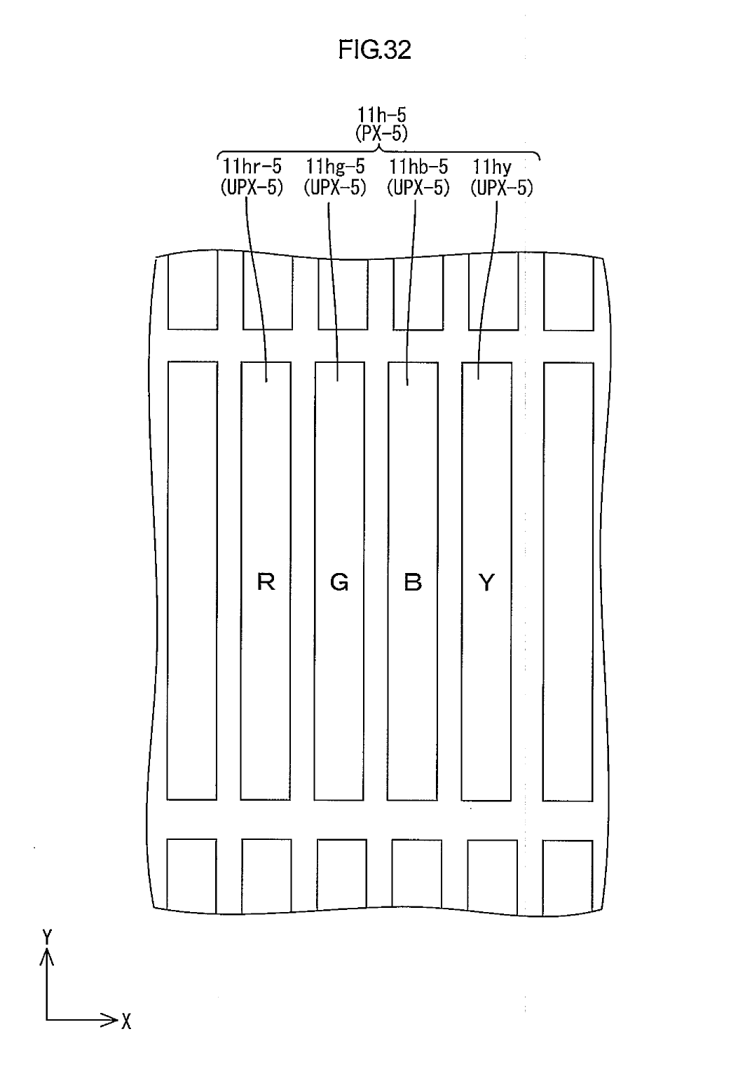

(5) A modification of the first embodiment illustrated in FIG. 32 includes color filters 11h-5 each including color portions 11hr-5, 11hg-5, 11hb-5, and 11hy in four colors that include Y (yellow) in addition to three colors of R, G, and B.

The modification may include unit pixels UPX-5 including the color portions 11hr-5, 11hg-5, 11hb-5, and 11hy, respectively. Four colors of unit pixels UPX-5 may form a display pixel PX-5. FIG. 32 illustrates a liquid crystal panel having a configuration in which each of the unit pixels UPX-5 in four colors has a vertically-long rectangular shape in a plan view with a long-side direction thereof corresponding with the Y-axis direction and a short-side direction thereof corresponding with the X-axis direction. Furthermore, each of display pixels PX-5 including four colors of the unit pixels UPX-5 and having a vertically-long rectangular shape in a plan view. A long-side direction of each display pixel PX-5 corresponds with the Y-axis direction and a short-side direction thereof corresponds with the X-axis direction. The present invention can be applied to the liquid crystal panel having such a configuration. In this case, exit angle distributions of transmitting light are similar to the first embodiment described earlier.

(6) A modification of other embodiment (5) may include unit pixels in four colors each having a horizontally-long rectangular plan-view shape and display pixels each having a horizontally-long rectangular plan-view shape similar to the eighth embodiment. Alternatively, the modification may include unit pixels in four colors each having a vertically-long plan-view shape and display pixels each having a horizontally-long rectangular plan-view shape similar to other embodiment (1). Alternatively, the modification may include unit pixels in four colors each having a horizontally-long plan-view shape and display pixels each having a vertically-long rectangular plan-view shape similar to other embodiment (2). Alternatively, the modification may include unit pixels in four colors each having a square plan-view shape and display pixels each having a vertically-long rectangular plan-view shape similar to other embodiment (3). Alternatively, the modification may include unit pixels in four colors each having a square plan-view shape and display pixels each having a horizontally-long rectangular plan-view shape similar to other embodiment (4). The sequence of the unit pixels in four colors can be altered as appropriate.

(7) In other embodiment (5), the color filters include color portions in four colors including Y (yellow) in addition to three colors of R, G, and B. Color portions in colors other than Y, for example, C (cyan) may be added. The color filters may include color portions in five or more colors.

(8) In each of the above embodiments, area ratios of unit pixels included in the display pixels are about equal. The present invention may be applied to a liquid crystal panel including display pixels that may include unit pixels having different area ratios.

(9) In each of the above embodiments, each display pixel has the rectangular plan-view shape. However, each display pixel may have an oval plan-view shape.

(10) In each of the first, the fourth, and the fifth embodiments, the second light diffusing sheet is the optical sheet that is disposed the closest to the liquid crystal panel. However, the position of the second light diffusing sheet (or a sequence of the layers) may be altered as appropriate.

(11) In each of the above embodiments, the optical sheets include two prism sheets and two light diffusing sheets. However, the optical sheets may include a single prism sheet or three prism sheet and three light diffusing sheets or a single light diffusing sheet. Alternatively, the optical sheets may include five or more sheets or three or less sheets. Furthermore, a reflection-type polarizing sheet may be added to or used instead of the prism sheets that are light collecting members and the light diffusing sheets that are light diffusing members. Still furthermore, the first light diffusing sheet that is an isotropic light diffusing sheet may be omitted.

(12) In each of the second and the third embodiments, the prism sheet includes the prism portion is formed on the plate surface of the base on the light guide plate side (the light entrance-side plate surface). However, a prism sheet that includes a prism portion formed on a plate surface of a base on a liquid crystal panel side (a light exit side plate surface) may be used as an “anisotropic light collecting member.”

(13) In each of the second and the third embodiments, the optical sheets include two sheets that include the prism sheet and the second light diffusing sheet or the first light diffusing sheet. However, the optical sheets may include three or more sheets that include other prism sheet or other light diffusing sheet. Alternatively, the second light diffusing sheet or the first light diffusing sheet may be omitted and only a single prism sheet may be used as an optical sheet. Furthermore, a light reflection-type polarizing sheet may be added to or used instead of the prism sheet that is the light collecting member or the light diffusing sheet that is the light diffusing member.

(14) In the second embodiment, the optical sheets include the second light diffusing sheet disposed close to the liquid crystal panel and the prism sheet disposed close to the light guide plate. However, the second light diffusing sheet and the prism sheet may be layered at opposite positions.

(15) In the third embodiment, the optical sheets include the first light diffusing sheet disposed close to the liquid crystal panel and the prism sheet disposed close to the light guide plate. However, the first light diffusing sheet and the prism sheet may be layered at opposite positions.

(16) In each of the above embodiments, the second light diffusing sheet and the prism sheet that are the anisotropic optical members may be disposed over the display surface of the liquid crystal panel.

(17) In each of the above embodiments (except for the third and the fifth embodiments), the anisotropic light diffusing particles are randomly arranged in the light transmissive resin layer of the second light diffusing sheet. However, the anisotropic light diffusing particles may be arranged with a uniform pattern in the light transmissive resin layer.

(18) The shapes and the sizes (the dimensions in the long-axis direction and in the short-axis direction) of the anisotropic light diffusing particles in the second light diffusing sheet may be altered as appropriate from the above embodiments (except for the third and the fifth embodiment). For example, anisotropic light diffusing particles each having an oval column-like shape or having a triangular or a polygonal cross section including a larger number of corners than a pentagon along the short-axis direction may be used. Each of the anisotropic light diffusing particles may have cone-like portions at ends of the long dimension of the round column-like portion thereof such that the ends narrow toward tips. Alternatively, each of the anisotropic light diffusing particles may have pyramid-like portions (triangular pyramid-like portions or rectangular pyramid-like portions) at ends of the long dimension of the column-like portion (the triangular column-like portion or the rectangular column-like portion) such that the ends narrow toward tips. Each of the anisotropic light diffusing particles may have a shape formed from two cone-like portions with bottoms thereof bonded together such that ends narrow toward tips. Each of the anisotropic light diffusing particles may have a shape formed from two pyramid-like portions (triangular pyramid-like portions or rectangular pyramid-like portions) with bottoms thereof bonded together such that ends narrow toward tips.

The materials or the refractive indexes of the materials used for the anisotropic light diffusing particles and the light transmissive resin layer of the second light diffusing sheet may be altered as appropriate from each of the above embodiments (except for the third and the fifth embodiments). For example, a visible light curing resin that is cured with visible rays other than the ultraviolet curing resin may be used for the light transmissive resin layer. A relationship between the refractive index of the anisotropic light diffusing particles and the refractive index of the light transmissive resin layer may be defined without restriction. The refractive index of the anisotropic light diffusing particles may be defined larger than the refractive index of the light transmissive resin layer or smaller than the refractive index of the light transmissive resin layer. Alternatively, the refractive index of the anisotropic light diffusing particles and the refractive index of the light transmissive resin layer may be defined equal to each other. The material used for the anisotropic light diffusing particles may be different from the material used for the light transmissive resin layer or the same material may be used.

(20) The weight percentage of the anisotropic light diffusing particles in the light transmissive resin layer of the second light diffusing sheet may be altered as appropriate from each of the above embodiments (except for the third and the fifth embodiments).

(21) In each of the above embodiments (except for the third and the fifth embodiment), the thickness of the anisotropic light diffusing portion is smaller than the thickness of the base of the second light diffusing sheet. However, the thicknesses may be defined the other way around, that is, the thickness of the anisotropic light diffusing portion may be defined larger than the thickness of the base.

(22) In each of the above embodiments, the bases of the second light diffusing sheet and the prism sheet are prepared by biaxially stretching. However, the bases may be prepared by other methods, for example, by extrusion or by injection molding.

(23) The fifth embodiment includes the second light diffusing sheet that includes the protrusions arranged along the light collecting direction and randomly meandering in the non-light collecting direction. However, the protrusions may be arranged along the light collecting direction parallel to each other and meandering at a uniform pattern.

(24) The fifth embodiment includes the second light diffusing sheet that includes the protrusions extending along he non-light collecting direction and meandering. The widths and the heights of the protrusions randomly vary according to the positions in the non-light collecting direction. However, the protrusions may be formed in serpentine forms with constant widths and heights.

(25) In the fifth embodiment, the anisotropic light diffusing portion of the second light diffusing sheet includes the protrusions. However, the anisotropic light diffusing portion may include a number of micro lenses arranged in a matrix along the first direction and the second direction on the plate surface of the base.

(26) In the fifth embodiment, the ultraviolet curing resin that is one kind of light curing resins and cured with ultraviolet rays is used for the protrusions (the anisotropic light diffusing portion) of the second light diffusing sheet. However, other kind of the light curing resin may be used. For example, a visible light curing resin that is cured with visible rays may be used. Alternatively, a light curing resin that is cured with both ultraviolet rays and visible rays may be used.

(27) In the fifth embodiment, the anisotropic light diffusing portion of the second light diffusing sheet includes a number of the protrusions and thus the rays of light are diffused in random directions. However, the anisotropic light diffusing portion may include lenticular lenses that extend along the first direction and each having a semicircular cross section along the light collecting direction. A number of the lenticular lenses are regularly arranged along the second direction.

(28) In each of the above embodiments (except for the fourth embodiment), a single LED board is disposed along the light entrance surface of the light guide plate. However, two or more LED boards may be disposed along the light entrance surface of the light guide plate.

(29) In each of the above embodiments (except for the fourth embodiment), the LED board is disposed opposite one of the long peripheral surfaces of the light guide plate. However, a configuration in which an LED board is disposed opposite one of the short peripheral surfaces of the light guide plate may be included in the scope of the present invention.

(30) Other than the above (29), a configuration in which LED boards are disposed opposite both long peripheral surfaces or LED boards are disposed opposite the short peripheral surfaces may be included in the scope of the present invention.

(31) Other than the above (29) and (30), a configuration in which LED boards are disposed opposite any three of the peripheral surfaces of the light guide plate or all of the four peripheral surfaces of the light guide plate may be included in the scope of the present invention.

(32) In each of the above embodiments, the touchscreen pattern using the projected capacitive touchscreen technology is used. Other than that, the present invention may be applied to configurations that include a touchscreen pattern using the surface capacitive touchscreen technology, a touchscreen pattern using the resistive touchscreen technology, and a touchscreen pattern using the electromagnetic induction touchscreen technology, respectively.

(33) Instead of the touchscreen in each of the above embodiments, parallax barrier panel (a switching liquid crystal panel) including parallax barrier patterns may be used. The parallax barrier patterns are for separating images displayed on the liquid crystal panel with a parallax so that a user sees stereoscopic images (3D images, three-dimensional images). The parallax barrier panel may be used in combination with the touchscreen panel.

(34) Touchscreen patterns may be formed on the parallax barrier panel in the above (33) to add touchscreen functions to the parallax barrier panel.

(35) Other than each of the above embodiments, the screen size of the liquid crystal panel may be altered as appropriate.

(36) In each of the above embodiments, the LEDs are used as light sources in the backlight unit. However, other types of light sources (e.g., organic ELs) may be used.

(37) In each of the above embodiments, the frame is made of metal. However, the frame may be made of synthetic resin.

(38) In each of the above embodiments, the chemically toughened glass is used for the cover panel. However, a toughened glass with an air-cooling toughening process (a physically toughening process) performed thereon may be used.

(39) In each of the above embodiments, the chemically toughened glass is used for the cover panel. However, a regular glass (non-toughened glass) other than the toughened glass or a synthetic resin member may be used.

(40) In each of the above embodiments, the cover panel is used for the liquid crystal display device. However, the cover panel may not be used. Furthermore, the touchscreen panel may not be used.

(41) In each of the above embodiments, the liquid crystal display device includes the horizontally-long display screen. However, liquid crystal display devices that include vertically-long display screens may be included in the scope of the present invention. Furthermore, liquid crystal display devices that include square display screens may be included in the scope of the present invention.

(42) The liquid crystal display device of each of the above embodiments is a light transmissive type liquid crystal display device with a backlight unit that is an external light source. However, the present invention may be applied to a semi-light transmissive type (a reflection and transmission type) which includes a transmissive display function for displaying images using light from a backlight unit and a reflection display function for displaying images using external light.

(43) Each of the above embodiments includes the TFTs as switching components of the liquid crystal display device. However, switching components other than the TFTs (such as thin film diodes (TFDs)) may be included in the scope of the present invention. Furthermore, a liquid crystal display device configured to display black and white images other than the liquid crystal display device configured to display color images.

(44) The liquid crystal display device of each of the above embodiments is for a smartphone or a tablet computer. However, the present invention may be applied to liquid crystal display devices for on-board information terminals, mobile phones other than smartphones, notebook computers other than tablet computers, digital photo frames, and portable video game players.

(45) In each of the above embodiments, the liquid crystal panel is used as an “isotropic display component.” However, the present invention may be applied to display devices that include self-light emitting type anisotropic display components such as plasma display panels (PDP) and organic EL panels as long as they have anisotropy in exit angle distributions of exiting light. In those cases, the anisotropic optical members (corresponding to the second light diffusing sheet or the prism sheet) may be disposed over the display surfaces of the self-light emitting type anisotropic display components. When the self-light emitting anisotropic display components are used, the backlight units (light sources and light guide plates) may not be required.

### EXPLANATION OF SYMBOLS

10: Liquid crystal display device (a display device)

11: Liquid crystal panel (an anisotropic display component)

11a: CF board (a board)

11b: Array board (a board)

11c: Liquid crystal layer (liquid crystals)

17, 317: LED (a light source)

17a, 317a: Light emitting surface

19, 119, 219: Light guide plate

19a, 119a: Light exit surface

19b: Light entrance surface

40: First prism sheet (another optical member)

41: Second prism sheet (another optical member)

42, 242: First light diffusing sheet (another optical member)

43, 143, 343, 443, 543, 643: Second light diffusing sheet (an anisotropic optical member, an isotropic light diffusing member)

43a, 443a: Base

43b1: Light transmissive resins layer

43b2, 543b2, 643b2: Anisotropic light diffusing particle

44, 244: Prism sheet (an anisotropic optical member, an anisotropic light collecting member)

46: Protrusion

DS: Display surface

PX, PX′, PX-1, PX-2, PX-3, PX-4, PX-5: Display pixel

1. A display device including a display surface for displaying images, the display device comprising:
an anisotropic display component having isotropy in an exit angle distribution of exiting light such that an exit angle range of the exiting light is relatively small with respect to a first direction along the display surface and relatively large with respect to a second direction perpendicular to the first direction; and
an anisotropic optical member disposed on any one of a display surface side or an opposite side relative to the anisotropic display component, the anisotropic optical member having anisotropy in an exit angle distribution of exiting light such that the exit angle range of the exiting light is relatively large with respect to the first direction and relatively small with respect to the second direction.

2. The display device according to claim 1, wherein the anisotropic optical member for diffusing rays of light exiting therefrom and includes at least an anisotropic light diffusing member having light diffusing anisotropy such that an amount of diffusing light is relatively large with respect to the first direction and relatively small with respect to the second direction.

3. The display device according to claim 2, wherein the anisotropic light diffusing member includes anisotropic light diffusing particles each having a longitudinal shape and being oriented with a long-axis direction thereof along the second direction and a short-axis direction thereof along the first direction.

4. The display device according to claim 3, wherein
the anisotropic light diffusing member includes a base having light transmissivity and a light transmissive resin layer that is layered over the base and includes a number of the anisotropic light diffusing particles dispersed therein, and
the anisotropic light diffusing particles are oriented with a long-axis direction thereof along the second direction and a short-axis thereof along the first direction in the light transmissive resin layer.

5. The display device according to claim 4, wherein each of the anisotropic light diffusing particles narrows from the middle toward ends with respect to the long-axis direction.

6. The display device according to claim 5, wherein the each of the anisotropic light diffusing particles has an oval cross section along the long-axis direction.

7. The display device according to claim 2, wherein the anisotropic light diffusing member includes a base having light transmissivity and a sheet-like shape and protrusions protruding from a plate surface of the base and each having a triangular cross section along the first direction, the protrusions extending and meandering along the second direction, the protrusions being arranged along the first direction.

8. The display device according to claim 7, wherein the protrusions arranged along the first direction are formed so as to randomly meander along the second direction.

9. The display device according to claim 7, wherein the protrusions are formed such that at least one of a width and a height randomly varies according to positions in the second direction.

10. The display device according to claim 2, further comprising another optical member, wherein
the anisotropic light diffusing member includes in the anisotropic optical member disposed over the anisotropic display component on an opposite side from the display surface side,
the other optical member is disposed over the anisotropic light diffusing member and configured to transmit light, and
the anisotropic light diffusing member is disposed closer to the anisotropic display component than the other optical member.

11. The display device according to claim 1, wherein the anisotropic optical member includes at least an anisotropic light collecting member for collecting rays of light exiting therefrom and having light collecting anisotropy such that light collecting effects are not exerted on the rays of exiting light with respect to the first direction and exerted on the rays of exiting light with respect to the second direction.

12. The display device according to claim 1, further comprising:
a light source; and
a light guide plate disposed on an opposite side from an anisotropic display component side with respect to the anisotropic optical member and configured to guide rays of light from the light source, wherein
the anisotropic optical member is disposed over the anisotropic display component on an opposite side from the display surface, and
the light guide plate includes:
a peripheral surface configured as a light entrance surface through which rays of light from the light source enter; and
a plate surface facing the anisotropic optical member and configured as a light exit surface through which the rays of light exit.

13. The display device according to claim 1, further comprising a light source, wherein
the anisotropic optical member is disposed on an opposite side from the display surface side with respect to the anisotropic display component,
the anisotropic optical member has a sheet-like shape and includes a plate surface along the display surface,
the light source includes a light emitting surface for emitting rays of light, and
the light emitting surface is opposite the plate surface of the anisotropic optical member.

14. The display device according to claim 1, wherein the anisotropic display component includes display pixels arranged in a matrix along the display surface and each having a planar shape with a short-side direction corresponding with the first direction and a long-side direction corresponding with the second direction.

15. The display device according to claim 1, wherein the anisotropic display component is a liquid crystal panel including liquid crystals sealed between substrates.
